(19) United States
(12) Patent Application Publication
(10) Pub. No.: US 2013/0023432 A1
(43) Pub. Date: Jan. 24, 2013

(54) METHOD FOR PREDICTING THERAPEUTIC EFFECT OF IMMUNOTHERAPY ON CANCER PATIENT AND/OR PROGNOSIS AFTER IMMUNOTHERAPY, AND GENE SET AND KIT TO BE USED THERIN

(71) Applicants: Kyogo Itoh, Kurume-shi (JP); Masanori Noguchi, Kurume-shi (JP); Akira Yamada, Kurume-shi (JP); Shigeki Shichijo, Kurume-shi (JP); Nobukazu Komatsu, Kurume-shi (JP)

(72) Inventors: Kyogo Itoh, Kurume-shi (JP); Masanori Noguchi, Kurume-shi (JP); Akira Yamada, Kurume-shi (JP); Shigeki Shichijo, Kurume-shi (JP); Nobukazu Komatsu, Kurume-shi (JP)

(73) Assignee: KURUME UNIVERSITY, Fukuoka (JP)

(21) Appl. No.: 13/497,998

(22) PCT Filed: Sep. 30, 2010
(86) PCT No.: PCT/JP2010/067088

§ 371 Date: Mar. 28, 2012

(30) Foreign Application Priority Data
Oct. 2, 2009 (JP) 2009-230279

(51) Int. Cl. C40B 30/04; C40B 40/06

(52) U.S. Cl. 506/9; 506/16

(57) ABSTRACT

The present invention provides a method for predicting effect of immunotherapy on a cancer patient and/or prognosis of the cancer patient after the immunotherapy, and a gene set and a kit for use in the method.

### TECHNICAL FIELD

The present invention provides a method for predicting effect of immunotherapy on a cancer patient and/or prognosis of the cancer patient after the immunotherapy, and a gene set and a kit for use in the method. The present application claims the benefit of Japanese patent application number 2009-230279 and the subject matter of which is hereby incorporated herein by reference.

### BACKGROUND ART

Cancer immunotherapy is still not an optimal therapeutic option for all patients although it has been effective for some patients. One of the reasons is that immunotherapy relys on immunity which considerably varies among different individuals to suppress proliferation of cancer cells. At present, it is not possible to predict effect of cancer immunotherapy and thus effectiveness of the therapy cannot be determined unless the therapy has done. It has been known that effect of chemotherapy on a breast cancer patient is predicted by determination of gene expression level. However, this prediction method is complicated because it involves not only gene expression level but also other factors. In addition, this method only directs to chemotherapy on breast cancer (patent literature 1). So far, methods for predicting effect of cancer immunotherapy or prognosis of a patient after immunotherapy have not been known.
Patent literature: JP-A-2008-536094

### Disclosure of Invention

### Problem to be Solved by the Invention

An object of the present invention is to provide a method for predicting effect of immunotherapy on a cancer patient with accuracy.

### Means of Solving the Problem

Based on the results of peptide vaccine therapy on prostate cancer patients over the years, the present inventors tried to predict effect of cancer immunotherapy. First, gene expression profiles of prostate cancer patients before peptide vaccine therapy were analyzed with DNA micorarray. Then, the patients were classified into good prognosis group and poor prognosis group according to their survival time after the therapy, and correlation between expression level of each gene before the therapy and survival time after the therapy was analyzed. As a result, some genes were found to have correlation between the two. Finally, it was confirmed that survival time of a patient after immunotherapy could be predicted from expression level of those genes and the present invention has been accomplished.

Thus, the present invention provides a method for predicting effect of immunotherapy on a cancer patient and/or prognosis of the cancer patient after the immunotherapy, which comprises the steps of:

(1) determining expression level of each gene in a gene set which consists of at least 1 gene selected from the group of genes shown in any of Tables 1-5 and
(2) performing statistical processing of the expression level to calculate predicted survival time.

The present invention further provides a gene set for predicting effect of immunotherapy on a cancer patient and/or prognosis of the cancer patient after the immunotherapy, which consists of at least 1 gene selected from the group of genes shown in any of Tables 1-5.

The present invention further provides a kit for predicting effect of immunotherapy on a cancer patient and/or prognosis of the cancer patient after the immunotherapy, which comprises a probe or primer for each gene in the aforementioned gene set.

### Effect of the Invention

According to the present invention, it has become possible to predict effect of immunotherapy on a cancer patient and/or prognosis of the cancer patient after the immunotherapy by determining gene expression profile of the cancer patient before initiation of the immunotherapy. The present invention can offer useful information in selecting therapeutic options for cancer patients.

### BRIEF DESCRIPTION OF DRAWINGS

FIG. 1 Distribution of predicted survival time of 40 prostate cancer patients.

FIG. 2 Pre-processing of microarray data.

FIG. 3 Distribution of top 300 genes selected by Pearson product-moment correlation coefficient.

FIG. 4 Accuracy of survival time prediction by different gene selection methods.

FIG. 5 Accuracy of survival time prediction with 30 gene sets each consisting of genes selected in descending order from the top (the first gene) of top 300 genes selected by Pearson product-moment correlation coefficient (Table 1). The vertical axis represents number of patients correctly predicted.

FIG. 6 Comparison between predicted survival time (calculated with the gene set consisting of top 50 genes selected by Pearson product-moment correlation coefficient, latent variable 3) and actual survival time of each patient.

FIG. 7 Kaplan-Meier curve prepared according to the results of survival time prediction.

FIG. 8 Accuracy of survival time prediction with 30 gene sets each consisting of genes selected in ascending order from the bottom (the 300th gene) of top 300 genes selected by Pearson product-moment correlation coefficient (Table 1). The vertical axis represents number of patients correctly predicted.

FIG. 9 Accuracy of survival time prediction with 30 gene sets each consisting of genes randomly selected from top 300 genes selected by Pearson product-moment correlation coefficient (Table 1). The vertical axis represents number of patients correctly predicted.

FIG. 10 Results of survival time prediction with good prognosis group (survival time was 300 days or more) and poor prognosis group (survival time was less than 300 days).

FIG. 11-1 Results of survival time prediction with one gene randomly selected from top 300 genes selected by Pearson product-moment correlation coefficient (Table 1) (1) (the rank in Table 1 is shown in the left of each graph).

FIG. 11-2 Results of survival time prediction with one gene randomly selected from top 300 genes selected by Pearson product-moment correlation coefficient (Table 1) (2) (the rank in Table 1 is shown in the left of each graph).

FIG. 11-3 Results of survival time prediction with one gene randomly selected from top 300 genes selected by Pearson product-moment correlation coefficient (Table 1) (3) (the rank in Table 1 is shown in the left of each graph).

### DESCRIPTION OF EMBODIMENTS

The prediction method of the present invention uses a gene or genes of which expression levels closely correlate survival time of a cancer patient after immunotherapy. The gene set of the present invention consists of at least 1 gene selected from the group of genes shown in any of Tables 1-5. The genes may be selected from any of Tables 1-5 in descending order from the top (the first gene), in ascending order from the bottom (the 300th gene), or randomly. In view of prediction accuracy, the genes are preferred to be selected in descending order from the top of any of the tables.

Number of genes in a gene set is not specifically limited and may be 1 or more. For example, for a gene set, 1, 2, 3, 4, 5, 6, 7, 8, 9, 10, 20, 30, 40, 50, 60, 70, 80, 90, 100, 110, 120, 130, 140, 150, 160, 170, 180, 190, 200, 210, 220, 230, 240, 250, 260, 270, 280, 290, or 300 genes may be selected.

The cancer patient to be treated by the present invention may be, but not limited to, a cancer patient of prostate cancer, pancreatic cancer, breast cancer, or liver cancer. Particularly, the present invention is suitable for a prostate cancer patient.

In the present invention, immunotherapy refers to a therapeutic method for treating cancer by stimulating immune response in a cancer patient against a tumor antigen protein. The immunotherapy of the present invention may include peptide vaccine therapy which uses a tumor antigen peptide, adoptive immunotherapy which uses lymphocytes such as cytotoxic T cells or natural killer cells, DNA vaccine therapy wherein a virus vector expressing a tumor antigen protein or peptide is introduced into a living body, and dendritic cell vaccine therapy wherein dendritic cells presenting a tumor antigen peptide are administered. Particularly, the present invention is suitable for peptide vaccine therapy.

In the present invention, expression level of a gene may be determined by any conventional method. Methods for determining expression level of a gene may include DNA microarray analysis, DNA chip analysis, PCR analysis, and Northern blot analysis, and particularly, DNA microarray analysis is suitable for the present invention.

DNA microarray analysis uses a microarray containing a probe for a gene to be determined. The microarray may be HumanWG-6 v3.0 Expression BeadChip (llumina). Alternatively, it is possible to prepare any desired microarray by synthesizing a probe for a gene to be determined and immobilizing the probe on a suitable substrate such as a slide glass. Methods for preparing a microarray are well known in the art. Analysis of microarray data is also well known in the art and may be performed according to MICROARRAYS FOR AN INTEGRATIVE GENOMICS, translated by Yujin Hoshida, Springer-Verlag Tokyo, for example.

A patient-derived sample used for determination of expression level of a gene may be, but not limited to, peripheral blood collected from a patient.

Expression level of a gene may be determined by DNA microarray analysis as follows. Briefly, total RNA is extracted and purified from peripheral blood of a patient. Then, biotinated cRNA is synthesized by using, for example, Illumina TotalPrep RNA Amplification Kit (Ambion). The biotinated cRNA is hybridized to a microarray and reacted with Cy3-labeled streptavidin. The resulting microarray is scanned by a dedicated scanner and Cy3 fluorescence of each spot is quantified by a dedicated software such as BeadStudio. Accordingly, expression level of the gene may be determined.

Predicted survival time of a patient may be calculated, for example, by applying the expression level of each gene of the gene set of the present invention in the patient into the regression equation of PLS regression analysis as shown in the following examples. Alternatively, it may be calculated by determining expression level of each gene of any gene set of the present invention in the patient group of the examples or other patient groups and performing statistical processing by SVM (Support Vector Machine), Regularized Least Squares, or Principal Component Analysis.

The gene set of the present invention is used for predicting effect of immunotherapy on a cancer patient and/or prognosis of the cancer patient after the immunotherapy and may be used for preparing a probe for DNA microarray or a primer for PCR for use in the prediction method of the present invention.

The kit of the present invention comprises a probe or primer which is capable of determining expression level of each gene of the gene set of the present invention. The probe or primer for each gene may be synthesized by a conventional method based on the sequence of the gene. The kit may comprise other reagents required for determination of expression level. The kit of the present invention may be used for DNA microarray analysis, DNA chip analysis, PCR analysis, and Northern blot analysis. A kit for DNA microarray analysis may comprise a microarray containing the probe as described above immobilized on a suitable substrate.

### EXAMPLES

### Example 1

### 1. Analysis of Gene Expression Profile Before Peptide Vaccine Therapy Using DNA Microarray

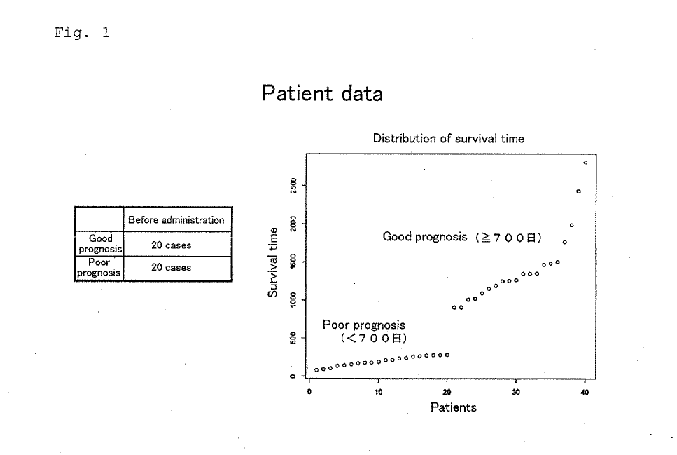

Patient-derived samples were peripheral blood which had been collected from prostate cancer patients who gave informed consent under the protocol approved by Kurume University ethical committee when the patients were diagnosed as recurrent prostate cancer in the past clinical trials. Gene expression profiles of 40 prostate cancer patients before peptide vaccine therapy were analyzed by using DNA microarray (HumanWG-6 v3.0 Expression BeadChip (Ilumina)). The prostate cancer patients included 20 good prognosis patients (whose survival time after peptide vaccine therapy was 700 days or more) and 20 poor prognosis patients (whose survival time after peptide vaccine therapy was less than 700 days) (FIG. 1).

(I) RNA Extraction and Purification from Peripheral Blood of Patients
1. To peripheral blood sample of a patient, TRIzol LS (Invitrogen) was added at a ratio 1:3 and mixed such that the mixture became turbid.
2. To 750 μl TRIzol LS solution, 200 μl chloroform was added and mixed such that the mixture became turbid, and the resulting solution was centrifuged.
3. The supernatant obtained was removed to a fresh tube and added with ethanol 0.55 times as much as the supernatant.
4. The sample obtained in item 3 was mounted on a column of SV Total RNA Isolation System (Promega) and passed through the filter.
5. The filter was washed with 500 μl washing buffer.
6. Total RNA was eluted with 80 μl nuclease-free water.
7. Concentration of RNA was determined by using a spectrophotometer, and quality of RNA was checked by electrophoresis by using Experion system (Biorad).
(II) cRNA Synthesis for Microarray Using Illumina TotalPrep RNA Amplification Kit (Ambion)
(1) Synthesis of Single-Stranded cDNA by Reverse Transcription
1. To 500 μg total RNA each, nuclease-free water was added up to 11 μl.
2. The solution obtained item 1 was added with 9 μl Reverse Transcription Master Mix and incubated for 2 hours at 42° C.

### (2) Synthesis of Double-Stranded DNA

1. To the tube of item (1)-2, 80 μl Second Strand Master Mix was added.
2. The tube was incubated for 2 hours at 16° C.
(3) Purification of cDNA
1. To the tube, 250 μl cDNA Binding Buffer was added.
2. The solution obtained in item 1 was mounted on cDNA Filter Cartridge and passed through the filter by centrifugation.
3. The filter was washed with 500 μl washing buffer.
4. cDNA was eluted with 19 μl nuclease-free water which was pre-heated to 50-55° C.
(4) Synthesis of cRNA by Reverse Transcription Reaction In Vitro
1. To the cDNA sample obtained in item (3)-4, 7.5 μl IVT Master Mix was added.
2. The tube obtained in item 1 was incubated for 14 hours at 37° C.
3. To the tube obtained in item 2, 75 μl nuclease-free water was added.
(5) Purification of cRNA
1. To the tube, 350 μl cRNA Binding Buffer was added.
2. To the tube, 250 μl of 100% ethanol was added and mixed such that the mixture became turbid.
3. The sample obtained in item 2 was mounted on tRNA Filter Cartridge and passed through the filter by centrifugation.
4. The filter was washed with 650 μl washing buffer.
5. cRNA was eluted with 100 μl nuclease-free water which was pre-heated to 50-55° C.
6. Concentration of cRNA of the resulting solution was determined and the solution was used as a hybridization sample.

### (III) Microarray Hybridization

(1) Preparation of cRNA for hybridization
1. To 500 μg total RNA, nuclease-free water was added up to 10 μl.
2. The solution obtained in item 1 was added with 20 μl GEX-HYB and incubated for 5 minutes at 65° C.

### (2) Hybridization

1. cRNA sample thus prepared was applied to HumanWG-6 v3.0 Expression BeadChip placed in a dedicated chamber.
2. The dedicated chamber was covered and incubated for 18 hours at 55° C.

### (IV) Washing and Staining of Microarrays

### (1) Washing of Microarrays

1. The covers of the microarrays were removed in Wash E1BC solution.
2. The arrays were immediately set in a slide rack and washed with 1×High-Temp Wash buffer which was pre-heated to 55° C.
3. The arrays were washed in Wash E1BC solution for 5 minutes.
4. The arrays were washed in ethanol for 5 minutes.
5. The arrays were washed in Wash E1BC solution for 5 minutes.
6. To each of staining trays 4 ml Block E1 buffer was added, and then the arrays were set in the staining trays one by one to perform blocking for 10 minutes at room temperature.
7. To each of staining trays 2 μl streptoavidin-Cy3 per 2 ml Block E1 buffer was added, and then the arrays were set in the staining trays one by one to perform staining for 10 minutes at room temperature.
8. The arrays were washed in Wash E1BC solution for 5 minutes and dried by centrifugation.

### (V) Scanning and Quantification

1. The arrays were set in a dedicated scanner (Illumina) and scanned in a standard mode.
2. After scanning, each spot on the microarrays was quantified by using a dedicated software BeadStudio.

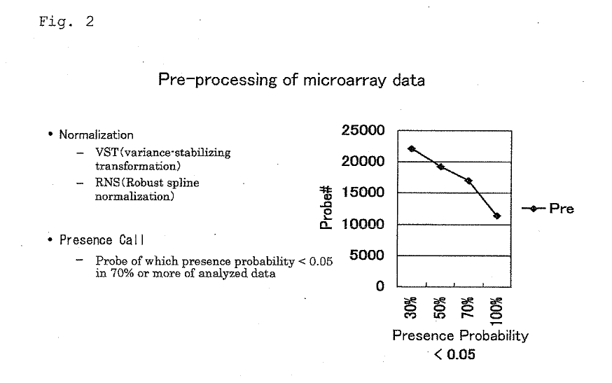

The microarray data obtained was normalized with VST (Variance Stabilizing Transformation) and RSN (robust spline normalization). Expression level of a gene was determined to be significant when the gene showed Presence Probability &#38;#38;#60 0.05 compared to a negative control (expression level measured with a probe for a gene which was not present in the microarray) (FIG. 2). The following analysis was performed using the genes showing Presence Probability &#38;#38;#60 0.05 in 70% or more of the 40 patients.

### 2: Selection of a Gene Set for Building PLS Regression Model

The prostate cancer patients of Example 1 were classified into 2 groups, good prognosis group (survival time after peptide vaccine therapy was 700 days or more) and poor prognosis group (survival time after peptide vaccine therapy was less than 700 days) and genes were selected based on correlation between expression level of each gene and survival time, and expression variation between the two groups. Expression variation was represented as increase or decrease of mean expression level of poor prognosis group compared to that of good prognosis group as a control.

For analysis, the following five statistical methods were used (A: method for analysis of correlation between expression level of a gene and survival time, B: method for analysis of expression variation between good prognosis group and poor prognosis group).
Pearson product-moment correlation coefficient (A)
Limma^{b} (B)
SAM^{a} (B)
Rank Prod^{c} (B)
Spearman's rank correlation coefficient (A)

### REFERENCES

^{a} Tusher et al. Significance analysis of microarrays applied to the ionizing radiation response. Proc Natl Acad Sci USA (2001) vol. 98 (9) pp. 5116-21.
^{b} Smyth. Linear models and empirical bayes methods for assessing differential expression in microarray experiments. Statistical applications in genetics and molecular biology (2004) vol. 3 pp. Article.
^{c} Breitling et al. Rank products: a simple, yet powerful, new method to detect differentially regulated genes in replicated microarray experiments. FEBS Letters (2004) vol. 573 (1-3) pp. 83-92.

Those references are herein incorporated by reference.

### 3: Analysis of PLS Regression Model

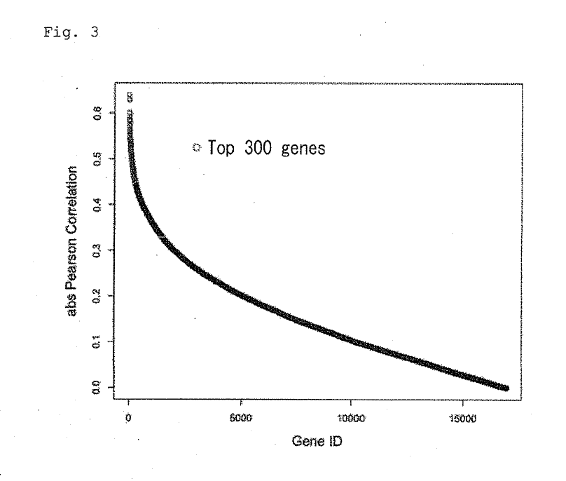

PLS (Partial Least Square) regression model was built for prediction of survival time of each patient after peptide vaccine therapy. Specifically, from each of the five gene sets consisting of top 300 genes selected by one of the above five methods, respectively (Tables 1-5, FIG. 3), 30 gene sets each comprising genes in multiples of 10 (i.e. 10, 20, . . . or 300 genes) from the top were extracted. Then, PLS regression model was built with latent variable 1 to 10.

Analysis of the regression model was performed according to Leave One Out Cross Validation (LOOCV) method. Namely, for 40 prostate cancer patients in total, regression model was built using results of 39 patients, and the regression model thus built was used to predict survival time of the remaining 1 patient.

For example, calculation of survival time with a gene set consisting of top 50 genes is as follows. Predicated survival time was calculated according to the following regression equation.

Predicated survival time=a1g1+a2g2+a3g3+ . . . +a50g50+E (formula 1),

wherein each of a1, a2, a3, . . . and a50 is a coefficient for expression level of a gene used to build the regression model; each of g1, g2, g3, g4, . . . g50 is expression level of a gene in a patient to be analyzed; and E is a constant term of the regression equation).

Table 6 shows coefficients used for the prediction of survival time of patients with the gene set consisting of top 50 genes selected by Pearson product-moment correlation coefficient, latent variable 3.

### REFERENCES

[1] Bjrn-Helge Mevik and Ron Wehrens Journal of Statistical Software: Vol 18, Issue 2 (2007), &#38;#38;#34; The pls Package: Principal Component and Partial Least Squares Regression in R&#38;#38;#34;
[2] Geladi, P. and B. Kowalski (1986) Partial least-squares regression: Atutorial. Analytica Chimica Acta 185:1-17.

Those references are herein incorporated by reference.

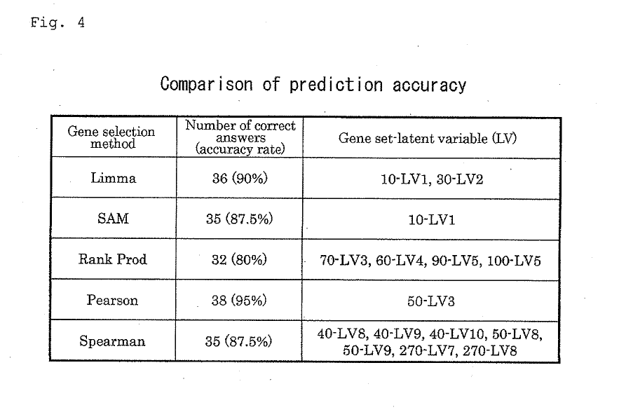

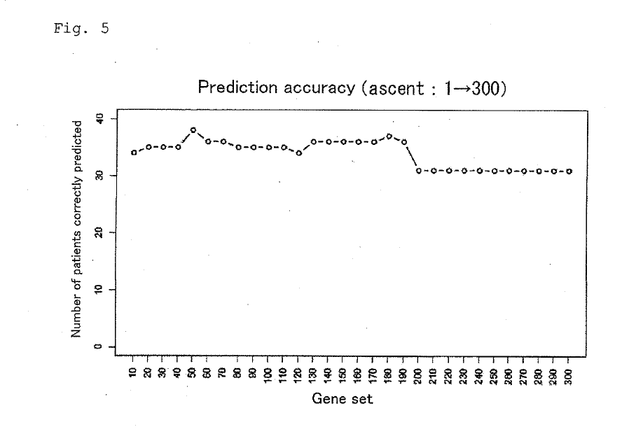

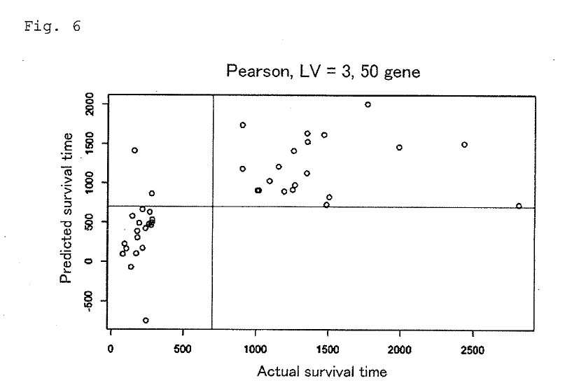

The answer was determined to be correct when the predicted survival time was 700 days or more for a good prognosis patient or less than 700 days for a poor prognosis patient, and accuracy rate (prediction accuracy) of the regression model was calculated. When evaluated, all the regression models showed the best prediction accuracy more than 80% (FIG. 4). Particularly, the gene set consisting of top 50 genes selected by Pearson product-moment correlation coefficient, latent variable 3 showed the highest prediction accuracy, which was 95%. Prediction accuracy of survival time prediction with this gene set and comparison between the predicted survival time and the actual survival time are shown in FIGS. 5 and 6. For the patients in the right-upper and left-lower sections in FIG. 6, predicted survival time reflected actual survival time. For the patients in the left-upper section, prognosis after the immunotherapy was predicted as good, but actual survival time was shorter than the prediction. On the other hand, there was no patient whose prognosis was predicted as poor but actual survival time was longer than the prediction (FIG. 6, the right-lower section). Those results indicate that the method of the present invention can predict a patient who would not be efficiently treated by immunotherapy before initiation of the immunotherapy.

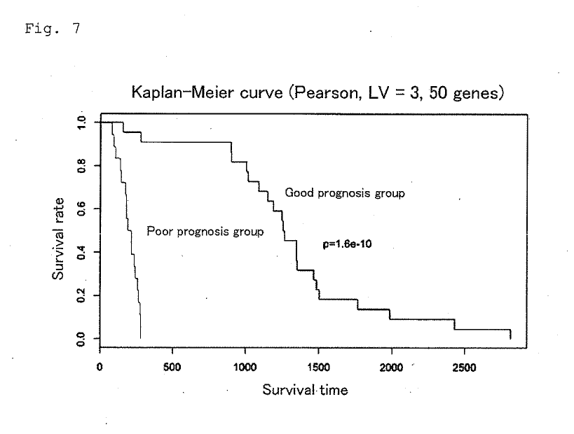

In addition, Kaplan-Meier curve was prepared using actual survival time of good and poor prognosis groups classified with the gene set consisting of: top 50 genes selected by Pearson product-moment correlation coefficient, latent variable 3 and then log rank test was performed. As a result, it was revealed that the present method could classify the patients into good and poor prognosis groups with probability p=1.6e-10 (FIG. 7).

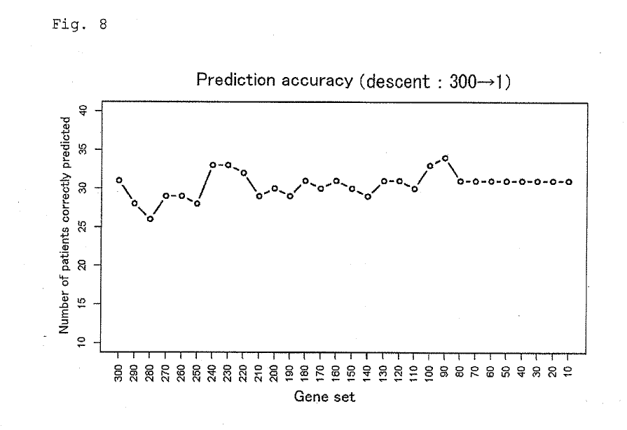

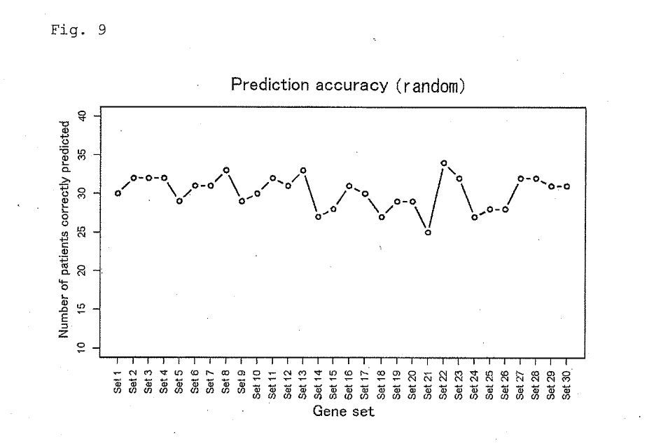

Then, from the gene set of Table 1, 30 gene sets each consisting of genes in multiples of 10 (i.e., 10, 20, . . . or 300 genes) in ascending order from the bottom were extracted and PLS regression model was built with latent variable 3 (FIG. 8). In this case, prediction accuracy was 65-85%. Also, from the same gene set, 30 gene sets were extracted randomly (Table 7) and PLS regression model was built with latent variable 3 (FIG. 9). In this case, prediction accuracy was 62.5-85%. Those results demonstrate that survival time after immunotherapy can be predicted by any gene selection method.

### Example 2

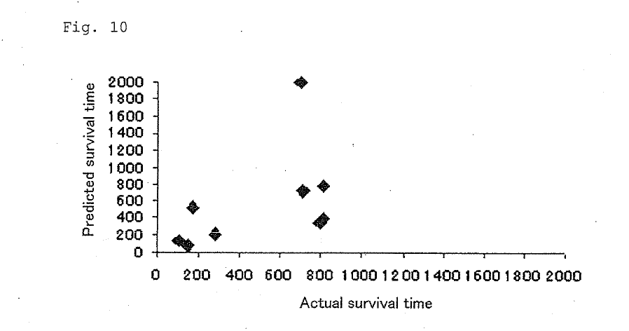

Gene Expression data of 9 prostate cancer patients were further included in addition to those of 40 prostate cancer patients of Example 1, and the patients were classified into good prognosis group (survival time was 300 days or more) and poor prognosis group (survival time was less than 300 days). Then, PLS regression model was built with a gene set consisting of top 50 genes selected by Pearson product-moment correlation coefficient, latent variable 3 and survival time of the 9 prostate cancer patients newly included were predicted (FIG. 10). In this example, prediction was correct in 8 of 9 patients.

### Example 3

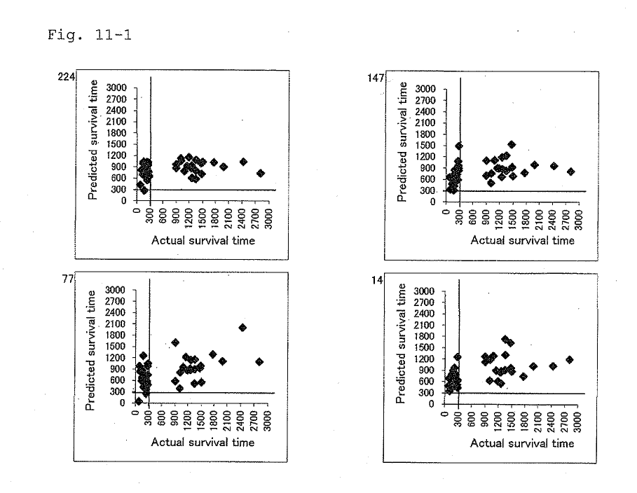

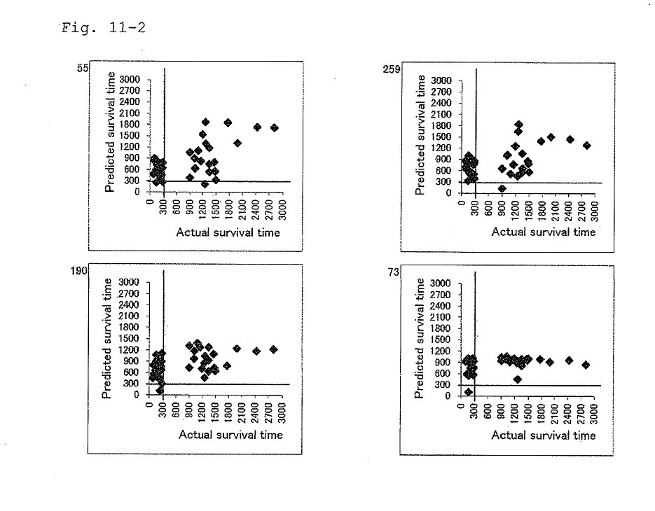

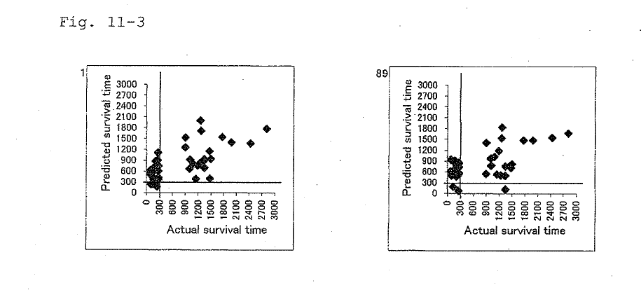

For 40 prostate cancer patients of Example 1, a primary linear regression equation was prepared according to their survival time and expression level of one of top 300 genes selected by Pearson product-moment correlation coefficient (Table 1). Then, predicted survival time of a patient was calculated with the equation thus prepared and expression level in the patient, and the calculated predicted survival time (y axis) and actual survival time (x axis) were shown in a graph (FIG. 11). The graphs show results of 10 genes randomly selected from Table 1 by generating a random number between 1 and 300 and regarding the number as a rank in the table. As a result, it was demonstrated that survival time could be predicted based on expression level of only one gene.

TABLE 1
List of top 300 genes selected by Pearson product-moment correlation coefficient.
Pearson

| No. | Probe ID | Name of gen | Description of gene | EntrezID | Acc | limma_logFC | Cor_Pearson_R | Cor_Pearson_absR | Cor_Pearson_Pval | Cor_Pearson_adPval |
|---|---|---|---|---|---|---|---|---|---|---|
| 1 | 3390368 | PDP2 | — | 57546 | NM_020786.1 | 0.068777448 | −0.640094678 | 0.640094678 | 8.68E−06 | 0.0806 |
| 2 | 1300687 | NULL | NULL | 731950 | XR_016039.1 | −0.061135983 | 0.631328974 | 0.631328974 | 1.25E−05 | 0.0806 |
| 3 | 5860465 | USP9Y | “ubiquitin specific peptidase 9, Y- | 8287 | NM_004654.3 | −0.094524102 | 0.628214485 | 0.628214485 | 1.42E−05 | 0.0806 |
| | | | linked (fat facets-like, Drosophila)” | | | | | | | |
| 4 | 4390576 | DFFA | “DNA fragmentation factor, 45 kDa, | 1678 | NM_213566.1 | 0.121909434 | −0.601015195 | 0.601015195 | 4.12E−05 | 0.1137 |
| | | | alpha polypeptide” | | | | | | | |
| 5 | 4830255 | DPP4 | dipeptidyl-peptidase 4 | 1803 | NM_001935.3 | −0.307400855 | 0.598684997 | 0.598684997 | 4.49E−05 | 0.1137 |
| 6 | 4570403 | NULL | NULL | NULL | BX106581 | 0.112837902 | −0.591426067 | 0.591426067 | 5.85E−05 | 0.1137 |
| 7 | 1780719 | PTGES3 | prostaglandin E synthase 3 | 10728 | NM_006601.4 | −0.528677962 | 0.586249078 | 0.586249078 | 7.04E−05 | 0.1137 |
| | | | (cytosolic) | | | | | | | |
| 8 | 3130477 | C7orf28A | chromosome 7 open reading frame | 51622 | XM_001133729.1 | −0.383441629 | 0.585298251 | 0.585298251 | 7.28E−05 | 0.1137 |
| | | | 28A | | | | | | | |
| 9 | 6110630 | HIST1H2BK | “histone cluster 1, H2bk” | 85236 | NM_080593.1 | 0.379122401 | −0.583688805 | 0.583688805 | 7.70E−05 | 0.1137 |
| 10 | 3310309 | CCDC135 | coiled-coil domain containing 135 | 84229 | NM_032269.4 | 0.099558313 | −0.582768194 | 0.582768194 | 7.96E−05 | 0.1137 |
| 11 | 4220731 | P4HA1 | “prolyl 4-hydroxylase, alpha | 5033 | NM_000917.2 | −0.307837835 | 0.582543435 | 0.582543435 | 8.02E−05 | 0.1137 |
| | | | polypeptide 1” | | | | | | | |
| 12 | 520706 | UBE4A | “ubiquitination factor E4A (UFD2 | 9354 | NM_004788.2 | −0.230502672 | 0.582455331 | 0.582455331 | 8.04E−05 | 0.1137 |
| | | | homolog, yeast)” | | | | | | | |
| 13 | 6420446 | CMPK1 | “cytidine monophosphate (UMP- | 51727 | NM_016308.1 | −0.398631213 | 0.576832021 | 0.576832021 | 9.78E−05 | 0.1276 |
| | | | CMP) kinase 1, cytosolic” | | | | | | | |
| 14 | 1400240 | LDHB | lactate dehydrogenase B | 3945 | NM_002300.4 | −0.605485777 | 0.573136201 | 0.573136201 | 0.000110918 | 0.1341 |
| 15 | 7510379 | SACS | spastic ataxia of Charlevoix- | 26278 | NM_014363.3 | −0.121241812 | 0.571175816 | 0.571175816 | 0.000118529 | 0.1341 |
| | | | Sag [symbol] enay (sacsin) | | | | | | | |
| 16 | 2640025 | HP | haptoglobin | 3240 | NM_005143.2 | 0.40681683 | −0.565414687 | 0.565414687 | 0.000143707 | 0.1412 |
| 17 | 3130296 | AMY2A | “amylase, alpha 2A (pancreatic)” | 279 | NM_000699.2 | −0.282794372 | 0.562912837 | 0.562912837 | 0.000156073 | 0.1412 |
| 18 | 3520601 | MPO | myeloperoxidase | 4353 | NM_000250.1 | 0.96554979 | −0.560650984 | 0.560650984 | 0.000168071 | 0.1412 |
| 19 | 1110091 | TIAL1 | TIA1 cytotoxic granule-associated | 7073 | NM_001033925.1 | −0.233908998 | 0.560267499 | 0.560267499 | 0.000170186 | 0.1412 |
| | | | RNA binding protein-like 1 | | | | | | | |
| 20 | 3130370 | ZNF83 | zinc finger protein 83 | 55769 | NM_018300.2 | −0.30567958 | 0.557785556 | 0.557785556 | 0.000184463 | 0.1412 |
| 21 | 2030332 | PTPN18 | “protein tyrosine phosphatase, | 26469 | NM_014369.2 | 0.083763446 | −0.556808508 | 0.556808508 | 0.000190373 | 0.1412 |
| | | | non-receptor type 18 (brain- | | | | | | | |
| | | | derived)” | | | | | | | |
| 22 | 670209 | ZNF700 | zinc finger protein 700 | 90592 | NM_144566.1 | −0.134476397 | 0.556120039 | 0.556120039 | 0.00019464 | 0.1412 |
| 23 | 6560161 | NULL | NULL | NULL | BX111675 | 0.054993081 | −0.555033755 | 0.555033755 | 0.000201547 | 0.1412 |
| 24 | 1740647 | FAM180B | “family with sequence similarity | 399888 | XM_941808.2 | 0.083819707 | −0.552949574 | 0.552949574 | 0.000215422 | 0.1412 |
| | | | 180, member B” | | | | | | | |
| 25 | 4880463 | SEC24A | “SEC24 family, member A | 10802 | NM_021982.1 | −0.069649892 | 0.551748217 | 0.551748217 | 0.000223805 | 0.1412 |
| | | | (S. cerevisiae)” | | | | | | | |
| 26 | 990315 | TCP1 | t-complex 1 | 6950 | NM_030752.2 | −0.256767834 | 0.548462787 | 0.548462787 | 0.00024825 | 0.1412 |
| 27 | 240463 | RNF216L | ring finger protein 216-like | 441191 | XR_001271.1 | 0.162378967 | −0.546624738 | 0.546624738 | 0.000262951 | 0.1412 |
| 28 | 2000035 | NULL | NULL | NULL | AL042883 | 0.08373784 | −0.545628461 | 0.545628461 | 0.000271242 | 0.1412 |
| 29 | 1780709 | DDX17 | DEAD (Asp-Glu-Ala-Asp) box | 10521 | NM_030881.2 | −0.443292451 | 0.54494961 | 0.54494961 | 0.000277025 | 0.1412 |
| | | | polypeptide 17 | | | | | | | |
| 30 | 2680440 | NULL | NULL | NULL | BF338665 | 0.061724508 | −0.544896308 | 0.544896308 | 0.000277484 | 0.1412 |
| 31 | 150672 | KLHL7 | kelch-like 7 (Drosophila) | 55975 | NM_001031710.1 | −0.155913324 | 0.544163441 | 0.544163441 | 0.000283861 | 0.1412 |
| 32 | 6940176 | ACTR3 | ARP3 actin-related protein 3 | 10098 | NM_005721.3 | −0.459963089 | 0.543431629 | 0.543431629 | 0.00029036 | 0.1412 |
| | | | homolog (yeast) | | | | | | | |
| 33 | 6180497 | GOLGA8C | “golgi autoantigen, golgin subfamily | 400304 | XM_375152.3 | −0.242008817 | 0.542516269 | 0.542516269 | 0.000298677 | 0.1412 |
| | | | a. 8C” | | | | | | | |
| 34 | 150706 | UGP2 | UDP-glucose pyrophosphorylase 2 | 7360 | NM_006759.3 | −0.347146055 | 0.542493196 | 0.542493196 | 0.000298889 | 0.1412 |
| 35 | 5900129 | CROP | — | 51747 | NM_006107.2 | −0.443849065 | 0.541743162 | 0.541743162 | 0.000305867 | 0.1412 |
| 36 | 6450437 | NULL | NULL | NULL | BF445990 | 0.102742584 | −0.541344228 | 0.541344228 | 0.000309638 | 0.1412 |
| 37 | 3990608 | MAN2A1 | “mannosidase, alpha, class 2A, | 4124 | NM_002372.2 | −0.327379686 | 0.540749807 | 0.540749807 | 0.000315334 | 0.1412 |
| | | | member 1” | | | | | | | |
| 38 | 3120075 | TIA1 | TIA1 cytotoxic granule-associated | 7072 | NM_022173.1 | −0.154497679 | 0.540658588 | 0.540658588 | 0.000316217 | 0.1412 |
| | | | RNA binding protein | | | | | | | |
| 39 | 1500047 | RIN1 | Ras and Rab interactor 1 | 9610 | NM_004292.2 | 0.132155916 | −0.537690388 | 0.537690388 | 0.000346168 | 0.1475 |
| 40 | 840358 | EXOSC10 | exosome component 10 | 5394 | NM_002685.2 | −0.226165883 | 0.53626305 | 0.53626305 | 0.000361457 | 0.1475 |
| 41 | 6590484 | NAP1L1 | nucleosome assembly protein 1-like 1 | 4673 | NM_139207.1 | −0.357418466 | 0.535985012 | 0.535985012 | 0.000364505 | 0.1475 |
| 42 | 2100594 | BUB3 | budding uninhibited by | 9184 | NM_004725.2 | −0.303182523 | 0.535031257 | 0.535031257 | 0.000375136 | 0.1475 |
| | | | benzimidazoles 3 homolog (yeast) | | | | | | | |
| 43 | 6650056 | ZNF566 | zinc finger protein 566 | 84924 | NM_032838.2 | −0.051770571 | 0.53472561 | 0.534725261 | 0.000378605 | 0.1475 |
| 44 | 2120017 | NOL8 | nucleolar protein 8 | 55035 | NM_017948.4 | −0.183491166 | 0.534382962 | 0.534382962 | 0.00038252 | 0.1475 |
| 45 | 1780639 | LOC645355 | — | 845355 | XM_932842.1 | 0.036028447 | −0.532604561 | 0.532604561 | 0.000403449 | 01481 |
| 46 | 6650594 | ATP11B | “ATPase, class VI, type 11B” | 23200 | NM_014616.1 | −0.252853775 | 0.531209574 | 0.531209574 | 0.000420578 | 0.1481 |
| 47 | 3420136 | C6orf222 | chromosome 6 open reading frame | 389384 | NM_001010903.3 | 0.050501562 | −0.531038639 | 0.531038639 | 0.000422721 | 0.1481 |
| | | | 222 | | | | | | | |
| 48 | 6760017 | YY1 | YY1 transcription factor | 7528 | NM_003403.3 | −0.328869705 | 0.530931836 | 0.530931836 | 0.000424065 | 0.1481 |
| 49 | 510209 | LOC643310 | — | 643310 | XM_926656.1 | −0.395581648 | 0.530359688 | 0.530359688 | 0.00043133 | 0.1481 |
| 50 | 4220873 | NULL | NULL | NULL | AA971450 | 0.072927449 | −0.529035258 | 0.529035258 | 0.000448577 | 0.1481 |
| 51 | 7650497 | ELA2 | “elastase 2, neutrophil” | 1991 | NM_001972.2 | 1.319902436 | −0.527751453 | 0.527751453 | 0.000465881 | 0.1481 |
| 52 | 2650601 | GPBP1L1 | GC-rich promoter binding protein | 60313 | NM_021639.3 | −0.185092124 | 0.526741783 | 0.526741783 | 0.000479908 | 0.1481 |
| | | | 1-like 1 | | | | | | | |
| 53 | 4880521 | CDC16 | cell division cycle 16 homolog | 8881 | NM_003903.3 | −0.34380491 | 0.526389836 | 0.526389836 | 0.000484886 | 0.1481 |
| | | | (S. cerevisiae) | | | | | | | |
| 54 | 5720300 | G3BP1 | GTPase activating protein (SH3 | 10146 | NM_005754.2 | −0.241645343 | 0.526197011 | 0.526197011 | 0.000487632 | 0.1481 |
| | | | domain) binding protein 1 | | | | | | | |
| 55 | 7210279 | NULL | NULL | NULL | AA431552 | 0.088033112 | −0.52587792 | 0.52587792 | 0.000492208 | 0.1481 |
| 56 | 840064 | LOC645489 | — | 645489 | XM_928514.1 | −0.199041088 | 0.525473195 | 0.525473195 | 0.000498067 | 0.1481 |
| 57 | 5960072 | NULL | NULL | NULL | BY797688 | −0.097047292 | 0.525204521 | 0.525204521 | 0.00050199 | 0.1481 |
| 58 | 3610521 | PCDHGB6 | “protocadherin gamma subfamily B, 6” | 56100 | NM_018926.2 | 0.176789549 | −0.524908903 | 0.524908903 | 0.00050634 | 0.1481 |
| 59 | 770441 | DOPEY1 | dopey family member 1 | 23033 | NM_015018.2 | −0.10084509 | 0.520195136 | 0.520195136 | 0.000580393 | 0.1577 |
| 60 | 5810619 | TADA1L | “transcriptional adaptor 1 (HFI1 | 117143 | NM_053053.2 | −0.16203449 | 0.519513067 | 0.519513067 | 0.000591874 | 0.1577 |
| | | | homolog, yearst)-like” | | | | | | | |
| 61 | 4260767 | GP1BA | “glycoprotein Ib (platelet), alpha | 2811 | NM_000173.4 | 0.13089936 | −0.519405182 | 0.519405182 | 0.000593708 | 0.1577 |
| | | | polypeptide” | | | | | | | |
| 62 | 5290358 | CPT1A | carnitine palmitoyltransferase 1A | 1374 | NM_001031847.1 | 0.165571989 | −0.518548295 | 0.518549295 | 0.000608441 | 0.1577 |
| | | | (liver) | | | | | | | |
| 63 | 3440189 | ZBTB20 | zinc finger and BTB domain | 26137 | NM_015642.3 | −0.287117754 | 0.518214913 | 0.518214913 | 0.000614286 | 0.1577 |
| | | | containing 20 | | | | | | | |
| 64 | 4050195 | FAM10A4 | “family with sequence similarity 10, | 145165 | NR_002183.1 | −0.370567771 | 0.517317921 | 0.517317921 | 0.000630211 | 0.1577 |
| | | | member A4 pseudogene” | | | | | | | |
| 65 | 160253 | MBNL1 | muscleblind-like (Drosophila) | 4154 | NM_207295.1 | −0.320695796 | 0.517296744 | 0.517296744 | 0.000630591 | 0.1577 |
| 66 | 6550164 | DEFA4 | “defensin, alpha 4, corticostatin” | 1669 | NM_001925.1 | 1.278228028 | −0.516993333 | 0.516993333 | 0.000838064 | 0.1577 |
| 67 | 2710653 | FBXO38 | F-box protein 38 | 81545 | NM_030793.3 | −0.149047116 | 0.51550975 | 0.51550975 | 0.000663438 | 0.1577 |
| 68 | 7200433 | NULL | NULL | NULL | BF434110 | 0.123387473 | −0.515143069 | 0.515143069 | 0.000670364 | 0.1577 |
| 69 | 4210129 | ELOVL5 | “ELOVL family member 5, | 60481 | NM_021814.3 | −0.284710319 | 0.515004341 | 0.515004341 | 0.000673001 | 0.1577 |
| | | | elongation of long chain fatty acids | | | | | | | |
| | | | (FEN1/Elo2, SUR4/Elo3-like, | | | | | | | |
| 70 | 270544 | NR2C1 | “nuclear receptor subfamily 2, | 7181 | NM_003297.1 | −0.155303368 | 0.514911933 | 0.514911933 | 0.000674763 | 0.1577 |
| | | | group C, member 1” | | | | | | | |
| 71 | 1710646 | C11orf63 | chromosome 11 open reading frame | 79864 | NM_024806.2 | −0.036113925 | 0.513815279 | 0.513815279 | 0.000695986 | 0.1577 |
| | | | 63 | | | | | | | |
| 72 | 4250154 | NULL | NULL | 648749 | XM_937834.2 | −0.061658345 | 0.513627958 | 0.513627958 | 0.00069967 | 0.1577 |
| 73 | 5670739 | AZU1 | azurocidin 1 | 566 | NM_001700.3 | 0.606626505 | −0.513100443 | 0.513100443 | 0.000710138 | 0.1577 |
| 74 | 3990563 | IFNA10 | “interferon, alpha 10” | 3446 | NM_002171.1 | 0.151388979 | −0.512771949 | 0.512771949 | 0.000716727 | 0.1577 |
| 75 | 6200678 | NULL | NULL | NULL | AA889171 | 0.058541514 | −0.512743528 | 0.512743528 | 0.000717299 | 0.1577 |
| 76 | 2320577 | SSR2 | “signal sequence receptor, beta | 6746 | XM_945427.1 | 0.064320484 | −0.512114597 | 0.512114597 | 0.000730076 | 0.1577 |
| | | | (translocon-essociated protein | | | | | | | |
| | | | beta)” | | | | | | | |
| 77 | 7160332 | NULL | NULL | NULL | CF552427 | 0.054930882 | −0.512069207 | 0.512069207 | 0.000731006 | 0.1577 |
| 78 | 1570392 | IL21R | interleukin 21 receptor | 50615 | NM_181078.1 | 0.057079914 | −0.512060675 | 0.512060675 | 0.000731181 | 0.1577 |
| 79 | 450195 | Sept7 | septin 7 | 989 | NM_001788.4 | −0.31815245 | 0.511500444 | 0.511500444 | 0.000742747 | 0.1577 |
| 80 | 6590278 | CBX2 | “chromobox homolog 2 (Pc class | 84733 | NM_005189.1 | 0.077041967 | −0.511473889 | 0.511473889 | 0.0007433 | 0.1577 |
| | | | homolog Drosophila)” | | | | | | | |
| 81 | 6280521 | NULL | NULL | 648399 | XM_937448.1 | −0.092941768 | 0.509883609 | 0.509883609 | 0.000777049 | 0.1621 |
| 82 | 4810072 | TUSC2 | tumor suppressor candidate 2 | 11334 | NM_007275.1 | 0.162628207 | −0.509587506 | 0.509587506 | 0.000783482 | 0.1621 |
| 83 | 2600204 | SACM1L | SAC1 suppressor of actin | 22908 | NM_014016.2 | −0.262966982 | 0.508788843 | 0.508788843 | 0.000801069 | 0.1638 |
| | | | mutations 1-like (yeast) | | | | | | | |
| 84 | 2360672 | TNFRSF19 | “tumor necrosis factor receptor | 55504 | NM_148957.2 | 0.070969941 | −0.507699006 | 0.507699006 | 0.000825635 | 0.1661 |
| | | | superfamily, member 19” | | | | | | | |
| 85 | 4010195 | COL6A2 | “collagen, type VI, alpha 2” | 1292 | NM_058175.2 | 0.063152686 | −0.507000048 | 0.507000048 | 0.00084174 | 0.1661 |
| 86 | 4850093 | NULL | NULL | 649596 | XM_938659.1 | 0.101165023 | −0.506996656 | 0.506996656 | 0.000841819 | 0.1661 |
| 87 | 3930561 | PRKCI | “protein kinase C. iota” | 6584 | NM_002740.5 | −0.105841727 | 0.506274935 | 0.506274935 | 0.000856744 | 0.1675 |
| 88 | 2970196 | DEFB125 | “defensin, beta 125” | 245938 | NM_153325.2 | 0.07618092 | −0.505487341 | 0.505487341 | 0.000877558 | 0.1684 |
| 89 | 2850379 | NULL | NULL | NULL | BC032017 | 0.065153173 | −0.504716304 | 0.504716304 | 0.00089633 | 0.1684 |
| 90 | 7320424 | HNRPA1L-2 | — | 664709 | NR_002944.2 | −0.432630765 | 0.504548219 | 0.504548219 | 0.00090047 | 0.1684 |
| 91 | 2070019 | UBA6 | ubiquitin-like modifier activating | 55236 | NM_018227.5 | −0.194843638 | 0.504433181 | 0.504433181 | 0.000903313 | 0.1684 |
| | | | enzyme 6 | | | | | | | |
| 92 | 2940767 | CEBPE | “CCAAT/enhancer binding protein | 1053 | NM_001805.2 | 0.145286933 | −0.503471709 | 0.503471709 | 0.000927387 | 0.171 |
| | | | (C/EBP), epsilon” | | | | | | | |
| 93 | 5910463 | PKIA | “protein kinase (cAMP-dependent, | 5569 | NM_006823.2 | −0.254561014 | 0.501973023 | 0.501973023 | 0.000966051 | 0.1714 |
| | | | catalytio) inhibitor alpha” | | | | | | | |
| 94 | 6550750 | ARMC8 | armadillo repeat containing 8 | 25852 | NM_014154.2 | −0.087200394 | 0.501272073 | 0.501272073 | 0.000984621 | 0.1714 |
| 95 | 4010632 | LQK1 | — | 642948 | XM_927142.1 | 0.072739876 | −0.500272952 | 0.500272952 | 0.001011638 | 0.1714 |
| 96 | 2350288 | NULL | NULL | NULL | CA429430 | 0.061870864 | −0.500162546 | 0.500162546 | 0.001014664 | 0.1714 |
| 97 | 5420053 | CCT6P1 | “chaperonin containing TCP1, | 643253 | NR_003110.2 | −0.281922881 | 0.49954008 | 0.49954008 | 0.001031872 | 0.1714 |
| | | | subunit 6 (zeta) pseudogene 1” | | | | | | | |
| 98 | 4590692 | PCDH24 | protocadherin 24 | 54825 | NM_017675.3 | 0.053628265 | −0.499137989 | 0.499137989 | 0.001043126 | 0.1714 |
| 99 | 840601 | MEGF10 | multiple EGF-like-domains 10 | 84466 | NM_032446.1 | 0.047723662 | −0.499051274 | 0.499051274 | 0.001045567 | 0.1714 |
| 100 | 1500735 | CTSG | cathepsin G | 1511 | NM_001911.2 | 1.254662256 | −0.498929923 | 0.498929923 | 0.001048992 | 0.1714 |
| 101 | 7650524 | BCAT1 | “branched chain aminotransferase | 586 | NM_005504.4 | 0.161097122 | −0.498874361 | 0.498874361 | 0.001050563 | 0.1714 |
| | | | 1, cytosolic” | | | | | | | |
| 102 | 4570170 | KIAA0947 | — | 23379 | NM_015325.1 | −0.180354486 | 0.498739242 | 0.498739242 | 0.001054393 | 0.1714 |
| 103 | 2370041 | LRRN3 | leucine rich repeat neuronal 3 | 54674 | NM_018334.3 | −0.383213794 | 0.498520298 | 0.498520298 | 0.001060626 | 0.1714 |
| 104 | 2120537 | SPOCD1 | SPOC domain containing 1 | 90853 | NM_144569.4 | 0.09473433 | −0.498432827 | 0.498432827 | 0.001063125 | 0.1714 |
| 105 | 7560300 | TCTEX1D1 | Tctex1 domain containing 1 | 200132 | NM_152665.1 | 0.124259481 | −0.498376405 | 0.498376405 | 0.001064739 | 0.1714 |
| 106 | 5550711 | SYNE1 | “spectrin repeat containing, nuclear | 23345 | NM_182951.2 | 0.075512374 | −0.497880756 | 0.497880756 | 0.001079019 | 0.1714 |
| | | | envelope 1” | | | | | | | |
| 107 | 3060288 | NAIP | “NLR family, apoptosis inhibitory | 4671 | NM_004536.2 | 0.073560957 | −0.497822596 | 0.497822596 | 0.001080705 | 0.1714 |
| | | | protein” | | | | | | | |
| 108 | 6380373 | TUBE1 | “tubulin, epsilon 1” | 51175 | NM_016262.3 | −0.138726153 | 0.496861389 | 0.496861389 | 0.00110892 | 0.1742 |
| 109 | 990044 | KIAA1147 | KIAA1147 | 57189 | XM_001130020.1 | −0.162506963 | 0.496349996 | 0.496349996 | 0.001124197 | 0.175 |
| 110 | 7380707 | ZFAND1 | “zine finger, AN1-type domain 1” | 79752 | NM_024699.1 | −0.254784176 | 0.495918538 | 0.495918538 | 0.00113723 | 0.1751 |
| 111 | 5720703 | AKTIP | AKT interacting protein | 64400 | NM_022476.2 | −0.132110131 | 0.495659163 | 0.495659163 | 0.001145129 | 0.1751 |
| 112 | 6520315 | NULL | NULL | NULL | BC033504 | 0.0764326 | −0.494719268 | 0.494719268 | 0.001174163 | 0.1779 |
| 113 | 270091 | C19orf68 | chromosome 19 open reading frame | 374920 | NM_199341.1 | 0.052642885 | −0.494044806 | 0.494044806 | 0.001195398 | 0.1787 |
| | | | 68 | | | | | | | |
| 114 | 580014 | C12orf43 | chromosome 12 open reading frame | 64897 | NM_022895.1 | −0.20852646 | 0.493884539 | 0.493884539 | 0.001200494 | 0.1787 |
| | | | 43 | | | | | | | |
| 115 | 1170268 | PRMT1 | protein arginine methyltransferase 1 | 3276 | NM_198319.2 | 0.067974089 | −0.493547647 | 0.493547647 | 0.001211268 | 0.1787 |
| 116 | 4180142 | KIAA1370 | KIAA1370 | 56204 | NM_019600.1 | −0.224639294 | 0.492945505 | 0.492945505 | 0.001230739 | 0.18 |
| 117 | 6860148 | SLC9A6 | “solute carrier family 9 | 10479 | NM_001042537.1 | −0.17456976 | 0.491943559 | 0.491943559 | 0.001263753 | 0.1827 |
| | | | (sodium/hydrogen exchanger), | | | | | | | |
| | | | member 6” | | | | | | | |
| 118 | 1990487 | XRN1 | 5′-3′ exoribonuclease 1 | 54464 | NM_019001.2 | −0.23813416 | 0.491542716 | 0.491542716 | 0.001277179 | 0.1827 |
| 119 | 1230270 | WTIP | Wilms tumor 1 interacting protein | 126374 | XM_059037.7 | 0.07763865 | −0.49141535 | 0.49141535 | 0.001281471 | 0.1827 |
| 120 | 7510164 | SCAMP5 | secretory carrier membrane protein 5 | 192683 | NM_138967.2 | 0.0812625 | −0.490826456 | 0.490826456 | 0.001301484 | 0.183 |
| 121 | 4760243 | NULL | NULL | 646210 | XR_016923.1 | −0.404442095 | 0.490196486 | 0.490196486 | 0.001323199 | 0.183 |
| 122 | 3290689 | C14orf166 | chromosome 14 open reading frame | 51637 | NM_016039.1 | −0.321385016 | 0.490154831 | 0.490154831 | 0.001324646 | 0.183 |
| | | | 166 | | | | | | | |
| 123 | 3780469 | SMARCA5 | “SWI/SNF related, matrix | 8467 | NM_003601.2 | −0.115124978 | 0.489947033 | 0.489947033 | 0.001331886 | 0.183 |
| | | | associated, actin dependent | | | | | | | |
| | | | regulator of chromatin, subfamily a, | | | | | | | |
| 124 | 730373 | LOC388621 | — | 388621 | XM_941195.2 | −0.448108038 | 0.48978157 | 0.48978157 | 0.001337675 | 0.183 |
| 125 | 3990561 | LV6H | “lymphocyte antigen 6 complex, | 4062 | NM_002347.2 | 0.197994096 | −0.48850596 | 0.48850596 | 0.001383063 | 0.1843 |
| | | | locus H” | | | | | | | |
| 126 | 6760326 | ZNF658 | zinc finger protein 658 | 26149 | NM_033160.4 | −0.078993442 | 0.487877369 | 0.487877369 | 0.001405927 | 0.1843 |
| 127 | 2340091 | NULL | NULL | 646135 | XM_933437.1 | 0.111295385 | −0.487712861 | 0.487712861 | 0.001411965 | 0.1843 |
| 128 | 4220114 | NULL | NULL | NULL | DA160411 | 0.070349309 | −0.487568568 | 0.487568568 | 0.00141728 | 0.1843 |
| 129 | 5910131 | PDE6H | “phosphodiesterase 6H, cGMP- | 5149 | NM_006205.1 | 0.060610886 | −0.487328442 | 0.487328442 | 0.001426165 | 0.1843 |
| | | | specific, cone, gamma” | | | | | | | |
| 130 | 4610138 | CAPZA1 | “capping protein (actin filament) | 829 | NM_006135.1 | −0.36644329 | 0.487145738 | 0.487145738 | 0.001432958 | 0.1843 |
| | | | muscle Z-line, alpha 1” | | | | | | | |
| 131 | 160537 | KDSR | 3-ketodihydrosphingosine | 2531 | NM_002035.1 | −0.165230376 | 0.487124003 | 0.487124003 | 0.001433768 | 0.1843 |
| | | | reductase | | | | | | | |
| 132 | 4540138 | NGB | neuroglobin | 58157 | NM_021257.3 | 0.062540263 | −0.487061726 | 0.487061726 | 0.001436091 | 0.1843 |
| 133 | 3440670 | NULL | NULL | 402251 | XM_377933.3 | −0.279019599 | 0.48643729 | 0.48643729 | 0.00145957 | 0.1843 |
| 134 | 2000162 | C5orf20 | chromosome 5 open reading frame | 140947 | NM_130848.2 | 0.086688645 | −0.486295653 | 0.486295653 | 0.001464943 | 0.1843 |
| | | | 20 | | | | | | | |
| 135 | 520215 | UBE2V1 | ubiquitin-conjugating enzyme E2 | 7335 | NM_001032288.1 | 0.104438712 | −0.48626056 | 0.48626056 | 0.001466277 | 0.1843 |
| | | | variant 1 | | | | | | | |
| 136 | 4150553 | TAF13 | “TAF13 RNA polymerase II, TATA | 6884 | NM_005645.3 | 0.061312413 | −0.485315546 | 0.485315546 | 0.001502601 | 0.1857 |
| | | | box binding protein (TBP)- | | | | | | | |
| | | | associated factor, 18 kDa” | | | | | | | |
| 137 | 4640739 | NULL | NULL | NULL | AL120241 | −0.069719279 | 0.485027915 | 0.485027915 | 0.001513814 | 0.1857 |
| 138 | 60053 | RPL11 | ribosomal protein L11 | 6135 | NM_000975.2 | −0.156372832 | 0.484070445 | 0.484070445 | 0.001551674 | 0.1857 |
| 139 | 6180463 | CNNM3 | cyclin M3 | 26505 | NM_017623.4 | 0.168754951 | −0.484039615 | 0.484039615 | 0.001552907 | 0.1857 |
| 140 | 2710020 | NULL | NULL | NULL | BX093329 | 0.068337239 | −0.483771626 | 0.483771626 | 0.00156366 | 0.1857 |
| 141 | 1090692 | GPBP1 | GC-rich promoter binding protein 1 | 65056 | NM_022913.1 | −0.264875927 | 0.483664554 | 0.483664554 | 0.001567975 | 0.1857 |
| 142 | 5360719 | MAPK9 | mitogen-activated protein kinase 9 | 5601 | NM_002752.3 | −0.123212945 | 0.483410076 | 0.483410076 | 0.001578271 | 0.1857 |
| 143 | 7550066 | MERTK | c-mer proto-oncogene tyrosine | 10461 | NM_006343.2 | 0.178168499 | −0.483308071 | 0.483308071 | 0.001582415 | 0.1857 |
| | | | kinase | | | | | | | |
| 144 | 1980628 | SMARCA5 | “SWI/SNF related, matrix | 8467 | NM_003601.2 | −0.146115776 | 0.483245604 | 0.483245604 | 0.001584958 | 0.1857 |
| | | | associated, actin dependent | | | | | | | |
| | | | regulator of chromatin, subfamily a, | | | | | | | |
| 145 | 6980253 | PTPLB | “protein tyrosine phosphatase-like | 201562 | NM_198402.2 | −0.336175973 | 0.483199931 | 0.483199931 | 0.001586819 | 0.1857 |
| | | | (proline instead of catalytic | | | | | | | |
| | | | arginine), member b” | | | | | | | |
| 146 | 5560465 | NOP56 | NOP56 ribonucleoprotein homolog | 10528 | NM_006392.2 | −0.266935568 | 0.482908033 | 0.482908033 | 0.00159876 | 0.1858 |
| | | | (yeast) | | | | | | | |
| 147 | 730288 | COG3 | component of oligomeric golgi | 83548 | NM_031431.2 | −0.128112796 | 0.482057164 | 0.482057164 | 0.001634022 | 0.1881 |
| | | | complex 3 | | | | | | | |
| 148 | 6110747 | GIMAP2 | “GTPase, IMAP family member 2” | 26157 | NM_015660.2 | −0.45531031 | 0.481664524 | 0.481664524 | 0.001850524 | 0.1881 |
| 149 | 1500201 | HNRNPC | heterogeneous nuclear | 3183 | NM_031314.1 | −0.397999182 | 0.481642829 | 0.481642829 | 0.00165144 | 0.1881 |
| | | | ribonucleoprotein C (C1/C2) | | | | | | | |
| 150 | 1570491 | hCG_2015956 | — | 648000 | XM_371757.5 | −0.31840088 | 0.481241081 | 0.481241081 | 0.001668486 | 0.1887 |
| 151 | 4540356 | UFM1 | ubiquitin-fold modifier 1 | 51569 | NM_016617.1 | −0.290998607 | 0.480702355 | 0.480702355 | 0.001691587 | 0.1901 |
| 152 | 7000474 | GARNL1 | GTPase activating Rap/RanGAP | 253959 | NM_194301.2 | −0.175348366 | 0.480353096 | 0.480353096 | 0.001706713 | 0.1905 |
| | | | domain-like 1 | | | | | | | |
| 153 | 7380382 | RNF115 | ring finger protein 115 | 27246 | NM_014455.1 | 0.278371033 | −0.479876191 | 0.479876191 | 0.001727561 | 0.1916 |
| 154 | 3060040 | PABPC1 | “poly(A) binding protein, | 26986 | NM_002568.3 | −0.393451244 | 0.479514498 | 0.479514498 | 0.001743522 | 0.1919 |
| | | | cytoplasmic 1” | | | | | | | |
| 155 | 2570132 | CLEC2D | “C-type lectin domain family 2, | 29121 | NM_001004419.2 | −0.163087579 | 0.479273474 | 0.479273474 | 0.00175423 | 0.1919 |
| | | | member D” | | | | | | | |
| 156 | 5900731 | SFRS12 | “splicing factor, arginine/serine- | 140890 | NM_001077199.1 | −0.290167988 | 0.47882202 | 0.47882202 | 0.001774443 | 0.1919 |
| | | | rich 12” | | | | | | | |
| 157 | 2360754 | LSM14B | “LSM14B, SCD6 homolog B | 149986 | NM_144703.2 | 0.096185097 | −0.47854662 | 0.47854662 | 0.001786874 | 0.1919 |
| | | | (S. cerevisiae)” | | | | | | | |
| 158 | 840403 | TSPAN17 | tetraspanin 17 | 26262 | NM_130465.3 | 0.154915647 | −0.478510302 | 0.478510302 | 0.001788519 | 0.1919 |
| 159 | 3990564 | CCDC89 | coiled-coil domain containing 89 | 220388 | NM_152723.1 | 0.204429972 | −0.478138699 | 0.478138699 | 0.001805428 | 0.1919 |
| 160 | 1990093 | NULL | NULL | NULL | BC042493 | 0.047968793 | −0.477656393 | 0.477656393 | 0.001827585 | 0.1919 |
| 161 | 3990441 | ABCC13 | “ATP-binding cassette. sub-family | 150000 | NR_003087.1 | 0.143883548 | −0.477586579 | 0.477586579 | 0.001830812 | 0.1919 |
| | | | C (CFTR/MRP), member 13” | | | | | | | |
| 162 | 6940433 | STAT5B | signal transducer and activator of | 6777 | NM_012448.3 | −0.24015242 | 0.477561066 | 0.477561066 | 0.001831992 | 0.1919 |
| | | | transcription 5B | | | | | | | |
| 163 | 6060553 | RBP5 | “retinol binding protein 5, cellular” | 83758 | NM_031491.1 | 0.051243739 | −0.47707584 | 0.47707584 | 0.001854572 | 0.1924 |
| 164 | 770021 | PRKRA | “protein kinase, interferon-inducible | 8575 | NM_003690.3 | −0.229357783 | 0.476977269 | 0.476977269 | 0.001859189 | 0.1924 |
| | | | double stranded RNA dependant | | | | | | | |
| | | | activator” | | | | | | | |
| 165 | 2360630 | FDFT1 | farnesyl-diphosphate | 2222 | NM_004462.3 | −0.242595956 | 0.476367672 | 0.476367672 | 0.001887967 | 0.1942 |
| | | | farnesyltransferase 1 | | | | | | | |
| 166 | 5570161 | KCNJ14 | “potassium inwardly-rectifying | 3770 | NM_170720.1 | 0.076087153 | −0.475749323 | 0.475749323 | 0.001917559 | 0.1947 |
| | | | channel, subfamily J, member 14” | | | | | | | |
| 167 | 3120762 | MSH5 | mutS homolog 5 (E. coli) | 4438 | NM_002441.3 | 0.058093161 | −0.475672606 | 0.475672606 | 0.001921258 | 0.1947 |
| 168 | 6280747 | NULL | NULL | 643240 | XM_926602.1 | 0.057101502 | −0.475541877 | 0.475541877 | 0.001927577 | 0.1947 |
| 169 | 4780767 | FLJ40473 | — | 285226 | XR_001031.1 | −0.068012051 | 0.474724843 | 0.474724843 | 0.001967486 | 0.1968 |
| 170 | 290632 | NULL | NULL | NULL | DB337375 | 0.05951249 | −0.474639429 | 0.474639429 | 0.001971699 | 0.1968 |
| 171 | 3360100 | IDH3A | isocitrate dehydrogenase 3 (NAD+) | 3419 | NM_005530.2 | −0.146008756 | 0.474175832 | 0.474175832 | 0.001994708 | 0.1979 |
| | | | alpha | | | | | | | |
| 172 | 7150270 | LRRC26 | leucine rich repeat containing 26 | 389816 | NM_001013653.2 | 0.105999587 | −0.472964535 | 0.472964535 | 0.00205595 | 0.2028 |
| 173 | 7610113 | SLC26A8 | “solute carrier family 26, member | 116369 | NM_138718.1 | 0.063661004 | −0.472306817 | 0.472306817 | 0.002089891 | 0.2028 |
| | | | B” | | | | | | | |
| 174 | 6650646 | C4orf39 | chromosome 4 open reading frame | 152756 | NM_153027.1 | −0.056865183 | 0.472186172 | 0.472186172 | 0.00209617 | 0.2028 |
| | | | 39 | | | | | | | |
| 175 | 3390309 | FAM74A4 | “family with sequence similarity 74, | 401508 | NM_207507.1 | 0.052989269 | −0.471884728 | 0.471884728 | 0.002111932 | 0.2028 |
| | | | member A4” | | | | | | | |
| 176 | 5860327 | PRPF1B | PRP18 pre-mRNA processing | 8559 | NM_003675.3 | −0.26670234 | 0.471782594 | 0.471782594 | 0.002117296 | 0.2028 |
| | | | factor 18 homolog (S. cerevisiae) | | | | | | | |
| 177 | 1090367 | BIVM | “basic, immunoglobulin-like variable | 54841 | NM_017693.2 | −0.126644305 | 0.471623506 | 0.471623506 | 0.002125674 | 0.2028 |
| | | | motif containing” | | | | | | | |
| 178 | 2570725 | PPCS | phosphopantothenoylcysteine | 79717 | NM_001077447.1 | −0.310167811 | 0.471401485 | 0.471401485 | 0.002137416 | 0.2028 |
| | | | synthetase | | | | | | | |
| 179 | 8110091 | WSB1 | WD repeat and SOCS box- | 26118 | NM_134265.2 | −0.29256262 | 0.471357938 | 0.471357938 | 0.002139726 | 0.2028 |
| | | | containing 1 | | | | | | | |
| 180 | 1110102 | HS2ST1 | heparan sulfate 2-O- | 9853 | NM_012262.2 | −0.075582168 | 0.470862477 | 0.470862477 | 0.002186161 | 0.2033 |
| | | | sulfotransferase 1 | | | | | | | |
| 181 | 4010452 | SLC38A6 | “solute carrier family 38, member | 145389 | NM_153811.1 | −0.130358094 | 0.470802009 | 0.470802009 | 0.002169407 | 0.2033 |
| | | | 6” | | | | | | | |
| 182 | 3130543 | RNASE3 | “ribonuclease, RNase A family, 3 | 6037 | NM_002935.2 | 0.573752609 | −0.470400954 | 0.470400954 | 0.002191043 | 0.2033 |
| | | | (eosinophil cationic protein)” | | | | | | | |
| 183 | 4180709 | SPAG5 | sperm associated antigen 5 | 10615 | NM_006461.3 | 0.043518097 | −0.470381365 | 0.470381365 | 0.002192104 | 0.2033 |
| 184 | 2340601 | AMMECR1 | “Alport syndrome, mental | 9949 | NM_015365.2 | −0.137410703 | 0.469981776 | 0.469981776 | 0.002213859 | 0.2042 |
| | | | retardation, midface hypoplasia and | | | | | | | |
| | | | elliptocytosis chromosomal region | | | | | | | |
| 185 | 5870326 | SLC2A8 | “solute carrier family 2 (facilitated | 29988 | NM_014580.3 | 0.183791974 | −0.468266194 | 0.468266194 | 0.002309432 | 0.2118 |
| | | | glucose transporter), member 8” | | | | | | | |
| 186 | 610367 | HECA | headcase homolog (Drosophila) | 51696 | NM_016217.2 | −0.312188865 | 0.467582354 | 0.467582354 | 0.002348527 | 0.2142 |
| 187 | 6510619 | NAE1 | NEDD8 activating enzyme E1 | 8883 | NM_001018160.1 | −0.29276015 | 0.467293313 | 0.467293313 | 0.002365226 | 0.2146 |
| | | | subunit 1 | | | | | | | |
| 188 | 6100170 | NULL | NULL | NULL | AI004472 | 0.074355718 | −0.466767709 | 0.466767709 | 0.002395858 | 0.2155 |
| 189 | 2570358 | HNRPDL | heterogeneous nuclear | 9987 | NM_031372.1 | −0.382998221 | 0.46668552 | 0.46668552 | 0.00240068 | 0.2155 |
| | | | ribonucleoprotein D-like | | | | | | | |
| 190 | 1690600 | FAM53B | “family with sequence similarity 53, | 9679 | NM_014661.3 | 0.082502036 | −0.465522685 | 0.465522685 | 0.002469813 | 0.2204 |
| | | | member B” | | | | | | | |
| 191 | 2230538 | LRRN3 | leucine rich repeat neuronal 3 | 54674 | NM_001099660.1 | −0.625504431 | 0.465045112 | 0.465045112 | 0.002498708 | 0.2204 |
| 192 | 4610519 | NULL | NULL | NULL | BU753725 | 0.072652165 | −0.464655359 | 0.464655359 | 0.002522509 | 0.2204 |
| 193 | 6200593 | CCDC15 | coiled-coil domain containing 15 | 80071 | NM_025004.2 | −0.055337923 | 0.464591132 | 0.464591132 | 0.002526451 | 0.2204 |
| 194 | 1580286 | SEH1L | SEH1-like (S. cerevisiae) | 81929 | NM_031216.3 | −0.083010039 | 0.464510779 | 0.464510779 | 0.002531389 | 0.2204 |
| 195 | 5050402 | HIST1H2BK | “histone cluster 1, H2bk” | 85236 | NM_080593.1 | 0.379454337 | −0.464481722 | 0.464481722 | 0.002533177 | 0.2204 |
| 196 | 1850300 | TC2N | “tandem C2 domains, nuclear” | 123036 | NM_152332.3 | −0.236871126 | 0.463622849 | 0.463622849 | 0.002586527 | 0.2232 |
| 197 | 3610376 | NULL | NULL | NULL | BM717102 | 0.080470357 | −0.463547722 | 0.463547722 | 0.00259124 | 0.2232 |
| 198 | 7400377 | CEACAM6 | carcinoembryonic antigen-related | 4680 | NM_002483.3 | 0.588920001 | −0.462719693 | 0.462719693 | 0.002643687 | 0.2266 |
| | | | cell adhesion molecule 6 (non- | | | | | | | |
| | | | specific cross reacting antigen) | | | | | | | |
| 199 | 2030477 | OTP | orthopedia homeobox | 23440 | NM_032109.2 | 0.058004572 | −0.462346154 | 0.462346154 | 0.002667651 | 0.2271 |
| 200 | 3360215 | NULL | NULL | NULL | BQ183460 | 0.053186883 | −0.462195315 | 0.462195315 | 0.002677381 | 0.2271 |
| 201 | 6420730 | RPL9 | ribosomal protein L9 | 6133 | NM_001024921.2 | −0.56653985 | 0.462002078 | 0.462002078 | 0.002689892 | 0.2271 |
| 202 | 3780670 | NGLY1 | N-glycanase 1 | 55768 | NM_018297.2 | −0.197659111 | 0.46152437 | 0.46152437 | 0.002721041 | 0.2279 |
| 203 | 1230593 | SP3 | Sp3 transcription factor | 6670 | NM_001017371.3 | −0.175703429 | 0.461118519 | 0.461118519 | 0.002747753 | 0.2279 |
| 204 | 5900128 | NULL | NULL | 391817 | XM_936708.1 | −0.044221454 | 0.461068597 | 0.461068597 | 0.002751055 | 0.2279 |
| 205 | 7400376 | RABL2A | “RAB, member of RAS oncogene | 11159 | NM_013412.1 | −0.178370764 | 0.460558719 | 0.460558719 | 0.002784974 | 0.2279 |
| | | | family-like 2A” | | | | | | | |
| 206 | 6380768 | EIF4E | eukaryotic translation initiation | 1977 | NM_001968.2 | −0.084050702 | 0.460244198 | 0.460244198 | 0.00280608 | 0.2279 |
| | | | factor 4E | | | | | | | |
| 207 | 5310747 | PSIP1 | PC4 and SFRS1 interacting protein 1 | 11168 | NM_033222.2 | −0.298779917 | 0.460104407 | 0.460104407 | 0.002815505 | 0.2279 |
| 208 | 110195 | LOC646197 | — | 646197 | XM_929153.1 | −0.239784184 | 0.459988242 | 0.459988242 | 0.002823359 | 0.2279 |
| 209 | 7380068 | CNBP | “CCHC-type zinc finger, nucleic | 7555 | NM_003418.1 | −0.327720874 | 0.45994846 | 0.45994846 | 0.002826053 | 0.2279 |
| | | | acid binding protein” | | | | | | | |
| 210 | 6020575 | NNT | nicotinamide nucleotide | 23530 | NM_012343.3 | −0.191702435 | 0.459704691 | 0.459704691 | 0.00284261 | 0.2279 |
| | | | transhydrogenase | | | | | | | |
| 211 | 3180438 | RPS3A | ribosomal protein S3A | 6189 | NM_001006.3 | −0.215689394 | 0.459396504 | 0.459396504 | 0.002863663 | 0.2279 |
| 212 | 6590441 | TRIP12 | thyroid hormone receptor interactor | 9320 | NM_004238.1 | −0.196624966 | 0.459371285 | 0.459371285 | 0.002865392 | 0.2279 |
| | | | 12 | | | | | | | |
| 213 | 4150408 | P2RY2 | “purinergic receptor P2Y, G-protein | 5029 | NM_002564.2 | 0.182075591 | −0.459094109 | 0.459094109 | 0.002884454 | 0.2279 |
| | | | coupled, 2” | | | | | | | |
| 214 | 6020598 | PMAIP1 | phorbol-12-myristate-13-acetate- | 5366 | NM_021127.1 | −0.206408928 | 0.458725976 | 0.458725976 | 0.002909942 | 0.2279 |
| | | | induced protein 1 | | | | | | | |
| 215 | 3780382 | DKFZp761E198 | — | 91056 | NM_138368.3 | 0.361999782 | −0.458706675 | 0.458706675 | 0.002911284 | 0.2279 |
| 216 | 4570008 | EXOG | “endo/exonuclease (5′-3′), | 9941 | NM_005107.2 | 0.223001865 | −0.458501321 | 0.458501321 | 0.002925593 | 0.2279 |
| | | | endonuclease G-like” | | | | | | | |
| 217 | 7550341 | HIGD1A | “HIG1 domain family, member 1A” | 25994 | NM_014056.1 | −0.279289648 | 0.458461556 | 0.458461556 | 0.002928371 | 0.2279 |
| 218 | 2640551 | CMPK1 | “cytidine monophosphate (UMP- | 51727 | NM_016308.1 | −0.272595837 | 0.458061071 | 0.458061071 | 0.002956478 | 0.2279 |
| | | | CMP) kinase 1, cytosolic” | | | | | | | |
| 219 | 1010315 | LINS1 | lines homolog 1 (Drosophila) | 55180 | NM_001040614.1 | −0.286168405 | 0.458036973 | 0.458036973 | 0.002958177 | 0.2279 |
| 220 | 870040 | ASCC3 | activating signal cointegrator 1 | 10973 | NM_006828.2 | −0.10465835 | 0.457844382 | 0.457844382 | 0.002971785 | 0.2279 |
| | | | complex subunit 3 | | | | | | | |
| 221 | 5820202 | LOC644131 | — | 644131 | XR_018325.1 | −0.244724622 | 0.457679581 | 0.457679581 | 0.002983472 | 0.2279 |
| 222 | 130670 | ZDHHC5 | “zinc finger, DHHC-type containing | 25921 | NM_015457.2 | 0.193270447 | −0.457640394 | 0.457640394 | 0.002986257 | 0.2279 |
| | | | 5” | | | | | | | |
| 223 | 2370754 | G3BP2 | GTPase activating protein (SH3 | 9908 | NM_012297.3 | 0.055347977 | −0.457521539 | 0.457521539 | 0.002994718 | 0.2279 |
| | | | domain) binding protein 2 | | | | | | | |
| 224 | 6250615 | PGLYRP1 | peptidoglycan recognition protein 1 | 8993 | NM_005091.1 | 0.663365274 | −0.456858765 | 0.456858765 | 0.003042283 | 0.2305 |
| 225 | 6450538 | TCERG1 | transcription elongation regulator 1 | 10915 | NM_006706.3 | −0.153163323 | 0.455894063 | 0.455894063 | 0.003112699 | 0.2315 |
| 226 | 4200022 | MIRHG1 | microRNA host gene 1 (non-protein | 407975 | XM_931088.1 | −0.087998961 | 0.455880766 | 0.455880766 | 0.003113679 | 0.2315 |
| | | | coding) | | | | | | | |
| 227 | 6510441 | NULL | NULL | NULL | AW337309 | 0.053375479 | −0.455703686 | 0.455703686 | 0.003126762 | 0.2315 |
| 228 | 1990132 | USH1G | Usher syndrome 1G (autosomal | 124590 | NM_173477.2 | 0.052441261 | −0.455661664 | 0.455661664 | 0.003129874 | 0.2315 |
| | | | recessive) | | | | | | | |
| 229 | 3800647 | UGCG | UDP-glucose ceramide | 7357 | NM_003358.1 | 0.348634208 | −0.455608899 | 0.455608899 | 0.003133785 | 0.2315 |
| | | | glucosyltransferase | | | | | | | |
| 230 | 8900044 | AMN1 | antagonist of mitotic exit network 1 | 196394 | NM_207337.1 | −0.126543905 | 0.45510482 | 0.45510482 | 0.003171363 | 0.2315 |
| | | | homolog (S. cerevisiae) | | | | | | | |
| 231 | 4560270 | PTPLB | “protein tyrosine phosphatase-like | 201582 | NM_198402.2 | −0.266540406 | 0.455059166 | 0.455059166 | 0.003174786 | 0.2315 |
| | | | (proline instead of catalytic | | | | | | | |
| | | | arginine), member b” | | | | | | | |
| 232 | 3710681 | ARFGEF1 | ADP-ribosylation factor guanine | 10565 | NM_006421.3 | −0.094839399 | 0.454851268 | 0.454851268 | 0.003190414 | 0.2315 |
| | | | nucleotide-exchange factor | | | | | | | |
| | | | 1(brefeldin A-inhibited) | | | | | | | |
| 233 | 4540689 | ANKRD10 | ankyrin repeat domain 10 | 55608 | NM_017664.2 | −0.170575575 | 0.454839609 | 0.454839609 | 0.003191293 | 0.2315 |
| 234 | 4860762 | INPP4B | “inositol polyphosphate-4- | 8821 | NM_003866.1 | −0.281061337 | 0.454820734 | 0.454820734 | 0.003192715 | 0.2315 |
| | | | phosphatase, type II, 105 kDa” | | | | | | | |
| 235 | 2320594 | NULL | NULL | NULL | BX119501 | 0.089280604 | −0.454390975 | 0.454390975 | 0.003225254 | 0.2325 |
| 236 | 5690403 | NULL | NULL | 645550 | XM_928570.1 | −0.065705517 | 0.454284141 | 0.454284141 | 0.003233388 | 0.2325 |
| 237 | 3710682 | NULL | NULL | 642033 | XM_936103.1 | 0.143366073 | −0.453895065 | 0.453895065 | 0.003263162 | 0.2336 |
| 238 | 7570189 | GAGE6 | G antigen 6 | 2578 | NM_001476.1 | 0.084017945 | −0.453062273 | 0.453062273 | 0.003327698 | 0.2372 |
| 239 | 2120468 | C10orf58 | chromosome 10 open reading frame | 84293 | NM_032333.2 | −0.327354271 | 0.451962933 | 0.451962933 | 0.003414595 | 0.2389 |
| | | | 58 | | | | | | | |
| 240 | 1410170 | GOPC | golgi associated PDZ and coiled- | 57120 | NM_020399.2 | −0.088182858 | 0.45162816 | 0.45162816 | 0.003441448 | 0.2389 |
| | | | coil motif containing | | | | | | | |
| 241 | 3420068 | HAT1 | histone acetyltransferase 1 | 8520 | NM_003642.2 | −0.268653366 | 0.451449886 | 0.451449886 | 0.003455823 | 0.2389 |
| 242 | 4590349 | ACVR2A | “activin A receptor, type IIA” | 92 | NM_001616.3 | −0.105208688 | 0.45133743 | 0.45133743 | 0.003464917 | 0.2389 |
| 243 | 3370673 | GUSBL2 | “glucuronidase, beta-like 2” | 375513 | NM_206910.1 | 0.128073825 | −0.451300153 | 0.451300153 | 0.003467937 | 0.2389 |
| 244 | 2640255 | NULL | NULL | 641848 | XM_935588.1 | −0.645965338 | 0.45124504 | 0.45124504 | 0.003472405 | 0.2389 |
| 245 | 5960332 | SLC39A10 | “solute carrier family 39 (zinc | 57181 | NM_020342.1 | −0.147299889 | 0.451151515 | 0.451151515 | 0.003479999 | 0.2389 |
| | | | transporter), member 10” | | | | | | | |
| 246 | 4120056 | IQSEC2 | IQ motif and Sec7 domain 2 | 23096 | NM_015075.1 | 0.077724109 | −0.450780113 | 0.450780113 | 0.003510299 | 0.2389 |
| 247 | 5820392 | CCT6A | “chaperonin containing TCP1, | 908 | NM_001009186.1 | −0.24460782 | 0.450747413 | 0.450747413 | 0.003512977 | 0.2389 |
| | | | subunit 6A (zeta 1)” | | | | | | | |
| 248 | 2570112 | ABLIM1 | actin binding LIM protein 1 | 3983 | NM_006720.3 | −0.4799407 | 0.450454564 | 0.450454564 | 0.003537047 | 0.2389 |
| 249 | 2710735 | RASD1 | “RAS, dexamethasone-induced 1” | 51655 | NM_016084.3 | 0.176270502 | −0.450334284 | 0.450334284 | 0.003546974 | 0.2389 |
| 250 | 3390047 | FREM2 | FRAS1 related extracellular matrix | 341640 | NM_207361.4 | 0.062120756 | −0.450220577 | 0.450220577 | 0.003556381 | 0.2389 |
| | | | protein 2 | | | | | | | |
| 251 | 2900039 | XRCC5 | X-ray repair complementing | 7520 | NM_021141.2 | −0.210035123 | 0.450062106 | 0.450062106 | 0.003569529 | 0.2389 |
| | | | defective repair in Chinese hamster | | | | | | | |
| | | | cells 5 (double-strand-break | | | | | | | |
| 252 | 8550600 | MYC | v-mye myelocytomatosis viral | 4609 | NM_002467.3 | −0.337363684 | 0.450052467 | 0.450052467 | 0.00357033 | 0.2389 |
| | | | oncogene homolog (avian) | | | | | | | |
| 253 | 7400343 | STX2 | syntaxin 2 | 2054 | NM_001980.2 | −0.258793675 | 0.449998887 | 0.449998887 | 0.003574785 | 0.2389 |
| 254 | 2190390 | NCOA1 | nuclear receptor coactivator 1 | 8648 | NM_147223.2 | −0.208822548 | 0.449989658 | 0.449989658 | 0.003575553 | 0.2389 |
| 255 | 3710465 | C6orf211 | chromosome 6 open reading frame | 79624 | NM_024573.1 | −0.114858487 | 0.449508458 | 0.449508458 | 0.003615794 | 0.2397 |
| | | | 211 | | | | | | | |
| 256 | 6620356 | ARPP-19 | — | 10776 | NM_006628.4 | −0.261668585 | 0.449498501 | 0.449498501 | 0.003616631 | 0.2397 |
| 257 | 5900100 | BCR | breakpoint cluster region | 613 | NM_021574.2 | 0.074331836 | −0.449183958 | 0.449183958 | 0.003643153 | 0.2398 |
| 258 | 5360204 | NMD3 | NMD3 homolog (S. cerevisiae) | 51068 | NM_015938.3 | −0.201253758 | 0.449147407 | 0.449147407 | 0.003646246 | 0.2398 |
| 259 | 7320615 | NULL | NULL | NULL | DR731427 | 0.097655571 | −0.448768392 | 0.448768392 | 0.003678454 | 0.241 |
| 260 | 1070475 | RPL11 | ribosomal protein L11 | 6135 | NM_000975.2 | −0.145832491 | 0.448285553 | 0.448285553 | 0.003719844 | 0.2419 |
| 261 | 1430477 | CTSL2 | cathepsin L2 | 1515 | NM_001333.2 | 0.048311832 | −0.448097229 | 0.448097229 | 0.003736097 | 0.2419 |
| 262 | 6580609 | CNOT8 | “CCR4-NOT transcription complex, | 9337 | NM_004779.4 | −0.206326635 | 0.448051554 | 0.448051554 | 0.003740048 | 0.2419 |
| | | | subunit 8” | | | | | | | |
| 263 | 430100 | XRCC6 | X-ray repair complementing | 2547 | NM_001469.3 | −0.202101353 | 0.447948393 | 0.447948393 | 0.003748986 | 0.2419 |
| | | | defective repair in Chinese hamster | | | | | | | |
| | | | cells 6 | | | | | | | |
| 264 | 7150685 | CBX5 | “chromobox homolog 5 (HP1 alpha | 23468 | NM_012117.1 | 0.077258047 | −0.447723533 | 0.447723533 | 0.003768532 | 0.2422 |
| | | | homolog, Drosophila)” | | | | | | | |
| 265 | 460682 | CCDC132 | coiled-coil domain containing 132 | 55610 | NM_017667.2 | −0.123015026 | 0.447052981 | 0.447052981 | 0.003827349 | 0.2429 |
| 266 | 160047 | LOC389787 | — | 389787 | XM_497072.2 | −0.49206406 | 0.446705007 | 0.446705007 | 0.003658186 | 0.2429 |
| 267 | 2900255 | ZBTB45 | zinc finger and BTB domain | 84878 | NM_032792.2 | 0.124641218 | −0.446554684 | 0.446554684 | 0.003871574 | 0.2429 |
| | | | containing 45 | | | | | | | |
| 268 | 5360168 | NULL | NULL | 652324 | XM_941748.1 | −0.08742157 | 0.446262544 | 0.446262544 | 0.003897708 | 0.2429 |
| 269 | 4390398 | LCN2 | lipocalin 2 | 3934 | NM_005564.3 | 0.939054288 | −0.446256107 | 0.446256107 | 0.003898286 | 0.2429 |
| 270 | 6620402 | NUDT16 | nudix (nucleoside diphosphate | 131870 | NM_152395.1 | 0.177581106 | −0.446234853 | 0.446234853 | 0.003900194 | 0.2429 |
| | | | linked moiety X)-type motif 16 | | | | | | | |
| 271 | 5900482 | HMGB2 | high-mobility group box 2 | 3148 | NM_002129.2 | −0.440289057 | 0.446075441 | 0.446075441 | 0.003914527 | 0.2429 |
| 272 | 1740709 | NULL | NULL | NULL | CB052724 | 0.070777262 | −0.446031691 | 0.448031691 | 0.003918469 | 0.2429 |
| 273 | 5310736 | FAM162A | “family with sequence similarity | 26355 | NM_014367.3 | −0.324511803 | 0.445941038 | 0.445941038 | 0.003926647 | 0.2429 |
| | | | 162, member A” | | | | | | | |
| 274 | 770128 | L3MBTL3 | f(3)mbt-like 3 (Drosophila) | 84456 | NM_032438.1 | −0.161561418 | 0.445836872 | 0.445836872 | 0.003936064 | 0.2429 |
| 275 | 7320022 | NULL | NULL | NULL | AL832228 | 0.086273286 | −0.445654736 | 0.445654736 | 0.003952575 | 0.2429 |
| 276 | 6980328 | ANP32C | “acidic (Jeucine-rich) nuclear | 23520 | NM_012403.1 | −0.074417224 | 0.445406089 | 0.445406089 | 0.003975214 | 0.2429 |
| | | | phosphoprotein 32 family, member | | | | | | | |
| | | | C” | | | | | | | |
| 277 | 510050 | LOC652837 | — | 652837 | XM_942529.1 | −0.036184103 | 0.445136212 | 0.445136212 | 0.003999913 | 0.2429 |
| 278 | 1300746 | NULL | NULL | 647971 | XM_937029.2 | 0.038761564 | −0.44462162 | 0.44462162 | 0.004047379 | 0.2429 |
| 279 | 5910241 | ZBBX | “zinc finger, B-box domain | 79740 | NM_024687.2 | 0.067673114 | −0.444458165 | 0.444458165 | 0.004062559 | 0.2429 |
| | | | containing” | | | | | | | |
| 280 | 4860066 | NULL | NULL | 647346 | XM_936495.2 | −0.209955699 | 0.44434344 | 0.44434344 | 0.004073242 | 0.2429 |
| 281 | 5220204 | C19orf66 | chromosome 19 open reading frame | 55337 | NM_018381.2 | 0.15331761 | −0.444184486 | 0.444184486 | 0.004088085 | 0.2429 |
| | | | 66 | | | | | | | |
| 282 | 6480600 | THUMPD1 | THUMP domain containing 1 | 55623 | NM_017736.3 | −0.123219301 | 0.444044022 | 0.444044022 | 0.004101241 | 0.2429 |
| 283 | 5390433 | DICER1 | “dicer 1, ribonuclease type III” | 23405 | NM_030621.2 | −0.111116126 | 0.443842864 | 0.443842864 | 0.004120145 | 0.2429 |
| 284 | 2570020 | CTR9 | “Ctr9. Paf1/RNA polymerase II | 9646 | NM_014633.3 | −0.109638771 | 0.443761854 | 0.443761854 | 0.004127779 | 0.2429 |
| | | | complex component, homolog | | | | | | | |
| | | | (S. cerevisiae)” | | | | | | | |
| 285 | 50563 | DOK7 | docking protein 7 | 285489 | NM_173660.3 | 0.047906163 | −0.443751623 | 0.443751623 | 0.004128744 | 0.2429 |
| 286 | 6380747 | ANKRD32 | ankyrin repeat domain 32 | 84250 | NM_032290.2 | −0.104537188 | 0.443725202 | 0.443725202 | 0.004131237 | 0.2429 |
| 287 | 5310270 | GALNT14 | UDP-N-acetyl-alpha-D- | 79623 | NM_024572.2 | 0.073549787 | −0.443580709 | 0.443580709 | 0.004144895 | 0.2429 |
| | | | galactosamine:polypeptide N- | | | | | | | |
| | | | acetylgalactosaminyltransferase 14 | | | | | | | |
| 288 | 2900445 | IQGAP3 | IQ motif containing GTPase | 128239 | NM_178229.3 | −0.047779237 | 0.443165428 | 0.443165428 | 0.004184367 | 0.2429 |
| | | | activating protein 3 | | | | | | | |
| 289 | 4250048 | CMTM7 | CKLF-like MARVEL transmembrane | 112616 | NM_138410.2 | 0.263133293 | −0.44312946 | 0.44312946 | 0.004187801 | 0.2429 |
| | | | domain containing 7 | | | | | | | |
| 290 | 3940358 | OSBPL8 | oxysterol binding protein-like 8 | 114882 | NM_001003712.1 | −0.261246813 | 0.443098374 | 0.443098374 | 0.004190771 | 0.2429 |
| 291 | 2450487 | KLRG2 | “killer cell lectin-like receptor | 346689 | NM_198508.2 | 0.048222142 | −0.443079336 | 0.443079336 | 0.004192591 | 0.2429 |
| | | | subfamily G, member 2” | | | | | | | |
| 292 | 6420309 | FAM134B | “family with sequence similarity | 54463 | NM_001034850.1 | −0.358481173 | 0.442988596 | 0.442988596 | 0.004201274 | 0.2429 |
| | | | 134, member B” | | | | | | | |
| 293 | 4900343 | MORF4L1 | mortality factor 4 like 1 | 10933 | NM_206839.1 | −0.24904666 | 0.442917936 | 0.442917936 | 0.004208046 | 0.2429 |
| 294 | 1570292 | NULL | NULL | NULL | AI807878 | −0.087151047 | 0.442699765 | 0.442699765 | 0.004229016 | 0.2429 |
| 295 | 7650669 | TBC1D4 | “TBC1 domain family, member 4” | 9882 | NM_014832.2 | −0.247692111 | 0.44262335 | 0.44262335 | 0.004236383 | 0.2429 |
| 296 | 2760553 | UBA3 | ubiquitin-like modifier activating | 9039 | NM_198197.1 | −0.187898967 | 0.442606739 | 0.442606739 | 0.004237986 | 0.2429 |
| | | | enzyme 3 | | | | | | | |
| 297 | 4670605 | MGC40489 | — | 146880 | XR_016048.1 | −0.029223716 | 0.442250835 | 0.442250835 | 0.004272453 | 0.2437 |
| 298 | 3460132 | PAQR4 | progestin and adipoQ receptor | 124222 | NM_152341.2 | 0.236239034 | −0.442151094 | 0.442151094 | 0.004282157 | 0.2437 |
| | | | family member IV | | | | | | | |
| 299 | 6200747 | LOC220433 | — | 220433 | XM_941684.2 | −0.448374765 | 0.442031781 | 0.442031781 | 0.004293789 | 0.2437 |
| 300 | 4120438 | RABGGTA | “Rab geranylgeranyltransferase, | 5875 | NM_182836.1 | 0.121605116 | −0.441511876 | 0.441511876 | 0.004344798 | 0.2448 |
| | | | alpha subunit” | | | | | | | |

[symbol]

indicates data missing or illegible when filed

TABLE 2
List of top 300 genes selected by Limma.
Limma

| No. | Name of gene | Description of gene | EntrezID | Acc | limma_logFC | AveExpr | limma_t | limma_pvalue | limma_adjpvalue |
|---|---|---|---|---|---|---|---|---|---|
| 1 | HIST1H2BK | “histone cluster 1, H2bk” | 85236 | NM_080593.1 | 0.379122401 | 10.56860754 | 4.621075111 | 3.96E−05 | 0.194083013 |
| 2 | LDHB | lactate dehydrogenase B | 3945 | NM_002300.4 | −0.605485777 | 11.14389182 | −4.582736357 | 4.47E−05 | 0.194083013 |
| 3 | DPP4 | dipeptidyl-peptidase 4 | 1803 | NM_001935.3 | −0.307400655 | 7.025297744 | −4.581722797 | 4.48E−05 | 0.194083013 |
| 4 | PCDHGB6 | “protocadherin gamma subfamily B, | 56100 | NM_018926.2 | 0.176789549 | 6.795139553 | 4.467413408 | 6.40E−05 | 0.194083013 |
| | | 6” | | | | | | | |
| 5 | PTPN18 | “protein tyrosine phosphatase, | 26469 | NM_014369.2 | 0.083763446 | 6.656468326 | 4.431096493 | 7.16E−05 | 0.194083013 |
| | | non-receptor type 18 (brain- | | | | | | | |
| | | derived)” | | | | | | | |
| 6 | P2RY2 | “purinergic receptor P2Y, G-protein | 5029 | NM_002564.2 | 0.182075591 | 6.769555976 | 4.414689685 | 7.54E−05 | 0.194083013 |
| | | coupled, 2” | | | | | | | |
| 7 | MAN2A1 | “mannosidase, alpha, class 2A, | 4124 | NM_002372.2 | −0.327379686 | 8.689610458 | −4.395157644 | 8.01E−05 | 0.194083013 |
| | | member 1” | | | | | | | |
| 8 | ZNF83 | zinc finger protein 83 | 55769 | NM_018300.2 | −0.30567958 | 7.621524008 | −4.252369567 | 0.000124289 | 0.248550702 |
| 9 | PTGES3 | prostaglandin E synthase 3 | 10728 | NM_006601.4 | −0.528677962 | 8.635339 | −4.175586605 | 0.000157174 | 0.248550702 |
| | | (cytosolic) | | | | | | | |
| 10 | ZBTB20 | zinc finger and BTB domain | 26137 | NM_015642.3 | −0.287117754 | 7.696970778 | −4.105392785 | 0.000194573 | 0.248550702 |
| | | containing 20 | | | | | | | |
| 11 | TUSC2 | tumor suppressor candidate 2 | 11334 | NM_007275.1 | 0.162628207 | 7.290633004 | 4.10064263 | 0.000197396 | 0.248550702 |
| 12 | P4HA1 | “prolyl 4-hydroxylase, alpha | 5033 | NM_000917.2 | −0.307837835 | 8.037416362 | −4.091284705 | 0.000203075 | 0.248550702 |
| | | polypeptide 1” | | | | | | | |
| 13 | PDP2 | — | 57546 | NM_020786.1 | 0.068777448 | 6.597619521 | 4.058263335 | 0.000224413 | 0.248550702 |
| 14 | C7orf28A | chromosome 7 open reading frame | 51622 | XM_001133729.1 | −0.383441629 | 7.951155828 | −4.03783508 | 0.000238691 | 0.248550702 |
| | | 28A | | | | | | | |
| 15 | USP9Y | “ubiquitin specific peptidase 9, Y- | 8287 | NM_004654.3 | −0.094524102 | 6.676560456 | −4.036753411 | 0.000239471 | 0.248550702 |
| | | linked (fat facets-like, Drosophila)” | | | | | | | |
| 16 | DFFA | “DNA fragmentation factor, 45 kDa, | 1676 | NM_213566.1 | 0.121909434 | 6.810258539 | 4.008160095 | 0.000261017 | 0.248550702 |
| | | alpha polypeptide” | | | | | | | |
| 17 | NAIP | “NLR family, apoptosis inhibitory | 4671 | NM_004536.2 | 0.073560957 | 6.62992199 | 3.957213679 | 0.000304171 | 0.248550702 |
| | | protein” | | | | | | | |
| 18 | MBNL1 | muscleblind-like (Drosophila) | 4154 | NM_207295.1 | −0.320695796 | 9.005728482 | −3.947528218 | 0.000313125 | 0.248550702 |
| 19 | CPT1A | carnitine palmitoyltransferase 1A | 1374 | NM_001031847.1 | 0.165571989 | 6.885159727 | 3.947282501 | 0.000313355 | 0.248550702 |
| | | (liver) | | | | | | | |
| 20 | TIAL1 | TIA1 cytotoxic granule-associated | 7073 | NM_001033925.1 | −0.233908998 | 7.770315033 | −3.945464543 | 0.000315066 | 0.248550702 |
| | | RNA binding protein-like 1 | | | | | | | |
| 21 | ZBTB45 | zinc finger and BTB domain | 84878 | NM_032792.2 | 0.124641218 | 6.816614376 | 3.938104816 | 0.000322082 | 0.248550702 |
| | | containing 45 | | | | | | | |
| 22 | DDX17 | DEAD (Asp-Glu-Ala-Asp) box | 10521 | NM_030881.2 | −0.443292451 | 8.856378817 | −3.877227352 | 0.000386238 | 0.248550702 |
| | | polypeptide 17 | | | | | | | |
| 23 | LOC645489 | — | 645489 | XM_928514.1 | −0.199041088 | 7.339931356 | −3.865849564 | 0.000399531 | 0.248550702 |
| 24 | LOC643310 | — | 643310 | XM_926656.1 | −0.395581648 | 9.491360136 | −3.862341614 | 0.000403718 | 0.248550702 |
| 25 | CROP | — | 51747 | NM_006107.2 | −0.443849065 | 8.126025421 | −3.823023431 | 0.000453658 | 0.248550702 |
| 26 | GP1BA | “glycoprotein Ib (platelet), alpha | 2811 | NM_000173.4 | 0.13089936 | 6.982468215 | 3.821325354 | 0.000455945 | 0.248550702 |
| | | polypeptide” | | | | | | | |
| 27 | RIN1 | Ras and Rab interactor 1 | 9610 | NM_004292.2 | 0.132155916 | 6.826236745 | 3.815491484 | 0.000463885 | 0.248550702 |
| 28 | HNRPA1L-2 | — | 664709 | NR_002944.2 | −0.432630765 | 9.53229527 | −3.813682717 | 0.000466374 | 0.248550702 |
| 29 | NULL | NULL | NULL | BY797688 | −0.097047292 | 6.728704366 | −3.798342261 | 0.000488009 | 0.248550702 |
| 30 | NAP1L1 | nucleosome assembly protein 1-like 1 | 4673 | NM_139207.1 | −0.357418466 | 7.704201529 | −3.786307558 | 0.000505658 | 0.248550702 |
| 31 | BUB3 | budding uninhibited by | 9184 | NM_004725.2 | −0.303162523 | 7.95184304 | −3.766258332 | 0.000536441 | 0.248550702 |
| | | benzimidazoles 3 homolog (yeast) | | | | | | | |
| 32 | BCAT1 | “branched chain aminotransferase | 586 | NM_005504.4 | 0.161097122 | 6.846191463 | 3.760614109 | 0.000545429 | 0.248550702 |
| | | 1, cytosolic” | | | | | | | |
| 33 | CMPK1 | “cytidine monophosphate (UMP- | 51727 | NM_016308.1 | −0.398631213 | 8.439255099 | −3.756013453 | 0.000552862 | 0.248550702 |
| | | CMP) kinase 1, cytosolic” | | | | | | | |
| 34 | UBE4A | “ubiquitination factor E4A (UFD2 | 9354 | NM_004788.2 | −0.230502672 | 7.842924308 | −3.753787092 | 0.000556494 | 0.248550702 |
| | | homolog, yeast)” | | | | | | | |
| 35 | ALKBH4 | “alkB, alkylation repair homolog 4 | 54784 | NM_017621.2 | 0.120660698 | 6.880124992 | 3.743909631 | 0.000572889 | 0.248550702 |
| | | (E. coli)” | | | | | | | |
| 36 | TSPAN17 | tetraspanin 17 | 26262 | NM_130465.3 | 0.154915647 | 7.039678231 | 3.741571832 | 0.000576837 | 0.248550702 |
| 37 | AMY2A | “amylase, alpha 2A (pancreatic)” | 279 | NM_000699.2 | −0.282794372 | 7.393714088 | −3.736503685 | 0.000585487 | 0.248550702 |
| 38 | IQSEC2 | IQ motif and Sec7 domain 2 | 23096 | NM_015075.1 | 0.077724109 | 6.596496017 | 3.736312891 | 0.000585815 | 0.248550702 |
| 39 | UGP2 | UDP-glucose pyrophosphorylase 2 | 7360 | NM_006759.3 | −0.347146055 | 8.140532242 | −3.729235851 | 0.00059811 | 0.248550702 |
| 40 | STAT5B | signal transducer and activator of | 6777 | NM_012448.3 | −0.24015242 | 8.701273034 | −3.715107247 | 0.000623404 | 0.248550702 |
| | | transcription 5B | | | | | | | |
| 41 | IFNA10 | “interferon, alpha 10” | 3446 | NM_002171.1 | 0.151388979 | 6.956915233 | 3.697947469 | 0.000655515 | 0.248550702 |
| 42 | NULL | NULL | NULL | BX106581 | 0.112837902 | 6.659739953 | 3.696828765 | 0.000657663 | 0.248550702 |
| 43 | TCP1 | t-complex 1 | 6950 | NM_030752.2 | −0.256767834 | 8.217718732 | −3.695651035 | 0.000659932 | 0.248550702 |
| 44 | RASD1 | “RAS, dexamethasone-induced 1” | 51655 | NM_016084.3 | 0.176270502 | 6.830608498 | 3.690572246 | 0.000669802 | 0.248550702 |
| 45 | EXOSC10 | exosome component 10 | 5394 | NM_002685.2 | −0.226165883 | 7.858330385 | −3.680867853 | 0.000689058 | 0.248550702 |
| 46 | LQK1 | — | 642946 | XM_927142.1 | 0.072739876 | 6.577138215 | 3.676653685 | 0.000697586 | 0.248550702 |
| 47 | NULL | NULL | 646135 | XM_933437.1 | 0.111295385 | 6.809297621 | 3.670589619 | 0.000710035 | 0.248550702 |
| 48 | RPS20 | ribosomal protein S20 | 6224 | NM_001023.2 | −0.162977591 | 14.67218734 | −3.670408202 | 0.000710411 | 0.248550702 |
| 49 | HP | haptoglobin | 3240 | NM_005143.2 | 0.40681683 | 7.165541368 | 3.666877322 | 0.000717762 | 0.248550702 |
| 50 | ACTR3 | ARP3 actin-related protein 3 | 10096 | NM_005721.3 | −0.459963089 | 8.761151473 | −3.653066998 | 0.000747224 | 0.253578052 |
| | | homolog (yeast) | | | | | | | |
| 51 | hCG_2015956 | — | 648000 | XM_371757.5 | −0.31840088 | 13.43073634 | −3.643230911 | 0.000768915 | 0.255822595 |
| 52 | C14orf166 | chromosome 14 open reading frame | 51637 | NM_016039.1 | −0.321385016 | 9.613544794 | −3.613732377 | 0.000837664 | 0.26384555 |
| | | 166 | | | | | | | |
| 53 | WSB1 | WD repeat and SOCS box- | 26118 | NM_134265.2 | −0.29256262 | 8.293125883 | −3.612814725 | 0.000839894 | 0.26384555 |
| | | containing 1 | | | | | | | |
| 54 | CNNM3 | cyclin M3 | 26505 | NM_017623.4 | 0.168754951 | 7.079276404 | 3.609952443 | 0.000846889 | 0.26384555 |
| 55 | KLHL7 | kelch-like 7 (Drosophila) | 55975 | NM_001031710.1 | −0.155913324 | 7.054179324 | −3.605822463 | 0.000857081 | 0.26384555 |
| 56 | SYNE1 | “spectrin repeat containing, nuclear | 23345 | NM_182961.2 | 0.075512374 | 6.64747449 | 3.594518134 | 0.000885585 | 0.26384555 |
| | | envelope 1” | | | | | | | |
| 57 | CDC16 | cell division cycle 16 homolog (S. cerevisiae) | 8881 | NM_003903.3 | −0.34380491 | 9.005265989 | −3.594228701 | 0.000886327 | 0.26384555 |
| 58 | ESRRAP2 | estrogen-related receptor alpha | 144832 | NR_000033.2 | 0.169761171 | 6.944028851 | 3.578018474 | 0.000928831 | 0.268633114 |
| | | pseudogene 2 | | | | | | | |
| 59 | ZDHHC5 | “zinc finger, DHHC-type containing | 25921 | NM_015457.2 | 0.193270447 | 7.893569537 | 3.57606895 | 0.000934073 | 0.268633114 |
| | | 5” | | | | | | | |
| 60 | FAM10A4 | “family with sequence similarity 10, | 145165 | NR_002183.1 | −0.370567771 | 9.471949409 | −3.560823632 | 0.000976057 | 0.276028841 |
| | | member A4 pseudogene” | | | | | | | |
| 61 | ELOVL5 | “ELOVL family member 5, | 60481 | NM_021814.3 | −0.284710319 | 8.617781544 | −3.519828721 | 0.001098134 | 0.278705103 |
| | | elongation of long chain fatty acids | | | | | | | |
| | | (FEN1/Elo2, SUR4/Elo3-like, | | | | | | | |
| 62 | LINS1 | lines homolog 1 (Drosophila) | 55180 | NM_001040614.1 | −0.286168405 | 7.802936078 | −3.51832105 | 0.001102893 | 0.278705103 |
| 63 | CCT6P1 | “chaperonin containing TCP1, | 643253 | NR_003110.2 | −0.281922881 | 8.987022794 | −3.517147156 | 0.001106611 | 0.278705103 |
| | | subunit 6 (zeta) pseudogene 1” | | | | | | | |
| 64 | GOLGA8C | “golgi autoantigen, golgin subfamily | 400304 | XM_375152.3 | −0.242008817 | 6.988112539 | −3.501558507 | 0.001157143 | 0.278705103 |
| | | a, 8C” | | | | | | | |
| 65 | RPS3A | ribosomal protein S3A | 6189 | NM_001006.3 | −0.215689394 | 13.27274226 | −3.480011693 | 0.001230644 | 0.278705103 |
| 66 | LRRC26 | leucine rich repeat containing 26 | 389816 | NM_001013653.2 | 0.105999587 | 6.599170468 | 3.476732331 | 0.001242216 | 0.278705103 |
| 67 | SLC9A6 | “solute carrier family 9 | 10479 | NM_001042537.1 | −0.17456976 | 8.079094525 | −3.468474071 | 0.00127182 | 0.278705103 |
| | | (sodium/hydrogen exchanger), | | | | | | | |
| | | member 6” | | | | | | | |
| 68 | NULL | NULL | 648749 | XM_937834.2 | −0.061658345 | 6.590715595 | −3.467954326 | 0.001273705 | 0.278705103 |
| 69 | MPO | myeloperoxidase | 4353 | NM_000250.1 | 0.96554979 | 7.646263192 | 3.467107562 | 0.001276783 | 0.278705103 |
| 70 | FDFT1 | farnesyl-diphosphate | 2222 | NM_004462.3 | −0.242595956 | 8.794891033 | −3.459119586 | 0.00130617 | 0.278705103 |
| | | farnesyltransferase 1 | | | | | | | |
| 71 | NULL | NULL | NULL | U43604 | 0.301411554 | 7.199165409 | 3.453864806 | 0.001325853 | 0.278705103 |
| 72 | IL21R | interleukin 21 receptor | 50615 | NM_181078.1 | 0.057079914 | 6.591538699 | 3.45178774 | 0.001333712 | 0.278705103 |
| 73 | XRN1 | 5′-3′ exoribonuclease 1 | 54464 | NM_019001.2 | −0.23813416 | 8.508548219 | −3.441864471 | 0.001371875 | 0.278705103 |
| 74 | EXOG | “endo/exonuclease (5′-3′), | 9941 | NM_005107.2 | 0.223001865 | 7.264760612 | 3.441155154 | 0.001374642 | 0.278705103 |
| | | endonuclease G-like” | | | | | | | |
| 75 | G3BP2 | GTPase activating protein (SH3 | 9908 | NM_012297.3 | 0.055347977 | 6.583384068 | 3.439083684 | 0.001382755 | 0.278705103 |
| | | domain) binding protein 2 | | | | | | | |
| 76 | MYC | v-myc myelocytomatosis viral | 4609 | NM_002467.3 | −0.337363684 | 7.745340453 | −3.43222232 | 0.001409956 | 0.278705103 |
| | | oncogene homolog (avian) | | | | | | | |
| 77 | RPL11 | ribosomal protein L11 | 6135 | NM_000975.2 | −0.156372832 | 14.69523285 | −3.421668194 | 0.001452799 | 0.278705103 |
| 78 | SLC2AB | “solute carrier family 2 (facilitated | 29988 | NM_014580.3 | 0.183791974 | 7.48215931 | 3.419438233 | 0.001462008 | 0.278705103 |
| | | glucose transporter), member 8” | | | | | | | |
| 79 | THOC2 | THO complex 2 | 57187 | NM_001081550.1 | 0.168129085 | 6.922775737 | 3.418506601 | 0.001465873 | 0.278705103 |
| 80 | NULL | NULL | NULL | AV730797 | 0.146406334 | 6.702252803 | 3.415196196 | 0.001479683 | 0.278705103 |
| 81 | TNFRSF19 | “tumor necrosis factor receptor | 55504 | NM_148957.2 | 0.070969941 | 6.600503679 | 3.412998956 | 0.001488918 | 0.278705103 |
| | | superfamily, member 19” | | | | | | | |
| 82 | RNF115 | ring finger protein 115 | 27246 | NM_014455.1 | 0.278371033 | 8.827361643 | 3.410923159 | 0.001497693 | 0.278705103 |
| 83 | LEF1 | lymphoid enhancer-binding factor 1 | 51176 | NM_016269.2 | −0.599827856 | 9.374949765 | −3.410373939 | 0.001500023 | 0.278705103 |
| 84 | NELL2 | NEL-like 2 (chicken) | 4753 | NM_006159.1 | −0.537157632 | 8.635324105 | −3.406582362 | 0.001516203 | 0.278705103 |
| 85 | TUBE1 | “tubulin, epsilon 1” | 51175 | NM_016262.3 | −0.138726153 | 6.918780573 | −3.405525994 | 0.00152074 | 0.278705103 |
| 86 | GPBP1L1 | GC-rich promoter binding protein | 60313 | NM_021639.3 | −0.185092124 | 6.99451945 | −3.40453954 | 0.001524989 | 0.278705103 |
| | | 1-like 1 | | | | | | | |
| 87 | NULL | NULL | 645609 | XM_928619.1 | 0.215115706 | 6.93283128 | 3.402248419 | 0.001534902 | 0.278705103 |
| 88 | RNF216L | ring finger protein 216-like | 441191 | XR_001271.1 | 0.162378967 | 7.075767146 | 3.391284261 | 0.001583195 | 0.278705103 |
| 89 | LOC388621 | — | 388621 | XM_941195.2 | −0.448108038 | 12.6172039 | −3.381059183 | 0.001629539 | 0.278705103 |
| 90 | SNORA33 | “small nucleolar RNA, H/ACA box | 594839 | NR_002436.1 | −0.186113851 | 7.237748956 | −3.378911416 | 0.001639437 | 0.278705103 |
| | | 33” | | | | | | | |
| 91 | FAM53B | “family with sequence similarity 53, | 9679 | NM_014661.3 | 0.082502036 | 6.720712848 | 3.378900914 | 0.001639485 | 0.278705103 |
| | | member B” | | | | | | | |
| 92 | TCTEX1D1 | Tctax1 domain containing 1 | 200132 | NM_152665.1 | 0.124259481 | 6.947438013 | 3.378852115 | 0.001639711 | 0.278705103 |
| 93 | CBX2 | “chromobox homolog 2 (Pc class | 84733 | NM_005189.1 | 0.077041967 | 6.586068418 | 3.37584138 | 0.001653684 | 0.278705103 |
| | | homolog, Drosophila)” | | | | | | | |
| 94 | SLC26A2 | “solute carrier family 26 (sulfate | 1836 | NM_000112.3 | 0.078282552 | 6.63165789 | 3.374992231 | 0.001657646 | 0.278705103 |
| | | transporter), member 2” | | | | | | | |
| 95 | TADA1L | “transcriptional adaptor 1 (HFI1 | 117143 | NM_053053.2 | −0.16203449 | 7.226654736 | −3.373370577 | 0.001665237 | 0.278705103 |
| | | homolog, yeast)-like” | | | | | | | |
| 96 | PTPLB | “protein tyrosine phosphatase-like | 201562 | NM_198402.2 | −0.336175973 | 9.255647124 | −3.373281148 | 0.001665656 | 0.278705103 |
| | | (proline instead of catalytic | | | | | | | |
| | | arginine), member b” | | | | | | | |
| 97 | HNRNPC | heterogeneous nuclear | 3183 | NM_031314.1 | −0.397999182 | 8.413292708 | −3.361986141 | 0.001719468 | 0.278705103 |
| | | ribonucleoprotein C (C1/C2) | | | | | | | |
| 98 | NULL | NULL | NULL | BF338665 | 0.061724508 | 6.594937826 | 3.36186306 | 0.001720063 | 0.278705103 |
| 99 | NULL | NULL | 731950 | XR_016039.1 | −0.061135983 | 6.603654541 | −3.361179911 | 0.001723372 | 0.278705103 |
| 100 | PKIA | “protein kinase (cAMP-dependent, | 5569 | NM_006823.2 | −0.254561014 | 7.229052236 | −3.360304127 | 0.001727622 | 0.278705103 |
| | | catalytic) inhibitor alpha” | | | | | | | |
| 101 | PAQR4 | progestin and adipoQ receptor | 124222 | NM_152341.2 | 0.235239034 | 7.212347489 | 3.360042242 | 0.001728895 | 0.278705103 |
| | | family member IV | | | | | | | |
| 102 | ELA2 | “elastase 2, neutrophil” | 1991 | NM_001972.2 | 1.319902836 | 8.282120812 | 3.357180559 | 0.001742862 | 0.278705103 |
| 103 | ZNF276 | zinc finger protein 276 | 92822 | NM_152287.2 | 0.130599764 | 6.992968715 | 3.356571932 | 0.001745846 | 0.278705103 |
| 104 | SLC26A8 | “solute carrier family 26, member | 116369 | NM_138718.1 | 0.063661004 | 6.612090652 | 3.356315889 | 0.001747103 | 0.278705103 |
| | | 8” | | | | | | | |
| 105 | NULL | NULL | NULL | BM932227 | −0.116682268 | 6.661300061 | −3.347803068 | 0.00178939 | 0.278705103 |
| 106 | HDAC2 | histone deacetylase 2 | 3066 | NM_001527.2 | −0.308059644 | 9.194835902 | −3.344717795 | 0.001804956 | 0.278705103 |
| 107 | NULL | NULL | NULL | AA971450 | 0.072927449 | 6.644971089 | 3.340652054 | 0.001825665 | 0.278705103 |
| 108 | HNRPDL | heterogeneous nuclear | 9987 | NM_031372.1 | −0.382998221 | 8.609895867 | −3.339735723 | 0.001830363 | 0.278705103 |
| | | ribonucleoprotein D-like | | | | | | | |
| 109 | DSC1 | desmocollin 1 | 1823 | NM_004948.2 | −0.247522067 | 6.842109462 | −3.337976177 | 0.001839418 | 0.278705103 |
| 110 | FAM134B | “family with sequence similarity | 54463 | NM_001034850.1 | −0.358481173 | 7.824193291 | −3.332078062 | 0.001870082 | 0.278705103 |
| | | 134, member B” | | | | | | | |
| 111 | NULL | NULL | NULL | AA431552 | 0.088033112 | 6.60564995 | 3.331235614 | 0.001874502 | 0.278705103 |
| 112 | NOP56 | NOP56 ribonucleoprotein homolog | 10528 | NM_006392.2 | −0.266935568 | 7.752420168 | −3.32920812 | 0.001885179 | 0.278705103 |
| | | (yeast) | | | | | | | |
| 113 | SACM1L | SAC1 suppressor of actin | 22908 | NM_014016.2 | −0.262966982 | 8.037968043 | −3.320589417 | 0.001931216 | 0.278705103 |
| | | mutations 1-like (yeast) | | | | | | | |
| 114 | C12orf43 | chromosome 12 open reading frame | 64897 | NM_022895.1 | −0.20852646 | 7.657143361 | −3.318702024 | 0.00194144 | 0.278705103 |
| | | 43 | | | | | | | |
| 115 | SMARCA5 | “SWI/SNF related, matrix | 8467 | NM_003601.2 | −0.115124978 | 7.082731596 | −3.318505294 | 0.001942508 | 0.278705103 |
| | | associated, actin dependent | | | | | | | |
| | | regulator of chromatin, subfamily a. | | | | | | | |
| 116 | GIMAP2 | “GTPase, IMAP family member 2” | 26157 | NM_015660.2 | −0.45531031 | 8.473264716 | −3.316388313 | 0.001954043 | 0.278705103 |
| 117 | NUDT16 | nudix (nucleoside diphosphate | 131870 | NM_152395.1 | 0.177581106 | 7.017862529 | 3.314837959 | 0.001962531 | 0.278705103 |
| | | linked moiety X)-type motif 16 | | | | | | | |
| 118 | LRRN3 | leucine rich repeat neuronal 3 | 54674 | NM_018334.3 | −0.383213794 | 6.977063895 | −3.311837127 | 0.001979062 | 0.278705103 |
| 119 | PRKCI | “protein kinase C, iota” | 5584 | NM_002740.5 | −0.105841727 | 6.824866958 | −3.311134682 | 0.00198295 | 0.278705103 |
| 120 | RPL11 | ribosomal protein L11 | 6135 | NM_000975.2 | −0.145832491 | 14.51015798 | −3.31068699 | 0.001985432 | 0.278705103 |
| 121 | NULL | NULL | NULL | AL120241 | −0.069719279 | 6.594134665 | −3.308246033 | 0.001999018 | 0.278705103 |
| 122 | NULL | NULL | NULL | CX782759 | −0.206252167 | 6.710163433 | −3.305733304 | 0.002013095 | 0.278705103 |
| 123 | AMN1 | antagonist of mitotic exit network 1 | 196394 | NM_207337.1 | −0.126543905 | 6.727686827 | −3.304450826 | 0.002020316 | 0.278705103 |
| | | homolog (S. cerevisiae) | | | | | | | |
| 124 | FAM180B | “family with sequence similarity | 399888 | XM_941808.2 | 0.083819707 | 6.625010712 | 3.296734176 | 0.00206429 | 0.279340342 |
| | | 180, member B” | | | | | | | |
| 125 | HAT1 | histone acetyltransferase 1 | 8520 | NM_003642.2 | −0.268653366 | 8.011690033 | −3.295875016 | 0.002069242 | 0.279340342 |
| 126 | NULL | NULL | 649088 | XM_938168.1 | −0.257637488 | 6.821077074 | −3.294997835 | 0.002074309 | 0.279340342 |
| 127 | NULL | NULL | NULL | AL042883 | 0.08373784 | 6.721750094 | 3.288131695 | 0.002114385 | 0.280973338 |
| 128 | SOX15 | SRY (sex determining region Y)-box | 6665 | NM_006942.1 | 0.08255695 | 6.609101503 | 3.28725522 | 0.002119554 | 0.280973338 |
| | | 15 | | | | | | | |
| 129 | NULL | NULL | 649555 | XM_945579.1 | −0.269621337 | 8.007087043 | −3.284266937 | 0.002137266 | 0.281124998 |
| 130 | NULL | NULL | NULL | BF445990 | 0.102742584 | 6.676471028 | 3.276579261 | 0.002183481 | 0.283914285 |
| 131 | GOSR1 | golgi SNAP receptor complex | 9527 | NM_001007024.1 | 0.092600962 | 6.795254442 | 3.271571079 | 0.002214098 | 0.283914285 |
| | | member 1 | | | | | | | |
| 132 | GAGE6 | G antigen 6 | 2578 | NM_001476.1 | 0.084017945 | 6.682459172 | 3.264048516 | 0.002260854 | 0.283914285 |
| 133 | APEX1 | APEX nuclease (multifunctional | 328 | NM_080649.1 | −0.205907613 | 10.29653222 | −3.263741347 | 0.002262783 | 0.283914285 |
| | | DNA repair enzyme) 1 | | | | | | | |
| 134 | DEFA4 | “defensin, alpha 4, corticostatin” | 1669 | NM_001925.1 | 1.278228028 | 8.166305327 | 3.261061773 | 0.002279678 | 0.283914285 |
| 135 | NULL | NULL | 654161 | XM_944884.1 | 0.104968986 | 6.718195712 | 3.257061934 | 0.002305119 | 0.283914285 |
| 136 | NUDT15 | nudix (nucleoside diphosphate | 55270 | NM_018283.1 | 0.123752342 | 6.885930043 | 3.255768591 | 0.002313403 | 0.283914285 |
| | | linked moiety X)-type motif 15 | | | | | | | |
| 137 | NULL | NULL | NULL | BF434110 | 0.123387473 | 6.780690807 | 3.249401682 | 0.002354598 | 0.283914285 |
| 138 | UFM1 | ubiquitin-fold modifier 1 | 51569 | NM_016617.1 | −0.290998607 | 7.377470679 | −3.247199714 | 0.002369006 | 0.283914285 |
| 139 | PPCS | phosphopantothenoylcysteine | 79717 | NM_001077447.1 | −0.310167811 | 8.568975401 | −3.246841442 | 0.002371358 | 0.283914285 |
| | | synthetase | | | | | | | |
| 140 | NOL8 | nucleolar protein 8 | 55035 | NM_017948.4 | −0.189491166 | 7.101045922 | −3.245977565 | 0.002377039 | 0.283914285 |
| 141 | ARHGAP26 | Rho GTPase activating protein 26 | 23092 | NM_015071.3 | 0.134940814 | 6.848659921 | 3.24444167 | 0.002387172 | 0.283914285 |
| 142 | LOC284757 | — | 284757 | NM_001004305.1 | 0.123817908 | 6.718141693 | 3.240499839 | 0.002413364 | 0.283914285 |
| 143 | OSTCL | oligosaccharyltransferase complex | 202459 | NM_145303.2 | 0.060154691 | 6.581023808 | 3.238217924 | 0.00242865 | 0.283914285 |
| | | subunit-like | | | | | | | |
| 144 | MGC2752 | — | 65996 | NM_023939.3 | 0.119350056 | 6.792942939 | 3.237415006 | 0.002434051 | 0.283914285 |
| 145 | NULL | NULL | 648399 | XM_937448.1 | −0.092941768 | 6.644024172 | −3.234527246 | 0.00245357 | 0.283914285 |
| 146 | ZNF700 | zinc finger protein 700 | 90592 | NM_144566.1 | −0.134476397 | 7.002962787 | −3.234466743 | 0.00245398 | 0.283914285 |
| 147 | C6orf222 | chromosome 6 open reading frame | 389384 | NM_001010903.3 | 0.050501562 | 6.569327079 | 3.231679197 | 0.002472965 | 0.283914285 |
| | | 222 | | | | | | | |
| 148 | CCDC135 | coiled-coil domain containing 135 | 84229 | NM_032269.4 | 0.099558313 | 6.682670608 | 3.231179152 | 0.002476386 | 0.283914285 |
| 149 | PCDH17 | protocadherin 17 | 27253 | NM_014459.2 | −0.527638621 | 7.136230311 | −3.222695445 | 0.002535104 | 0.284452992 |
| 150 | ZDHHC9 | “zinc finger, DHHC-type containing | 51114 | NM_016032.2 | 0.119706025 | 6.997375053 | 3.217216624 | 0.002573725 | 0.284452992 |
| | | 9” | | | | | | | |
| 151 | LRRN3 | leucine rich repeat neuronal 3 | 54674 | NM_001099660.1 | −0.625504431 | 7.682637114 | −3.214775054 | 0.002591115 | 0.284452992 |
| 152 | BPTF | bromodomain PHD finger | 2186 | NM_004459.6 | 0.091882838 | 6.908904599 | 3.213818559 | 0.002597958 | 0.284452992 |
| | | transcription factor | | | | | | | |
| 153 | ABLIM1 | actin binding LIM protein 1 | 3983 | NM_006720.3 | −0.4799407 | 9.683313038 | −3.211379067 | 0.002615488 | 0.284452992 |
| 154 | DNAJA2 | “DnaJ (Hsp40) homolog, subfamily | 10294 | NM_005880.2 | −0.266568167 | 10.14561262 | −3.210741465 | 0.002620088 | 0.284452992 |
| | | A, member 2” | | | | | | | |
| 155 | ESRRA | estrogen-related receptor alpha | 2101 | NM_004451.3 | 0.246532485 | 7.560235207 | 3.209923275 | 0.002626002 | 0.284452992 |
| 156 | C10orf58 | chromosome 10 open reading frame | 84293 | NM_032333.2 | −0.327354271 | 12.01556757 | −3.208768803 | 0.002634369 | 0.284452992 |
| | | 58 | | | | | | | |
| 157 | Sept7 | septin 7 | 989 | NM_001788.4 | −0.31815245 | 7.233902696 | −3.207967599 | 0.002640191 | 0.284452992 |
| 158 | NULL | NULL | NULL | CA847896 | −0.142130207 | 6.698943452 | −3.206384308 | 0.002651731 | 0.284452992 |
| 159 | YY1 | YY1 transcription factor | 7528 | NM_003403.3 | −0.328869705 | 8.107148479 | −3.204275996 | 0.002667172 | 0.284452992 |
| 160 | DSC1 | desmocollin 1 | 1823 | NM_004948.2 | −0.207019876 | 6.793195915 | −3.200364719 | 0.002696043 | 0.284452992 |
| 161 | CLEC2D | “C-type lectin domain family 2, | 29121 | NM_001004419.2 | −0.163087579 | 6.794369704 | −3.198257031 | 0.002711724 | 0.284452992 |
| | | member D” | | | | | | | |
| 162 | PRPF18 | PRP18 pre-mRNA processing | 8559 | NM_003675.3 | −0.26670234 | 7.878626332 | −3.197713488 | 0.002715782 | 0.284452992 |
| | | factor 18 homolog (S. cerevisiae) | | | | | | | |
| 163 | G3BP1 | GTPase activating protein (SH3 | 10146 | NM_005754.2 | −0.241645343 | 7.052446591 | −3.185861616 | 0.002805707 | 0.292068911 |
| | | domain) binding protein 1 | | | | | | | |
| 164 | MST150 | — | 85027 | NM_032947.3 | 0.146021285 | 6.865433004 | 3.176860762 | 0.002875877 | 0.296708297 |
| 165 | TBC1D4 | “TBC1 domain family, member 4” | 9882 | NM_014832.2 | −0.247692111 | 7.386975828 | −3.174355605 | 0.002895701 | 0.296708297 |
| 166 | NULL | NULL | 641848 | XM_935588.1 | −0.645965338 | 9.336735576 | −3.173470885 | 0.002902733 | 0.296708297 |
| 167 | LOC646197 | — | 646197 | XM_929153.1 | −0.239784184 | 7.328222264 | −3.166981614 | 0.002954807 | 0.300222595 |
| 168 | NULL | NULL | NULL | BX111675 | 0.054993081 | 6.598572236 | 3.162436409 | 0.002991807 | 0.302172471 |
| 169 | STX2 | syntaxin 2 | 2054 | NM_001980.2 | −0.258793675 | 8.129855454 | −3.160200443 | 0.003010169 | 0.302228045 |
| 170 | MTRR | 5-methyltetrahydrofolate- | 4552 | NM_024010.1 | −0.355492388 | 8.577705624 | −3.152664579 | 0.003072842 | 0.306705797 |
| | | homocysteine methyltransferase | | | | | | | |
| | | reductase | | | | | | | |
| 171 | RPS3A | ribosomal protein S3A | 6189 | NM_001006.3 | −0.224696704 | 13.45225898 | −3.146532931 | 0.003124746 | 0.308412922 |
| 172 | IDH3A | isocitrate dehydrogenase 3 (NAD+) | 3419 | NM_005530.2 | −0.146008756 | 7.834975506 | −3.146351122 | 0.003126298 | 0.308412922 |
| | | alpha | | | | | | | |
| 173 | ABCC13 | “ATP-binding cassette, sub-family | 150000 | NR_003087.1 | 0.143863548 | 6.975180019 | 3.143481172 | 0.003150887 | 0.309041948 |
| | | C (CFTR/MRP), member 13” | | | | | | | |
| 174 | PFN2 | profilin 2 | 5217 | NM_053024.2 | −0.101946483 | 6.657579392 | −3.139339792 | 0.003186693 | 0.310064384 |
| 175 | UBE2Q1 | ubiquitin-conjugating enzyme E2Q | 55585 | NM_017582.5 | 0.154304568 | 7.337098311 | 3.138057327 | 0.003197859 | 0.310064384 |
| | | family member 1 | | | | | | | |
| 176 | AMMECR1 | “Alport syndrome, mental | 9949 | NM_015365.2 | −0.137410703 | 7.232010532 | −3.13384834 | 0.003234765 | 0.310661839 |
| | | retardation, midface hypoplasia and | | | | | | | |
| | | elliptocytosis chromosomal region | | | | | | | |
| 177 | C1orf116 | chromosome 1 open reading frame | 79098 | NM_023938.5 | 0.160946362 | 7.087582262 | 3.131317441 | 0.00325715 | 0.310661839 |
| | | 116 | | | | | | | |
| 178 | NULL | NULL | NULL | AI807878 | −0.087151047 | 6.620513943 | −3.13111503 | 0.003258947 | 0.310661839 |
| 179 | SACS | spastic ataxia of Charlevoix- | 26278 | NM_014363.3 | −0.121241812 | 6.762655646 | −3.11937001 | 0.003364815 | 0.313968641 |
| | | Saguenay (sacsin) | | | | | | | |
| 180 | LSM14B | “LSM14B, SCD6 homolog B (S. cerevisiae)” | 149986 | NM_144703.2 | 0.096185097 | 6.699394363 | 3.118872143 | 0.003369373 | 0.313968641 |
| 181 | XAF1 | XIAP associated factor 1 | 54739 | NM_199139.1 | 0.524120564 | 8.118813402 | 3.118616591 | 0.003371715 | 0.313968641 |
| 182 | C19orf10 | chromosome 19 open reading frame | 56005 | NM_019107.3 | 0.409044609 | 8.364952884 | 3.11477554 | 0.003407106 | 0.313968641 |
| | | 10 | | | | | | | |
| 183 | LY6H | “lymphocyte antigen 6 complex, | 4062 | NM_002347.2 | 0.197994096 | 7.625459259 | 3.11379814 | 0.003416167 | 0.313968641 |
| | | locus H” | | | | | | | |
| 184 | PTPLB | “protein tyrosine phosphatase-like | 201562 | NM_198402.2 | −0.266540406 | 8.55593686 | −3.113403603 | 0.003419831 | 0.313968641 |
| | | (proline instead of catalytic | | | | | | | |
| | | arginine), member b” | | | | | | | |
| 185 | GPBP1 | GC-rich promoter binding protein 1 | 65056 | NM_022913.1 | −0.264875927 | 7.600558229 | −3.111547981 | 0.003437115 | 0.313968641 |
| 186 | RPLP2 | “ribosomal protein, large, P2” | 6181 | NM_001004.2 | −0.118887297 | 15.00311102 | −3.11020746 | 0.003449652 | 0.313968641 |
| 187 | RNF11 | ring finger protein 11 | 26994 | NM_014372.3 | 0.225580915 | 7.461433616 | 3.109081409 | 0.003460217 | 0.313968641 |
| 188 | INPP4B | “inositol polyphosphate-4- | 8821 | NM_003866.1 | −0.281061337 | 7.795763622 | −3.104207785 | 0.003506294 | 0.313968641 |
| | | phosphatase, type II, 105 kDa” | | | | | | | |
| 189 | FAM162A | “family with sequence similarity | 26355 | NM_014367.3 | −0.324511803 | 7.752271827 | −3.10396735 | 0.003508582 | 0.313968641 |
| | | 162, member A” | | | | | | | |
| 190 | MORF4L1 | mortality factor 4 like 1 | 10933 | NM_206839.1 | −0.24904666 | 10.34569001 | −3.102150665 | 0.003525916 | 0.313968641 |
| 191 | SCAMP5 | secretory carrier membrane protein 5 | 192683 | NM_138967.2 | 0.0612925 | 6.631370252 | 3.098618399 | 0.003559852 | 0.313968641 |
| 192 | CCDC89 | coiled-coil domain containing 89 | 220388 | NM_152723.1 | 0.204429972 | 7.482187696 | 3.09753939 | 0.003570279 | 0.313968641 |
| 193 | MEGF10 | multiple EGF-like-domains 10 | 84466 | NM_032446.1 | 0.047723662 | 6.628265945 | 3.096096662 | 0.003584267 | 0.313968641 |
| 194 | SATB1 | SATB homeobox 1 | 6304 | NM_002971.2 | −0.216171431 | 7.186778766 | −3.09531339 | 0.003591883 | 0.313968641 |
| 195 | ABCA10 | “ATP-binding cassette, sub-family | 10349 | NM_080282.3 | −0.111376806 | 6.625364772 | −3.093640769 | 0.003608197 | 0.313968641 |
| | | A (ABC1), member 10” | | | | | | | |
| 196 | MRPL9 | mitochondrial ribosomal protein L9 | 65005 | NM_031420.2 | −0.156554264 | 8.221670276 | −3.087455651 | 0.003669133 | 0.31454873 |
| 197 | TAPBPL | TAP binding protein-like | 55080 | NM_018009.3 | 0.214867322 | 8.1474735 | 3.086165839 | 0.003681962 | 0.31454873 |
| 198 | COL6A2 | “collagen, type VI, alpha 2” | 1292 | NM_058175.2 | 0.063152686 | 6.561772793 | 3.085397873 | 0.003689621 | 0.31454873 |
| 199 | LOC439949 | — | 439949 | XM_001129241.1 | −0.469330965 | 9.557830109 | −3.085250381 | 0.003691093 | 0.31454873 |
| 200 | KIAA0947 | — | 23379 | NM_015325.1 | −0.180354486 | 7.294868393 | −3.078574853 | 0.003758327 | 0.31454873 |
| 201 | ZBP1 | Z-DNA binding protein 1 | 81030 | NM_030776.1 | 0.273696455 | 8.206083343 | 3.075164636 | 0.003793118 | 0.31454873 |
| 202 | ZFAND1 | “zinc finger, AN1-type domain 1” | 79752 | NM_024699.1 | −0.254784176 | 7.600944243 | −3.071364143 | 0.003832248 | 0.31454873 |
| 203 | CTSG | cathepsin G | 1511 | NM_001911.2 | 1.254662256 | 8.153662815 | 3.066769075 | 0.003880067 | 0.31454873 |
| 204 | WIPI1 | “WD repeat domain, | 55062 | NM_017983.4 | 0.224176607 | 7.728118352 | 3.066646213 | 0.003881354 | 0.31454873 |
| | | phosphoinositide interacting 1” | | | | | | | |
| 205 | NULL | NULL | NULL | AA532505 | −0.182665342 | 6.801109687 | −3.064162052 | 0.003907447 | 0.31454873 |
| 206 | CETP | “cholesteryl ester transfer protein, | 1071 | NM_000078.1 | 0.23667459 | 7.0432678 | 3.063834245 | 0.003910903 | 0.31454873 |
| | | plasma” | | | | | | | |
| 207 | PNN | “pinin, desmosome associated | 5411 | NM_002687.3 | −0.314789132 | 8.884666033 | −3.062982207 | 0.003919898 | 0.31454873 |
| | | protein” | | | | | | | |
| 208 | HMGB2 | high-mobility group box 2 | 3148 | NM_002129.2 | −0.440289057 | 9.197446056 | −3.062831664 | 0.00392149 | 0.31454873 |
| 209 | KIAA0495 | — | 57212 | NM_207306.1 | 0.103342047 | 6.804792712 | 3.054813009 | 0.004007139 | 0.31454873 |
| 210 | INADL | InaD-like (Drosophila) | 10207 | NM_176878.1 | −0.241811563 | 7.411681346 | −3.052446632 | 0.00403275 | 0.31454873 |
| 211 | NULL | NULL | 402251 | XM_377933.3 | −0.279019599 | 13.20844854 | −3.05231587 | 0.004034169 | 0.31454873 |
| 212 | PMAIP1 | phorbol-12-myristate-13-acetate- | 5366 | NM_021127.1 | −0.206408928 | 6.932806262 | −3.051907227 | 0.004038609 | 0.31454873 |
| | | induced protein 1 | | | | | | | |
| 213 | ERVWE1 | “endogenous retroviral family W, | 30816 | NM_014590.3 | −0.11912978 | 6.669466439 | −3.051740881 | 0.004040418 | 0.31454873 |
| | | env(C7), member 1” | | | | | | | |
| 214 | DEFB125 | “defensin, beta 125” | 245938 | NM_153325.2 | 0.07618092 | 6.649380002 | 3.050659019 | 0.004052199 | 0.31454873 |
| 215 | GALNT6 | UDP-N-acetyl-alpha-D- | 11226 | NM_007210.3 | 0.080267134 | 6.753373034 | 3.050508823 | 0.004053837 | 0.31454873 |
| | | galactosamine:polypeptide N- | | | | | | | |
| | | acetylgalactosaminyltransferase 6 | | | | | | | |
| 216 | PABPC1 | “poly(A) binding protein, | 26986 | NM_002568.3 | −0.393451244 | 8.998065664 | −3.049628157 | 0.004063455 | 0.31454873 |
| | | cytoplasmic 1” | | | | | | | |
| 217 | TFIP11 | tuftelin interacting protein 11 | 24144 | NM_001008697.1 | −0.334180963 | 7.760123364 | −3.049354132 | 0.004066452 | 0.31454873 |
| 218 | NAE1 | NEDD8 activating enzyme E1 | 8883 | NM_001018160.1 | −0.29276015 | 7.771592744 | −3.044929903 | 0.004115128 | 0.31454873 |
| | | subunit 1 | | | | | | | |
| 219 | ANKRD10 | ankyrin repeat domain 10 | 55608 | NM_017664.2 | −0.170575575 | 7.64901735 | −3.039743162 | 0.004172892 | 0.31454873 |
| 220 | GM2A | GM2 ganglioside activator | 2760 | NM_000405.3 | 0.266114128 | 7.061105638 | 3.038262899 | 0.004189517 | 0.31454873 |
| 221 | NULL | NULL | NULL | AW510851 | 0.206747428 | 7.083271693 | 3.038237159 | 0.004189807 | 0.31454873 |
| 222 | NULL | NULL | NULL | BC032017 | 0.065153173 | 6.608790075 | 3.036217154 | 0.004212596 | 0.31454873 |
| 223 | MERTK | c-mer proto-oncogene tyrosine | 10461 | NM_006343.2 | 0.178168499 | 6.954953554 | 3.0358305 | 0.004216971 | 0.31454873 |
| | | kinase | | | | | | | |
| 224 | AP3M2 | “adaptor-related protein complex 3, | 10947 | NM_006803.2 | −0.269660186 | 7.913987405 | −3.035147683 | 0.004224709 | 0.31454873 |
| | | mu 2 subunit” | | | | | | | |
| 225 | DKFZp761E198 | — | 91056 | NM_138368.3 | 0.361999782 | 7.249752149 | 3.033989667 | 0.004237861 | 0.31454873 |
| 226 | ADD3 | adducin 3 (gamma) | 120 | NM_001121.2 | −0.331309202 | 10.1268842 | −3.032530689 | 0.004254487 | 0.31454873 |
| 227 | CDC16 | cell division cycle 16 homolog (S. cerevisiae) | 8881 | NM_001078645.1 | −0.262987116 | 9.820606346 | −3.030775491 | 0.004274569 | 0.31454873 |
| 228 | KIAA1147 | KIAA1147 | 57189 | XM_001130020.1 | −0.162506963 | 7.004494336 | −3.030736896 | 0.004275012 | 0.31454873 |
| 229 | UQCRC2 | ubiquinol-cytochrome c reductase | 7385 | NM_003366.2 | −0.306901413 | 9.073083441 | −3.029625432 | 0.004287776 | 0.31454873 |
| | | core protein II | | | | | | | |
| 230 | UBA6 | ubiquitin-like modifier activating | 55236 | NM_018227.5 | −0.194843638 | 7.532537393 | −3.028380957 | 0.00430211 | 0.31454873 |
| | | enzyme 6 | | | | | | | |
| 231 | ROM1 | retinal outer segment membrane | 6094 | NM_000327.2 | 0.090241562 | 6.729914462 | 3.028098053 | 0.004305375 | 0.31454873 |
| | | protein 1 | | | | | | | |
| 232 | NR2C1 | “nuclear receptor subfamily 2, | 7181 | NM_003297.1 | −0.155303368 | 6.991172468 | −3.0280023 | 0.004306481 | 0.31454873 |
| | | group C, member 1” | | | | | | | |
| 233 | F12 | coagulation factor XII (Hagema | 2161 | NM_000505.3 | 0.095388359 | 6.762822694 | 3.026085058 | 0.004328674 | 0.31454873 |
| | | factor) | | | | | | | |
| 234 | ARMC8 | armadillo repeat containing 8 | 25852 | NM_014154.2 | −0.087200394 | 6.632486359 | −3.025296236 | 0.004337836 | 0.31454873 |
| 235 | ATP11B | “ATPase, class VI, type 11B” | 23200 | NM_014616.1 | −0.252853775 | 7.626141524 | −3.008423755 | 0.004538234 | 0.32615798 |
| 236 | NGLY1 | N-glycanase 1 | 55768 | NM_018297.2 | −0.197659111 | 8.023132987 | −3.007062614 | 0.004554774 | 0.32615798 |
| 237 | SFRS12 | “splicing factor, arginine/serine-rich | 140890 | NM_001077199.1 | −0.290167988 | 7.753512191 | −3.003361465 | 0.004600037 | 0.32615798 |
| | | 12” | | | | | | | |
| 238 | NULL | NULL | 643272 | XM_926633.1 | −0.171519101 | 6.729150181 | −3.002858425 | 0.004606221 | 0.32615798 |
| 239 | SNN | stannin | 8303 | NM_003498.4 | 0.236846461 | 7.364580648 | 3.002384307 | 0.004612057 | 0.32615798 |
| 240 | NULL | NULL | NULL | BU753725 | 0.072652165 | 6.618401869 | 3.001859946 | 0.00461852 | 0.32615798 |
| 241 | HIGD1A | “HIG1 domain family, member 1A” | 25994 | NM_014056.1 | −0.279289648 | 8.999208769 | −2.995323082 | 0.004699801 | 0.32615798 |
| 242 | KCTD5 | potassium channel tetramerisation | 54442 | NM_018992.2 | 0.23125854 | 8.529271571 | 2.995052196 | 0.004703198 | 0.32615798 |
| | | domain containing 5 | | | | | | | |
| 243 | KIAA1370 | KIAA1370 | 56204 | NM_019600.1 | −0.224539294 | 7.456650271 | −2.994813967 | 0.004706187 | 0.32615798 |
| 244 | APEX1 | APEX nuclease (multifunctional | 328 | NM_001641.2 | −0.196094396 | 9.738672442 | −2.992976895 | 0.0047293 | 0.32615798 |
| | | DNA repair enzyme) 1 | | | | | | | |
| 245 | RABGGTA | “Rab geranylgeranyltransferase, | 5875 | NM_182836.1 | 0.121605116 | 6.86888209 | 2.992774267 | 0.004731856 | 0.32615798 |
| | | alpha subunit” | | | | | | | |
| 246 | C2orf18 | chromosome 2 open reading frame | 54978 | NM_017877.3 | 0.137500886 | 6.87955857 | 2.992710778 | 0.004732657 | 0.32615798 |
| | | 18 | | | | | | | |
| 247 | AK5 | adenylate kinase 5 | 26289 | NM_012093.2 | −0.119581494 | 6.636155047 | −2.988854547 | 0.004781554 | 0.32615798 |
| 248 | HERC2P3 | hect domain and RLD 2 pseudogene 3 | 283755 | XM_001128358.1 | −0.175308013 | 6.682973877 | −2.988111751 | 0.004791027 | 0.32615798 |
| 249 | ATP5C1 | “ATP synthase, H+ transporting, | 509 | NM_005174.2 | −0.369186445 | 10.44337548 | −2.98421357 | 0.00484103 | 0.32615798 |
| | | mitochondrial F1 complex, gamma | | | | | | | |
| | | polypeptide 1” | | | | | | | |
| 250 | IMMT | “inner membrane protein, | 10989 | NM_001100169.1 | −0.221779779 | 8.555082028 | −2.983540607 | 0.004849711 | 0.32615798 |
| | | mitochondrial (mitofilin)” | | | | | | | |
| 251 | XIAP | X-linked inhibitor of apoptosis | 331 | NM_001167.2 | 0.07202812 | 6.621201373 | 2.981911934 | 0.004870783 | 0.32615798 |
| 252 | C14orf4 | chromosome 14 open reading frame 4 | 64207 | NM_024496.2 | 0.29452834 | 7.653210546 | 2.979013545 | 0.004908495 | 0.32615798 |
| 253 | NULL | NULL | 645550 | XM_928570.1 | −0.065705517 | 6.590349507 | −2.978667878 | 0.00491301 | 0.32615798 |
| 254 | RPL9 | ribosomal protein L9 | 6133 | NM_001024921.2 | −0.56653985 | 11.40544642 | −2.975268779 | 0.004957625 | 0.32615798 |
| 255 | NULL | NULL | NULL | BM717102 | 0.080470357 | 6.717739236 | 2.975115397 | 0.004959647 | 0.32615798 |
| 256 | ZBBX | “zinc finger, B-box domain | 79740 | NM_024687.2 | 0.067673114 | 6.679035963 | 2.97421524 | 0.00497153 | 0.32615798 |
| | | containing” | | | | | | | |
| 257 | UPK3A | uroplakin 3A | 7380 | NM_006953.2 | 0.082445237 | 6.698973174 | 2.971686744 | 0.005005051 | 0.32615798 |
| 258 | NULL | NULL | NULL | AI479380 | 0.091888829 | 6.633620699 | 2.968887484 | 0.00504241 | 0.32615798 |
| 259 | CAPZA1 | “capping protein (actin filament) | 829 | NM_006135.1 | −0.36644329 | 7.449870807 | −2.968385028 | 0.005049143 | 0.32615798 |
| | | muscle Z-line, alpha 1” | | | | | | | |
| 260 | FBXO38 | F-box protein 38 | 81545 | NM_030793.3 | −0.149047116 | 6.882751518 | −2.96757563 | 0.005060008 | 0.32615798 |
| 261 | NBPF14 | “neuroblastoma breakpoint family, | 25832 | NM_015383.1 | −0.189228519 | 7.28417605 | −2.967517575 | 0.005060788 | 0.32615798 |
| | | member 14” | | | | | | | |
| 262 | MYC | v-myc myelocytomatosis viral | 4609 | NM_002467.3 | −0.38321124 | 8.439937979 | −2.965923374 | 0.005082253 | 0.32615798 |
| | | oncogene homolog (avian) | | | | | | | |
| 263 | UBA3 | ubiquitin-like modifier activating | 9039 | NM_198197.1 | −0.187898967 | 7.02054307 | −2.964535444 | 0.005101011 | 0.32615798 |
| | | enzyme 3 | | | | | | | |
| 264 | TRIOBP | TRIO and F-actin binding protein | 11078 | NM_138632.2 | 0.133302598 | 7.129841312 | 2.963553212 | 0.005114326 | 0.32615798 |
| 265 | RPL7 | ribosomal protein L7 | 6129 | NM_000971.3 | −0.354882331 | 10.11769817 | −2.962843057 | 0.005123972 | 0.32615798 |
| 266 | CNOT7 | “CCR4-NOT transcription complex, | 29883 | NM_013354.5 | −0.212744803 | 8.998078077 | −2.962376643 | 0.005130317 | 0.32615798 |
| | | subunit 7” | | | | | | | |
| 267 | ALDH7A1 | “aldehyde dehydrogenase 7 family, | 501 | NM_001182.2 | −0.068559518 | 6.611321514 | −2.960459925 | 0.005156468 | 0.32615798 |
| | | member A1” | | | | | | | |
| 268 | OR11L1 | “olfactory receptor, family 11, | 391189 | NM_001001959.1 | 0.101699642 | 6.879400128 | 2.960040266 | 0.005162211 | 0.32615798 |
| | | subfamily L, member 1” | | | | | | | |
| 269 | GUSBL2 | “glucuronidase, beta-like 2” | 375513 | NM_206910.1 | 0.128073825 | 6.907202924 | 2.958648625 | 0.005181296 | 0.32615798 |
| 270 | AZU1 | azurocidin 1 | 566 | NM_001700.3 | 0.606626505 | 7.0491903 | 2.957871261 | 0.005191986 | 0.32615798 |
| 271 | DUSP26 | dual specificity phosphatase 26 | 78986 | NM_024025.1 | 0.086230095 | 6.832117186 | 2.956626422 | 0.005209147 | 0.32615798 |
| | | (putative) | | | | | | | |
| 272 | TIA1 | TIA1 cytotoxic granule-associated | 7072 | NM_022173.1 | −0.154497679 | 7.045284603 | −2.951573346 | 0.005279357 | 0.328639571 |
| | | RNA binding protein | | | | | | | |
| 273 | RPL23 | ribosomal protein L23 | 9349 | NM_000978.3 | −0.338815803 | 11.96776242 | −2.949718357 | 0.005305352 | 0.328639571 |
| 274 | FKRP | fukutin related protein | 79147 | NM_024301.3 | 0.120111732 | 6.815052027 | 2.944636349 | 0.005377187 | 0.328639571 |
| 275 | GNL3L | guanine nucleotide binding protein- | 54552 | NM_019067.4 | 0.338634328 | 7.473595121 | 2.94338078 | 0.005395075 | 0.328639571 |
| | | like 3 (nucleolar)-like | | | | | | | |
| 276 | NULL | NULL | NULL | CF552427 | 0.054930882 | 6.640898885 | 2.941052051 | 0.005428399 | 0.328639571 |
| 277 | LOC642934 | — | 642934 | XM_942991.2 | −0.452151346 | 9.850733599 | −2.938312313 | 0.005467851 | 0.328639571 |
| 278 | RPL5 | ribosomal protein L5 | 6125 | NM_000969.3 | −0.250479654 | 13.11440201 | −2.936873997 | 0.005488671 | 0.328639571 |
| 279 | TMEM189 | transmembrane protein 189 | 387521 | NM_199129.1 | 0.148299783 | 7.711569894 | 2.936068915 | 0.005500356 | 0.328639571 |
| 280 | EIF1AX | “eukaryotic translation initiation | 1964 | NM_001412.3 | −0.259913717 | 7.91454554 | −2.935272494 | 0.005511939 | 0.328639571 |
| | | factor 1A, X-linked” | | | | | | | |
| 281 | TCERG1 | transcription elongation regulator 1 | 10915 | NM_006706.3 | −0.153163323 | 7.597318359 | −2.934764583 | 0.005519338 | 0.328639571 |
| 282 | TNIP2 | TNFAIP3 interacting protein 2 | 79155 | NM_024309.2 | 0.160957185 | 7.341463538 | 2.934623572 | 0.005521394 | 0.328639571 |
| 283 | FLVCRt | feline leukemia virus subgroup C | 28982 | NM_014053.1 | 0.133852915 | 6.983247308 | 2.934521625 | 0.005522881 | 0.328639571 |
| | | cellular receptor 1 | | | | | | | |
| 284 | OSBPL1A | oxysterol binding protein-like 1A | 114876 | NM_080597.2 | 0.088316231 | 6.818536942 | 2.932343132 | 0.00555474 | 0.328639571 |
| 285 | DHX15 | DEAH (Asp-Glu-Ala-His) box | 1665 | NM_001358.2 | −0.188453408 | 9.249900465 | −2.931629933 | 0.005565207 | 0.328639571 |
| | | polypeptide 15 | | | | | | | |
| 286 | PLEKHN1 | “pleckstrin homology domain | 84069 | NM_032129.1 | 0.124659553 | 6.987594206 | 2.929799098 | 0.005592163 | 0.328639571 |
| | | containing, family N member 1” | | | | | | | |
| 287 | ATM | ataxia telangiectasia mutated | 472 | NM_000051.3 | −0.361381652 | 8.817161402 | −2.926480737 | 0.005641331 | 0.328639571 |
| 288 | AKTIP | AKT interacting protein | 64400 | NM_022476.2 | −0.132110131 | 7.173375215 | −2.926408412 | 0.005642407 | 0.328639571 |
| 289 | MGC10997 | — | 84741 | NR_001565.1 | −0.229371406 | 10.57230382 | −2.926241638 | 0.005644889 | 0.328639571 |
| 290 | NULL | NULL | 648210 | XR_018923.1 | −0.404442095 | 10.47351845 | −2.925088264 | 0.005662083 | 0.328639571 |
| 291 | GRB14 | growth factor receptor-bound | 2888 | NM_004490.2 | 0.107052844 | 6.780507016 | 2.924443935 | 0.00567171 | 0.328639571 |
| | | protein 14 | | | | | | | |
| 292 | UGCG | UDP-glucose ceramide | 7357 | NM_003358.1 | 0.348634208 | 7.672012128 | 2.923971985 | 0.005678771 | 0.328639571 |
| | | glucosyltransferase | | | | | | | |
| 293 | BCR | breakpoint cluster region | 613 | NM_021574.2 | 0.074331836 | 6.624980953 | 2.923844748 | 0.005680676 | 0.328639571 |
| 294 | KCNJ14 | “potassium inwardly-rectifying | 3770 | NM_170720.1 | 0.076087153 | 6.618374084 | 2.922939338 | 0.00569425 | 0.328639571 |
| | | channel, subfamily J, member 14” | | | | | | | |
| 295 | NDFIP1 | Nedd4 family interacting protein 1 | 80762 | NM_030571.2 | −0.171766084 | 7.624592155 | −2.921558194 | 0.005715014 | 0.328719859 |
| 296 | LOC644131 | — | 644131 | XR_018325.1 | −0.244724622 | 7.573926707 | −2.919946228 | 0.005739338 | 0.329003667 |
| 297 | SPN | sialophorin | 6693 | NM_001030288.1 | 0.34574151 | 8.247211489 | 2.914907743 | 0.005815992 | 0.332014809 |
| 298 | RBPJ | recombination signal binding protein | 3516 | NM_203284.1 | 0.254681218 | 8.653397128 | 2.913617187 | 0.00583578 | 0.332014809 |
| | | for immunoglobulin kappa J region | | | | | | | |
| 299 | NULL | NULL | NULL | BM677010 | −0.224636988 | 6.908713574 | −2.911624953 | 0.00586645 | 0.332014809 |
| 300 | SEH1L | SEH1-like (S. cerevisiae) | 81929 | NM_031216.3 | −0.083010039 | 6.697203672 | −2.911306261 | 0.005871371 | 0.332014809 |

TABLE 3
List of top 300 genes selected by SAM.
SAM

| No. | Probe ID | Name of gene | Description of gene | EntrezID | Acc |
|---|---|---|---|---|---|
| 1 | 1400240 | LDHB | lactate dehydrogenase B | 3945 | NM_002300.4 |
| 2 | 4830255 | DPP4 | dipeptidyl-peptidase 4 | 1803 | NM_001935.3 |
| 3 | 3990608 | MAN2A1 | “mannosidase, alpha, class 2A, | 4124 | NM_002372.2 |
| | | | member 1” | | |
| 4 | 1780719 | PTGES3 | prostaglandin E synthase 3 | 10728 | NM_006601.4 |
| | | | (cytosolic) | | |
| 5 | 3130370 | ZNF83 | zinc finger protein 83 | 55769 | NM_018300.2 |
| 8 | 3130477 | C7orf28A | chromosome 7 open reading frame | 51622 | XM_001133729.1 |
| | | | 28A | | |
| 7 | 4220731 | P4HA1 | “prolyl 4-hydroxylase, alpha | 5033 | NM_000917.2 |
| | | | polypeptide 1” | | |
| 8 | 3440189 | ZBTB20 | zinc finger and BTB domain | 26137 | NM_015642.3 |
| | | | containing 20 | | |
| 9 | 1780709 | DDX17 | DEAD (Asp-Glu-Ala-Asp) box | 10521 | NM_030881.2 |
| | | | polypeptide 17 | | |
| 10 | 160253 | MBNL1 | muscleblind-like (Drosophila) | 4154 | NM_207295.1 |
| 11 | 510209 | LOC643310 | — | 643310 | XM_926656.1 |
| 12 | 5900129 | CROP | — | 51747 | NM_006107.2 |
| 13 | 7320424 | HNRPA1L-2 | — | 664709 | NR_002944.2 |
| 14 | 6110630 | HIST1H2BK | “histone cluster 1, H2bk” | 85236 | NM_080593.1 |
| 15 | 6420446 | CMPK1 | “cytidine monophosphate (UMP- | 51727 | NM_016308.1 |
| | | | CMP) kinase 1, cytosolic” | | |
| 16 | 6590484 | NAP1L1 | nucleosome assembly protein 1-like | 4673 | NM_139207.1 |
| 17 | 1110091 | TIAL1 | TIA1 cytotoxic granule-associated | 7073 | NM_001033925.1 |
| | | | RNA binding protein-like 1 | | |
| 18 | 150706 | UGP2 | UDP-glucose pyrophosphorylase 2 | 7360 | NM_006759.3 |
| 19 | 6940176 | ACTR3 | ARP3 actin-related protein 3 | 10096 | NM_005721.3 |
| | | | homolog (yeast) | | |
| 20 | 2100594 | BUB3 | budding uninhibited by | 9184 | NM_004725.2 |
| | | | benzimidazoles 3 homolog (yeast) | | |
| 21 | 3130296 | AMY2A | “amylase, alpha 2A (pancreatic)” | 279 | NM_000699.2 |
| 22 | 840064 | LOC645489 | — | 645489 | XM_928514.1 |
| 23 | 1570491 | hCG_2015956 | — | 648000 | XM_371757.5 |
| 24 | 520706 | UBE4A | “ubiquitination factor E4A (UFD2 | 9354 | NM_004788.2 |
| | | | homolog, yeast)” | | |
| 25 | 990315 | TCP1 | t-complex 1 | 6950 | NM_030752.2 |
| 26 | 4880521 | CDC16 | cell division cycle 16 homolog (S. cerevisiae) | 8881 | NM_003903.3 |
| 27 | 3290689 | C14orf166 | chromosome 14 open reading frame | 51637 | NM_016039.1 |
| | | | 166 | | |
| 28 | 6940433 | STAT5B | signal transducer and activator of | 6777 | NM_012448.3 |
| | | | transcription 5B | | |
| 29 | 4050195 | FAM10A4 | “family with sequence similarity 10, | 145165 | NR_002183.1 |
| | | | member A4 pseudogene” | | |
| 30 | 6110091 | WSB1 | WD repeat and SODS box- | 26118 | NM_134265.2 |
| | | | containing 1 | | |
| 31 | 840358 | EXOSC10 | exosome component 10 | 5394 | NM_002685.2 |
| 32 | 4570255 | LEF1 | lymphoid enhancer-binding factor 1 | 51176 | NM_016269.2 |
| 33 | 7550358 | NELL2 | NEL-like 2 (chicken) | 4753 | NM_006159.1 |
| 34 | 1010315 | L1NS1 | lines homolog 1 (Drosophila) | 55180 | NM_001040614.1 |
| 35 | 4210129 | ELOVL5 | “ELOVL family member 5, | 60481 | NM_021814.3 |
| | | | elongation of long chain fatty acids | | |
| | | | (FEN1/Elo2, SUR4/Elo3-like, | | |
| 36 | 5420053 | CCT6P1 | “chaperonin containing TCP1, | 643253 | NR_003110.2 |
| | | | subunit 6 (zeta) pseudogene 1” | | |
| 37 | 730379 | LOC388621 | — | 388621 | XM_941195.2 |
| 38 | 6550600 | MYC | v-myc myelocytomatosis viral | 4609 | NM_002467.3 |
| | | | oncogene homolog (avian) | | |
| 39 | 5860465 | USP9Y | “ubiquitin specific peptidase 9, Y- | 8287 | NM_004654.3 |
| | | | linked (fat facets-like, Drosophila)” | | |
| 40 | 1500201 | HNRNPC | heterogeneous nuclear | 3183 | NM_031314.1 |
| | | | ribonucleoprotein C (C1/C2) | | |
| 41 | 6180497 | GOLGA8C | “golgi autoantigen, golgin subfamily | 400304 | XM_375152.3 |
| | | | a, 8C” | | |
| 42 | 3360228 | RPS20 | ribosomal protein S20 | 6224 | NM_001023.2 |
| 43 | 6110747 | GIMAP2 | “GTPase, IMAP family member 2” | 26157 | NM_015660.2 |
| 44 | 6980253 | PTPLB | “protein tyrosine phosphatase-like | 201562 | NM_198402.2 |
| | | | (proline instead of catalytic | | |
| | | | arginine), member b” | | |
| 45 | 2570358 | HNRPDL | heterogeneous nuclear | 9987 | NM_031372.1 |
| | | | ribonucleoprotein D-like | | |
| 46 | 2360630 | FDFT1 | farnesyl-diphosphate | 2222 | NM_004462.3 |
| | | | farnesyltransferase 1 | | |
| 47 | 6420309 | FAM134B | “family with sequence similarity | 54463 | NM_001034850.1 |
| | | | 134, member B” | | |
| 48 | 2370041 | LRRN3 | leucine rich repeat neuronal 3 | 54674 | NM_018334.3 |
| 49 | 3180438 | RPS3A | ribosomal protein S3A | 6189 | NM_001006.3 |
| 50 | 1990487 | XRN1 | 5′-3′ exoribonuclease 1 | 54464 | NM_019001.2 |
| 51 | 2230538 | LRRN3 | leucine rich repeat neuronal 3 | 54674 | NM_001099660.1 |
| 52 | 6900750 | HDAC2 | histone deacetylase 2 | 3066 | NM_001527.2 |
| 53 | 150672 | KLHL7 | kelch-like 7 (Drosophila) | 55975 | NM_001031710.1 |
| 54 | 2970370 | PCDH17 | protocadherin 17 | 27253 | NM_014459.2 |
| 55 | 2640255 | NULL | NULL | 641848 | XM_935588.1 |
| 56 | 2570112 | ABLIM1 | actin binding LIM protein 1 | 3983 | NM_006720.3 |
| 57 | 5910463 | PKIA | “protein kinase (cAMP-dependent, | 5569 | NM_006823.2 |
| | | | catalytic) inhibitor alpha” | | |
| 58 | 5560465 | NOP56 | NOP56 ribonucleoprotein homolog | 10528 | NM_006392.2 |
| | | | (yeast) | | |
| 59 | 2600204 | SACM1L | SAC1 suppressor of actin | 22908 | NM_014016.2 |
| | | | mutations 1-like (yeast) | | |
| 60 | 4050328 | DSC1 | desmocollin 1 | 1823 | NM_004948.2 |
| 61 | 6860148 | SLC9A6 | “solute carrier family 9 | 10479 | NM_001042537.1 |
| | | | (sodium/hydrogen exchanger), | | |
| | | | member 6” | | |
| 62 | 5960072 | NULL | NULL | NULL | BY797688 |
| 63 | 3420068 | HAT1 | histone acetyltransferase 1 | 8520 | NM_003642.2 |
| 64 | 2570725 | PPCS | phosphopantothenoylcysteine | 79717 | NM_001077447.1 |
| | | | synthetase | | |
| 65 | 2680102 | NULL | NULL | 649555 | XM_945579.1 |
| 66 | 1690605 | NULL | NULL | 649088 | XM_938168.1 |
| 67 | 2650601 | GPBP1L1 | GC-rich promoter binding protein | 60313 | NM_021639.3 |
| | | | 1-like 1 | | |
| 68 | 4540356 | UFM1 | ubiquitin-fold modifier 1 | 51569 | NM_016617.1 |
| 69 | 2120468 | C10orf58 | chromosome 10 open reading frame | 84293 | NM_032333.2 |
| | | | 58 | | |
| 70 | 6760017 | YY1 | YY1 transcription factor | 7528 | Table |
| | | | | | NM_0 [symbol] 3 |
| 71 | 450195 | Sept7 | septin 7 | 989 | NM_001788.4 |
| 72 | 6510433 | SNORA33 | “small nucleolar RNA, H/ACA box | 594839 | NR_002436.1 |
| | | | 33” | | |
| 73 | 580014 | C12orf43 | chromosome 12 open reading frame | 64897 | NM_022895.1 |
| | | | 43 | | |
| 74 | 5340487 | MTRR | 5-methyltetrahydrofolate- | 4552 | NM_024010.1 |
| | | | homocysteine methyltransferase | | |
| | | | reductase | | |
| 75 | 2370372 | NULL | NULL | NULL | CX782759 |
| 76 | 60053 | RPL11 | ribosomal protein L11 | 6135 | NM_000975.2 |
| 77 | 4050609 | DNAJA2 | “DnaJ (Hsp40) homolog, subfamily | 10294 | NM_005880.2 |
| | | | A, member 2” | | |
| 78 | 4560088 | LOC439949 | — | 439949 | XM_001129241.1 |
| 79 | 5860327 | PRPF18 | PRP18 pre-mRNA processing | 8559 | NM_003675.3 |
| | | | factor 18 homolog (S. cerevisiae) | | |
| 80 | 5810619 | TADA1L | “transcriptional adaptor 1 (HFI1 | 117143 | NM_053053.2 |
| | | | homolog, yeast)-like” | | |
| 81 | 6510053 | APEX1 | APEX nuclease (multifunctional | 328 | NM_080649.1 |
| | | | DNA repair enzyme) 1 | | |
| 82 | 5900482 | HMGB2 | high-mobility group box 2 | 3148 | NM_002129.2 |
| 83 | 5720300 | G3BP1 | GTPase activating protein (SH3 | 10146 | NM_005754.2 |
| | | | domain) binding protein 1 | | |
| 84 | 7650669 | TBC1D4 | “TBC1 domain family, member 4” | 9882 | NM_014832.2 |
| 85 | 6380673 | TUBE1 | “tubulin, epsilon 1” | 51175 | NM_016262.3 |
| 86 | 5310736 | FAM162A | “family with sequence similarity | 26355 | NM_014367.3 |
| | | | 162, member A” | | |
| 87 | 7400343 | STX2 | syntaxin 2 | 2054 | NM_001980.2 |
| 88 | 3060040 | PABPC1 | “poly(A) binding protein, | 26986 | NM_002568.3 |
| | | | cytoplasmic 1” | | |
| 89 | 110195 | LOC646197 | — | 646197 | XM_929153.1 |
| 90 | 2120017 | NOL8 | nucleolar protein 8 | 55035 | NM_017948.4 |
| 91 | 6860259 | DSC1 | desmocollin 1 | 1823 | NM_004948.2 |
| 92 | 4860762 | INPP4B | “inositol polyphosphate-4- | 8821 | NM_003866.1 |
| | | | phosphatase, type II, 105 KDa” | | |
| 93 | 6420730 | RPL9 | ribosomal protein L9 | 6133 | NM_001024921.2 |
| 94 | 4560270 | PTPLB | “protein tyrosine phosphatase-like | 201562 | NM_198402.2 |
| | | | (proline instead of catalytic | | |
| | | | arginine), member b” | | |
| 95 | 1090692 | GPBP1 | GC-rich promoter binding protein 1 | 65056 | NM_022913.1 |
| 96 | 7150132 | PNN | “pinin, desmosome associated | 5411 | NM_002687.3 |
| | | | protein” | | |
| 97 | 2600600 | TFIP11 | tuftelin interacting protein 11 | 24144 | NM_001008697.1 |
| 98 | 6560164 | RPS3A | ribosomal protein S3A | 6189 | NM_001006.3 |
| 99 | 1070475 | RPL11 | ribosomal protein L11 | 6135 | NM_000975.2 |
| 100 | 1990468 | ADD3 | adducin 3 (gamma) | 120 | NM_001121.2 |
| 101 | 4900343 | MORF4L1 | mortality factor 4 like 1 | 10933 | NM_206839.1 |
| 102 | 6510619 | NAE1 | NEDD8 activating enzyme E1 | 8883 | NM_001018160.1 |
| | | | subunit 1 | | |
| 103 | 3440670 | NULL | NULL | 402251 | XM_377933.3 |
| 104 | 5220195 | UQCRC2 | ubiquinol-cytochrome c reductase | 7385 | NM_003366.2 |
| | | | core protein II | | |
| 105 | 7380707 | ZFAND1 | “zinc finger, AN1-type domain 1” | 79752 | NM_024699.1 |
| 106 | 4780450 | ATP5C1 | “ATP synthase, H+ transporting, | 509 | NM_005174.2 |
| | | | mitochondrial F1 complex, gamma | | |
| | | | polypeptide 1” | | |
| 107 | 5420095 | MYC | v-myc myelocytomatosis viral | 4609 | NM_002467.3 |
| | | | oncogene homolog (avian) | | |
| 108 | 7040482 | LOC642934 | — | 642934 | XM_942991.2 |
| 109 | 4610138 | CAPZA1 | “capping protein (actin filament) | 829 | NM_006135.1 |
| | | | muscle Z-line, alpha 1” | | |
| 110 | 3420128 | AP3M2 | “adaptor-related protein complex 3, | 10947 | NM_006803.2 |
| | | | mu 2 subunit” | | |
| 111 | 3130669 | SATB1 | SATB homeobox 1 | 6304 | NM_002971.2 |
| 112 | 2570132 | CLEC2D | “C-type lectin domain family 2, | 29121 | NM_001004419.2 |
| | | | member D” | | |
| 113 | 5360619 | CDC16 | cell division cycle 16 homolog (S. cerevisiae) | 8881 | NM_001078645.1 |
| 114 | 2680082 | RPL7 | ribosomal protein L7 | 6129 | NM_000971.3 |
| 115 | 2340632 | INADL | InaD-like (Drosophila) | 10207 | NM_176878.1 |
| 116 | 2060050 | NULL | NULL | NULL | BM932227 |
| 117 | 6900044 | AMN1 | antagonist of mitotic exit network 1 | 196394 | NM_207337.1 |
| | | | homolog (S. cerevisiae) | | |
| 118 | 5900731 | SFRS12 | “splicing factor, arginine/serine-rich | 140890 | NM_001077199.1 |
| | | | 12” | | |
| 119 | 4760243 | NULL | NULL | 648210 | XR_018923.1 |
| 120 | 7550341 | HIGD1A | “HIG1 domain family, member 1A” | 25994 | NM_014056.1 |
| 121 | 380575 | RPL23 | ribosomal protein L23 | 9349 | NM_000978.3 |
| 122 | 6650594 | ATP11B | “ATPase, class VI, type 11B” | 23200 | NM_014616.1 |
| 123 | 3780465 | SMARCA5 | “SWI/SNF related, matrix | 8467 | NM_003601.2 |
| | | | associated, actin dependent | | |
| | | | regulator of chromatin, subfamily a, | | |
| 124 | 6840605 | ATM | ataxia telangiectasia mutated | 472 | NM_000051.3 |
| 125 | 670209 | ZNF700 | zinc finger protein 700 | 90592 | NM_144566.1 |
| 126 | 2120307 | NULL | NULL | NULL | CA847896 |
| 127 | 110332 | NULL | NULL | NULL | XM_378421 |
| 128 | 6020598 | PMAIP1 | phorbol-12-myristate-13-acetate- | 5366 | NM_021127.1 |
| | | | induced protein 1 | | |
| 129 | 4220307 | NULL | NULL | 647673 | XM_936731.1 |
| 130 | 3180131 | hCG_1984468 | — | 389672 | XM_933893.1 |
| 131 | 4570170 | KIAA0947 | — | 23379 | NM_015325.1 |
| 132 | 5260161 | NULL | NULL | NULL | AA532505 |
| 133 | 4180142 | KIAA1370 | KIAA1370 | 56204 | NM_019600.1 |
| 134 | 3930561 | PRKCI | “protein kinase C, iota” | 5584 | NM_002740.5 |
| 135 | 3360100 | IDH3A | isocitrate dehydrogenase 3 (NAD+) | 3419 | NM_005530.2 |
| | | | alpha | | |
| 136 | 6200747 | LOC220433 | — | 220433 | XM_941684.2 |
| 137 | 2070019 | UBA6 | ubiquitin-like modifier activating | 55236 | NM_018227.5 |
| | | | enzyme 6 | | |
| 138 | 2810601 | LEF1 | lymphoid enhancer-binding factor 1 | 51176 | NM_016269.2 |
| 139 | 1010477 | ADD3 | adducin 3 (gamma) | 120 | NM_016824.3 |
| 140 | 3190059 | IMMT | “inner membrane protein, | 10989 | NM_001100169.1 |
| | | | mitochondrial (mitofilin)” | | |
| 141 | 3930296 | EIF1AX | “eukaryotic translation initiation | 1964 | NM_001412.3 |
| | | | factor 1A, X-linked” | | |
| 142 | 3780670 | NGLY1 | N-glycanase 1 | 55768 | NM_018297.2 |
| 143 | 3930382 | NMT2 | N-myristoyltransferase 2 | 9397 | NM_004808.1 |
| 144 | 830609 | RPL5 | ribosomal protein L5 | 6125 | NM_000969.3 |
| 145 | 1410603 | RAB3IP | RAB3A interacting protein (rabin3) | 117177 | NM_001024647.2 |
| 146 | 4010735 | MRPL9 | mitochondrial ribosomal protein L9 | 65005 | NM_031420.2 |
| 147 | 2340601 | AMMECR1 | “Alport syndrome, mental | 9949 | NM_015365.2 |
| | | | retardation, midface hypoplasia and | | |
| | | | elliptocytosis chromosomal region | | |
| 148 | 7610608 | RP11-122C9.1 | — | 653702 | NM_001093763.1 |
| 149 | 3120309 | APEX1 | APEX nuclease (multifunctional | 328 | NM_001641.2 |
| | | | DNA repair enzyme) 1 | | |
| 150 | 4540689 | ANKRD10 | ankyrin repeat domain 10 | 55608 | NM_017664.2 |
| 151 | 4590241 | CNOT7 | “CCR4-NOT transcription complex, | 29883 | NM_013354.5 |
| | | | subunit 7” | | |
| 152 | 5820202 | LOC644131 | — | 644131 | XR_018325.1 |
| 153 | 1450471 | FAM153B | “family with sequence similarity | 202134 | XM_371783.3 |
| | | | 153, member B” | | |
| 154 | 6770673 | SOCS2 | suppressor of cytokine signaling 2 | 8835 | NM_003877.3 |
| 155 | 160047 | LOC389787 | — | 389787 | XM_497072.2 |
| 156 | 160079 | MGC10997 | — | 84741 | NR_001565.1 |
| 157 | 460386 | PTMA | “prothymosin, alpha” | 5757 | NM_001099285.1 |
| 158 | 990044 | KIAA1147 | KIAA1147 | 57189 | XM_001130020.1 |
| 159 | 780402 | RTN4 | reticulon 4 | 57142 | NM_020532.4 |
| 160 | 4040113 | NULL | NULL | 643272 | XM_926633.1 |
| 161 | 4860431 | NBPF14 | “neuroblastoma breakpoint family, | 25832 | NM_015383.1 |
| | | | member 14” | | |
| 162 | 4830100 | HSP90AB1 | “heat shock protein 90 kDa alpha | 3326 | NM_007355.2 |
| | | | (cytosolic), class B member 1” | | |
| 163 | 3440709 | NULL | NULL | NULL | BM677010 |
| 164 | 460196 | HERC2P3 | hect domain and RLD 2 pseudogene 3 | 283755 | XM_001128358.1 |
| 165 | 2760553 | UBA3 | ubiquitin-like modifier activating | 9039 | NM_198197.1 |
| | | | enzyme 3 | | |
| 166 | 5130674 | CSE1L | CSE1 chromosome segregation 1- | 1434 | NM_001316.2 |
| | | | like (yeast) | | |
| 167 | 5310747 | PSIP1 | PC4 and SFRS1 interacting protein 1 | 11168 | NM_033222.2 |
| 168 | 270544 | NR2C1 | “nuclear receptor subfamily 2, | 7181 | NM_003297.1 |
| | | | group C, member 1” | | |
| 169 | 430577 | DDX50 | DEAD (Asp-Glu-Ala-Asp) box | 79009 | NM_024045.1 |
| | | | polypeptide 50 | | |
| 170 | 5890661 | GIMAP2 | “GTPase, IMAP family member 2” | 26157 | NM_015660.2 |
| 171 | 5360692 | LY9 | lymphocyte antigen 9 | 4063 | NM_002348.2 |
| 172 | 6510246 | NULL | NULL | 648210 | XR_018923.1 |
| 173 | 7510379 | SACS | spastic ataxia of Charlevoix- | 26278 | NM_014363.3 |
| | | | Saguenay (sacsin) | | |
| 174 | 1980201 | WWP1 | WW domain containing E3 ubiquitin | 11059 | NM_007013.3 |
| | | | protein ligase 1 | | |
| 175 | 4590333 | DHX15 | DEAH (Asp-Glu-Ala-His) box | 1665 | NM_001358.2 |
| | | | polypeptide 15 | | |
| 176 | 770021 | PRKRA | “protein kinase, interferon-inducible | 8575 | NM_003690.3 |
| | | | double stranded RNA dependent | | |
| | | | activator” | | |
| 177 | 4850097 | RPLP2 | “ribosomal protein, large, P2” | 6181 | NM_001004.2 |
| 178 | 4250154 | NULL | NULL | 648749 | XM_937834.2 |
| 179 | 1440121 | tcag7.1261 | — | 645968 | XM_928934.1 |
| 180 | 4860066 | NULL | NULL | 647346 | XM_936495.2 |
| 181 | 6280521 | NULL | NULL | 648399 | XM_937448.1 |
| 182 | 7000377 | PHIP | pleckstrin homology domain | 55023 | NM_017934.4 |
| | | | interacting protein | | |
| 183 | 6100288 | Sept15 | — | 9403 | NM_004261.3 |
| 184 | 2600035 | NCL | nucleolin | 4691 | NM_005381.2 |
| 185 | 2260168 | NULL | NULL | 731640 | XM_001133089.1 |
| 186 | 6900634 | CD69 | CD69 molecule | 969 | NM_001781.1 |
| 187 | 1780348 | FH | fumarate hydratase | 2271 | NM_000143.2 |
| 188 | 6280408 | TTN | titin | 7273 | NM_003319.3 |
| 189 | 60553 | NDFIP1 | Nedd4 family interacting protein 1 | 80762 | NM_030571.2 |
| 190 | 4880204 | SPRYD5 | SPRY domain containing 5 | 84767 | NM_032681.1 |
| 191 | 620450 | RNASEH2B | “ribonuclease H2, subunit B” | 79621 | NM_024570.1 |
| 192 | 2710653 | FBXO38 | F-box protein 38 | 81545 | NM_030793.3 |
| 193 | 4610681 | LOC653658 | — | 653658 | XM_939687.2 |
| 194 | 4850133 | SNRPN | small nuclear ribonucleoprotein | 6638 | NM_022806.2 |
| | | | polypeptide N | | |
| 195 | 1850300 | TC2N | “tandem C2 domains, nuclear” | 123036 | NM_152332.3 |
| 196 | 3120075 | TIA1 | TIA1 cytotoxic granule-associated | 7072 | NM_022173.1 |
| | | | RNA binding protein | | |
| 197 | 6130538 | PFN2 | profilin 2 | 5217 | NM_053024.2 |
| 198 | 3190541 | ABCA10 | “ATP-binding cassette, sub-family | 10349 | NM_080282.3 |
| | | | A (ABC1), member 10” | | |
| 199 | 6590441 | TRIP12 | thyroid hormone receptor interactor | 9320 | NM_004238.1 |
| | | | 12 | | |
| 200 | 2190390 | NCOA1 | nuclear receptor coactivator 1 | 8648 | NM_147223.2 |
| 201 | 3610521 | PCDHGB6 | “protocadherin gamma subfamily B, | 56100 | NM_018926.2 |
| | | | 6” | | |
| 202 | 4150408 | P2RY2 | “purinergic receptor P2Y, G-protein | 5029 | NM_002564.2 |
| | | | coupled, 2” | | |
| 203 | 4810072 | TUSC2 | tumor suppressor candidate 2 | 11334 | NM_007275.1 |
| 204 | 2640025 | HP | haptoglobin | 3240 | NM_005143.2 |
| 205 | 3890315 | ERVWE1 | “endogenous retroviral family W, | 30816 | NM_014590.3 |
| | | | env(C7), member 1” | | |
| 206 | 6860615 | LOC147804 | — | 147804 | NR_003148.2 |
| 207 | 7380068 | CNBP | “CCHC-type zinc finger, nucleic | 7555 | NM_003418.1 |
| | | | acid binding protein” | | |
| 208 | 6660286 | INTS8 | integrator complex subunit 8 | 55656 | NM_017864.2 |
| 209 | 6450538 | TCERG1 | transcription elongation regulator 1 | 10915 | NM_006706.3 |
| 210 | 3140047 | CROP | — | 51747 | NM_016424.3 |
| 211 | 3830136 | NACAP1 | nascent-polypeptide-associated | 83955 | NR_002182.1 |
| | | | complex alpha polypeptide | | |
| | | | pseudogene 1 | | |
| 212 | 3800707 | XPO4 | exportin 4 | 64328 | NM_022459.3 |
| 213 | 5700670 | WIPF1 | “WAS/WASL interacting protein | 7456 | NM_003387.3 |
| | | | family, member 1” | | |
| 214 | 2230167 | LOC653773 | — | 653773 | XM_938755.2 |
| 215 | 4640739 | NULL | NULL | NULL | AL120241 |
| 216 | 6650672 | ZNF439 | zinc finger protein 439 | 90594 | NM_152262.2 |
| 217 | 7400376 | RABL2A | “RAB, member of RAS oncogene | 11159 | NM_013412.1 |
| | | | family-like 2A” | | |
| 218 | 6020273 | RPS4Y2 | “ribosomal protein S4, Y-linked 2” | 140032 | NM_001039567.2 |
| 219 | 6560564 | PRKCA | “protein kinase C, alpha” | 5578 | NM_002737.2 |
| 220 | 1300687 | NULL | NULL | 731950 | XR_016039.1 |
| 221 | 1980626 | SMARCA5 | “SWI/SNF related, matrix | 8467 | NM_003601.2 |
| | | | associated, actin dependent | | |
| | | | regulator of chromatin, subfamily a, | | |
| 222 | 3370112 | RPN2 | ribophorin II | 6185 | NM_002951.2 |
| 223 | 6270148 | AK5 | adenylate kinase 5 | 26289 | NM_012093.2 |
| 224 | 6620356 | ARPP-19 | — | 10776 | NM_006628.4 |
| 225 | 6370435 | ETS1 | v-ets erythroblastosis virus E26 | 2113 | NM_005238.2 |
| | | | oncogene homolog 1 (avian) | | |
| 226 | 1190064 | UGT2B7 | “UDP glucuronosyltransferase 2 | 7364 | XM_001128725.1 |
| | | | family, polypeptide B7” | | |
| 227 | 1570292 | NULL | NULL | NULL | AI807878 |
| 228 | 2640551 | CMPK1 | “cytidine monophosphate (UMP- | 51727 | NM_016308.1 |
| | | | CMP) kinase 1, cytosolic” | | |
| 229 | 2570328 | TRIB2 | tribbles homolog 2 (Drosophila) | 28951 | NM_021643.1 |
| 230 | 5720703 | AKTIP | AKT interacting protein | 64400 | NM_022476.2 |
| 231 | 7000474 | GARNL1 | GTPase activating Rap/RanGAP | 253959 | NM_194301.2 |
| | | | domain-like 1 | | |
| 232 | 1990390 | RAB3IP | RAB3A interacting protein (rabin3) | 117177 | NM_175624.2 |
| 233 | 1410246 | BBS2 | Bardet-Biedl syndrome 2 | 583 | NM_031885.2 |
| 234 | 5910543 | GLOD4 | glyoxalase domain containing 4 | 51031 | NM_016080.2 |
| 235 | 5360204 | NMD3 | NMD3 homolog (S. cerevisiae) | 51068 | NM_015938.3 |
| 236 | 3710048 | NULL | NULL | 731895 | XM_001133620.1 |
| 237 | 2900039 | XRCC5 | X-ray repair complementing | 7520 | NM_021141.2 |
| | | | defective repair in Chinese hamster | | |
| | | | cells 5 (double-strand-break | | |
| 238 | 6770563 | NULL | NULL | 650215 | XR_018889.1 |
| 239 | 1820300 | CTSO | cathepsin O | 1519 | NM_001334.2 |
| 240 | 940398 | EIF3M | “eukaryotio translation initiation | 10480 | NM_006360.3 |
| | | | factor 3, subunit M” | | |
| 241 | 3940358 | OSBPL8 | oxysterol binding protein-like 8 | 114882 | NM_001003712.1 |
| 242 | 6650161 | GNA13 | “guanine nucleotide binding protein | 10672 | NM_006572.3 |
| | | | (G protein), alpha 13” | | |
| 243 | 2100292 | RBBP7 | retinoblastoma binding protein 7 | 5931 | NM_002893.2 |
| 244 | 6020066 | NULL | NULL | 651202 | XM_940333.2 |
| 245 | 6770315 | LOC391656 | — | 391656 | XM_373027.4 |
| 246 | 70753 | C9orf123 | chromosome 9 open reading frame | 90871 | NM_033428.1 |
| | | | 123 | | |
| 247 | 7330014 | SNX4 | sorting nexin 4 | 8723 | NM_003794.2 |
| 248 | 6020575 | NNT | nicotinamide nucleotide | 23530 | NM_012343.3 |
| | | | transhydrogenase | | |
| 249 | 7200021 | CUL4A | cullin 4A | 8451 | NM_003589.2 |
| 250 | 7150554 | LCOR | ligand dependent nuclear receptor | 84458 | NM_032440.1 |
| | | | corepressor | | |
| 251 | 3850278 | NULL | NULL | 641849 | XM_935589.1 |
| 252 | 2190379 | NULL | NULL | 390856 | XM_938867.1 |
| 253 | 3990112 | CAST | calpastatin | 831 | NM_001042445.1 |
| 254 | 7000521 | PRPS2 | phosphoribosyl pyrophosphate | 5634 | NM_001039091.1 |
| | | | synthetase 2 | | |
| 255 | 620546 | RRAS2 | related RAS viral (r-ras) oncogene | 22800 | NM_012250.3 |
| | | | homolog 2 | | |
| 256 | 6760670 | C7orf28B | chromosome 7 open reading frame | 221960 | XM_001126212.1 |
| | | | 28B | | |
| 257 | 770128 | L3MBTL3 | l(3)mbt-like 3 (Drosophila) | 84456 | NM_032438.1 |
| 258 | 6590646 | FAM26F | “family with sequence similarity 26, | 441168 | NM_001010919.1 |
| | | | member F” | | |
| 259 | 2030767 | CD48 | CD48 molecule | 962 | NM_001778.2 |
| 260 | 3170020 | DGKA | “diacylglycerol kinase, alpha 80 kDa” | 1606 | NM_201554.1 |
| 261 | 5820392 | CCT6A | “chaperonin containing TCP1, | 908 | NM_001009186.1 |
| | | | subunit 6A (zeta 1)” | | |
| 262 | 2760068 | NULL | NULL | NULL | AK023178 |
| 263 | 2750367 | PMAIP1 | phorbol-12-myristate-13-acetate- | 5366 | NM_021127.1 |
| | | | induced protein 1 | | |
| 264 | 6580270 | KRT18P31 | keratin 18 pseudogene 31 | 646723 | XR_017241.1 |
| 265 | 4890292 | TSHZ2 | teashirt zinc finger homeobox 2 | 128553 | NM_173485.4 |
| 266 | 6400243 | ABLIM1 | actin binding LIM protein 1 | 3983 | NM_001003407.1 |
| 267 | 6550750 | ARMC8 | armadillo repeat containing 8 | 25852 | NM_014154.2 |
| 268 | 5290056 | TRIM48 | tripartite motif-containing 48 | 79097 | NM_024114.2 |
| 269 | 7000037 | ZFAND1 | “zinc finger, AN1-type domain 1” | 79752 | NM_024699.1 |
| 270 | 1770546 | ATIC | 5-aminoimidazole-4-carboxamide | 471 | NM_004044.4 |
| | | | ribonucleotide | | |
| | | | formyltransferase/IMP | | |
| 271 | 870181 | LOC653314 | — | 653314 | NM_001080544.1 |
| 272 | 5550463 | FARSB | “phenylalanyl-tRNA synthetase, | 10056 | NM_005687.2 |
| | | | beta subunit” | | |
| 273 | 2690561 | RPLP1 | “ribosomal protein, large, P1” | 6176 | NM_001003.2 |
| 274 | 6860681 | IER3IP1 | immediate early response 3 | 51124 | NM_016097.3 |
| | | | interacting protein 1 | | |
| 275 | 5810435 | SNAP23 | “synaptosomal-associated protein, | 8773 | NM_003825.2 |
| | | | 23 kDa” | | |
| 276 | 5490403 | CD1E | CD1e molecule | 913 | NM_001042586.1 |
| 277 | 670195 | NUDCD2 | NudC domain containing 2 | 134492 | NM_145266.4 |
| 278 | 3460162 | NULL | NULL | 646900 | XM_929862.1 |
| 279 | 160537 | KDSR | 3-ketodihydrosphingosine | 2531 | NM_002035.1 |
| | | | reductase | | |
| 280 | 1240450 | CD27 | CD27 molecule | 939 | NM_001242.4 |
| 281 | 430100 | XRCC6 | X-ray repair complementing | 2547 | NM_001469.3 |
| | | | defective repair in Chinese hamster | | |
| | | | cells 6 | | |
| 282 | 360719 | CD44 | CD44 molecule (Indian blood group) | 960 | NM_000610.3 |
| 283 | 520673 | LRFN5 | leuoine rich repeat and fibronectin | 145581 | NM_152447.2 |
| | | | type III domain containing 5 | | |
| 284 | 3800678 | NUP88 | nucleoporin 88 kDa | 4927 | NM_002532.3 |
| 285 | 6370717 | GNG10 | “guanine nucleotide binding protein | 2790 | NM_001017998.2 |
| | | | (G protein), gamma 10” | | |
| 286 | 2650653 | ZNF75D | zinc finger protein 75D | 7626 | NM_007131.2 |
| 287 | 6020093 | SARS | seryl-tRNA synthetase | 6301 | NM_006513.2 |
| 288 | 5360592 | NULL | NULL | 729985 | XM_001131964.1 |
| 289 | 5960332 | SLC39A10 | “solute carrier family 39 (zinc | 57181 | NM_020342.1 |
| | | | transporter), member 10” | | |
| 290 | 940500 | CLDN14 | claudin 14 | 23562 | NM_012130.2 |
| 291 | 7400047 | LOC388344 | — | 388344 | XM_371023.4 |
| 292 | 3930689 | DHX9 | DEAH (Asp-Glu-Ala-His) box | 1660 | NM_001357.2 |
| | | | polypeptide 9 | | |
| 293 | 6280524 | CCNL1 | cyclin L1 | 57018 | NM_020307.2 |
| 294 | 1820528 | PAPSS1 | 3′-phosphoadenosine 5′- | 9061 | NM_005443.4 |
| | | | phosphosulfate synthase 1 | | |
| 295 | 1050148 | LOC653264 | — | 653264 | XM_932721.2 |
| 296 | 3830156 | GTF3C3 | “general transcription factor IIIC, | 9330 | NM_012086.2 |
| | | | polypeptide 3; 102 kDa” | | |
| 297 | 4590349 | ACVR2A | “activin A receptor, type IIA” | 92 | NM_001616.3 |
| 298 | 2260551 | RAD21 | RAD21 homolog (S. pombe) | 5885 | NM_006265.1 |
| 299 | 6510600 | MLLT10 | “myeloid/lymphoid or mixed-lineage | 8028 | NM_004641.2 |
| | | | leukemia (trithorax homolog, | | |
| | | | Drosophila); translocated to, 10” | | |
| 300 | 3610348 | FAM10A4 | “family with sequence similarity 10, | 145165 | NR_002183.1 |
| | | | member A4 pseudogene” | | |

| No. | limma_logFC | SAM_FoldChange | SAM_qvalue | SAM_pvalue |
|---|---|---|---|---|
| 1 | −0.605485777 | 0.657250037 | 0 | 7.20E−05 |
| 2 | −0.307400655 | 0.808096419 | 0 | 9.00E−05 |
| 3 | −0.327379686 | 0.796982701 | 0 | 0.00010897 |
| 4 | −0.528677962 | 0.693189659 | 0 | 0.000118989 |
| 5 | −0.30567958 | 0.809061019 | 0 | 0.000143446 |
| 8 | −0.383441629 | 0.766606625 | 0 | 0.000185113 |
| 7 | −0.307837835 | 0.807851578 | 0 | 0.00019578 |
| 8 | −0.287117754 | 0.819537713 | 0 | 0.000201968 |
| 9 | −0.443292451 | 0.735454273 | 0 | 0.000244932 |
| 10 | −0.320695796 | 0.800683623 | 0 | 0.000260019 |
| 11 | −0.395581648 | 0.760182834 | 0 | 0.000271806 |
| 12 | −0.443849065 | 0.735170578 | 0 | 0.000277699 |
| 13 | −0.432630765 | 0.740909499 | 0 | 0.000287011 |
| 14 | 0.379122401 | 1.300550483 | 2.69772513 | 7.89E−05 |
| 15 | −0.398631213 | 0.758577658 | 4.54353706 | 0.000348715 |
| 16 | −0.357418456 | 0.780560051 | 4.54353706 | 0.000349599 |
| 17 | −0.233908998 | 0.850327795 | 4.54353706 | 0.000350012 |
| 18 | −0.347146055 | 0.786137702 | 4.54353706 | 0.000409771 |
| 19 | −0.459963089 | 0.727004859 | 4.54353706 | 0.000412423 |
| 20 | −0.303162523 | 0.810473813 | 4.54353706 | 0.000416549 |
| 21 | −0.282794372 | 0.821997339 | 4.54353706 | 0.000476957 |
| 22 | −0.199041088 | 0.871129382 | 4.54353706 | 0.000500236 |
| 23 | −0.31840088 | 0.801958296 | 4.54353706 | 0.00054479 |
| 24 | −0.230502672 | 0.852337864 | 4.54353706 | 0.000554868 |
| 25 | −0.256767834 | 0.83696092 | 4.54353706 | 0.000575613 |
| 26 | −0.34380491 | 0.787960431 | 4.54353706 | 0.000582037 |
| 27 | −0.321385016 | 0.800301204 | 4.54353706 | 0.000582449 |
| 28 | −0.24015242 | 0.846655859 | 4.54353706 | 0.000583746 |
| 29 | −0.370567771 | 0.773478035 | 4.54353706 | 0.000601073 |
| 30 | −0.29256262 | 0.816450531 | 4.54353706 | 0.000625825 |
| 31 | −0.226165883 | 0.854903874 | 4.54353706 | 0.000671087 |
| 32 | −0.599827856 | 0.659832683 | 4.54353706 | 0.000692126 |
| 33 | −0.537157632 | 0.689127277 | 4.54353706 | 0.000734795 |
| 34 | −0.286168405 | 0.820077178 | 4.54353706 | 0.000818423 |
| 35 | −0.284710319 | 0.820906424 | 4.54353706 | 0.0008186 |
| 36 | −0.281922881 | 0.822494034 | 4.54353706 | 0.000831565 |
| 37 | −0.448108038 | 0.733003485 | 4.54353706 | 0.000873114 |
| 38 | −0.337363684 | 0.791486318 | 4.54353706 | 0.000906648 |
| 39 | −0.094524102 | 0.936581144 | 4.886445518 | 0.000963284 |
| 40 | −0.397999182 | 0.758910057 | 4.886445518 | 0.000981436 |
| 41 | −0.242008817 | 0.84556712 | 4.886445518 | 0.000987093 |
| 42 | −0.162977591 | 0.893179726 | 4.886445518 | 0.000998468 |
| 43 | −0.45531031 | 0.729353278 | 4.886445518 | 0.001029408 |
| 44 | −0.336175973 | 0.792138184 | 4.886445518 | −0.001054809 |
| 45 | −0.382998221 | 0.766842276 | 4.886445518 | 0.001060879 |
| 46 | −0.242595956 | 0.845223066 | 4.886445518 | 0.001090582 |
| 47 | −0.358481173 | 0.779985293 | 4.886445518 | 0.001129538 |
| 48 | −0.383213794 | 0.7667277 | 4.886445518 | 0.001144625 |
| 49 | −0.215689394 | 0.861134567 | 4.886445518 | 0.001155882 |
| 50 | −0.23813416 | 0.847841118 | 4.886445518 | 0.001159241 |
| 51 | −0.625504431 | 0.6481931 | 4.886445518 | 0.001186233 |
| 52 | −0.308059644 | 0.807727384 | 4.886445518 | 0.001210868 |
| 53 | −0.155913324 | 0.897563974 | 4.886445518 | 0.001219177 |
| 54 | −0.527638621 | 0.693689224 | 4.886445518 | 0.001244342 |
| 55 | −0.645965338 | 0.639065035 | 4.886445518 | 0.001318364 |
| 56 | −0.4799407 | 0.717007095 | 4.886445518 | 0.0013407 |
| 57 | −0.254561014 | 0.838242158 | 4.886445518 | 0.001347006 |
| 58 | −0.266935568 | 0.831082978 | 4.886445518 | 0.001404762 |
| 59 | −0.262966982 | 0.83337228 | 4.886445518 | 0.00145079 |
| 60 | −0.247522067 | 0.842341957 | 4.886445518 | 0.001456801 |
| 61 | −0.17456976 | 0.886031712 | 5.912822202 | 0.001472713 |
| 62 | −0.097047292 | 0.934944549 | 5.912822202 | 0.0015 |
| 63 | −0.268653366 | 0.830094007 | 5.912822202 | 0.00151491 |
| 64 | −0.310167811 | 0.806547938 | 5.912822202 | 0.001552275 |
| 65 | −0.269621337 | 0.829537245 | 5.912822202 | 0.001556695 |
| 66 | −0.257637488 | 0.836456553 | 5.912822202 | 0.001568541 |
| 67 | −0.185092124 | 0.879592907 | 5.912822202 | 0.001609618 |
| 68 | −0.290998607 | 0.817336118 | 5.912822202 | 0.001621405 |
| 69 | −0.327354271 | 0.79699674 | 5.912822202 | 0.001658475 |
| 70 | −0.328869705 | 0.79616 | 5.912822202 | 0.001672796 |
| 71 | −0.31815245 | 0.802096404 | 5.912822202 | 0.001692185 |
| 72 | −0.186113851 | 0.878970194 | 5.912822202 | 0.001704385 |
| 73 | −0.20852646 | 0.865420704 | 5.912822202 | 0.001772749 |
| 74 | −0.355492388 | 0.781602839 | 5.912822202 | 0.001833805 |
| 75 | −0.206252167 | 0.866786046 | 5.912822202 | 0.001846299 |
| 76 | −0.156372832 | 0.897278139 | 5.912822202 | 0.00185231 |
| 77 | −0.266568167 | 0.831294651 | 5.912822202 | 0.001899988 |
| 78 | −0.469330965 | 0.722299479 | 5.912822202 | 0.001914722 |
| 79 | −0.26670234 | 0.831217343 | 5.912822202 | 0.001963873 |
| 80 | −0.16203449 | 0.893763795 | 5.912822202 | 0.001994991 |
| 81 | −0.205907613 | 0.866993082 | 5.912822202 | 0.002050743 |
| 82 | −0.440289057 | 0.736986932 | 5.912822202 | 0.002095945 |
| 83 | −0.241645343 | 0.84578018 | 7.047118706 | 0.002177393 |
| 84 | −0.247692111 | 0.84224268 | 7.047118706 | 0.002197843 |
| 85 | −0.138726153 | 0.908320815 | 7.047118706 | 0.00219802 |
| 86 | −0.324511803 | 0.79856857 | 7.047118706 | 0.002198491 |
| 87 | −0.258793675 | 0.835786479 | 7.047118706 | 0.00220633 |
| 88 | −0.393451244 | 0.761306212 | 7.047118706 | 0.002289604 |
| 89 | −0.239784184 | 0.846871989 | 7.047118706 | 0.002296146 |
| 90 | −0.189491166 | 0.876914952 | 7.047118706 | 0.002304809 |
| 91 | −0.207019876 | 0.866324921 | 7.047118706 | 0.002379125 |
| 92 | −0.281061337 | 0.822985355 | 7.047118706 | 0.002406412 |
| 93 | −0.56653985 | 0.675234325 | 7.047118706 | 0.002410655 |
| 94 | −0.266540406 | 0.831310647 | 7.047118706 | 0.002436292 |
| 95 | −0.264875927 | 0.832270308 | 7.047118706 | 0.002457744 |
| 96 | −0.314789132 | 0.803968492 | 7.047118706 | 0.002498645 |
| 97 | −0.334180963 | 0.793234338 | 7.047118706 | 0.002502416 |
| 98 | −0.224696704 | 0.855774915 | 7.047118706 | 0.002545674 |
| 99 | −0.145832491 | 0.903857666 | 7.047118706 | 0.002576674 |
| 100 | −0.331309202 | 0.794814886 | 7.047118706 | 0.002626355 |
| 101 | −0.24904666 | 0.841452268 | 7.047118706 | 0.002631424 |
| 102 | −0.29276015 | 0.816338752 | 7.047118706 | 0.002737683 |
| 103 | −0.279019599 | 0.824150889 | 7.047118706 | 0.002770038 |
| 104 | −0.306901413 | 0.808376108 | 7.047118706 | 0.002770156 |
| 105 | −0.254784176 | 0.838112505 | 7.047118706 | 0.002804514 |
| 106 | −0.369186445 | 0.774218966 | 7.047118706 | 0.002824257 |
| 107 | −0.38321124 | 0.766729057 | 7.047118706 | 0.002915665 |
| 108 | −0.452151346 | 0.73095204 | 7.047118706 | 0.002919319 |
| 109 | −0.36644329 | 0.775692474 | 7.047118706 | 0.002961398 |
| 110 | −0.269660186 | 0.829514908 | 7.047118706 | 0.002963637 |
| 111 | −0.216171431 | 0.860846891 | 7.047118706 | 0.002982438 |
| 112 | −0.163087579 | 0.893111634 | 7.047118706 | 0.002982614 |
| 113 | −0.262987116 | 0.833360649 | 7.047118706 | 0.003044024 |
| 114 | −0.354882331 | 0.781933417 | 7.047118706 | 0.003051686 |
| 115 | −0.241811563 | 0.845682739 | 7.047118706 | 0.003052275 |
| 116 | −0.116682268 | 0.92230622 | 7.047118706 | 0.003063178 |
| 117 | −0.126543905 | 0.916023233 | 7.047118706 | 0.003064298 |
| 118 | −0.290167988 | 0.817806827 | 7.047118706 | 0.003068423 |
| 119 | −0.404442095 | 0.755528407 | 7.047118706 | 0.00317421 |
| 120 | −0.279289648 | 0.823996635 | 7.047118706 | 0.003208746 |
| 121 | −0.338815803 | 0.790690062 | 7.047118706 | 0.003237093 |
| 122 | −0.252853775 | 0.839234694 | 7.047118706 | 0.00330976 |
| 123 | −0.115124978 | 0.923302323 | 7.047118706 | 0.003318835 |
| 124 | −0.361381652 | 0.77841874 | 7.047118706 | 0.003336162 |
| 125 | −0.134476397 | 0.911000407 | 7.047118706 | 0.003349717 |
| 126 | −0.142130207 | 0.90618015 | 7.047118706 | 0.003364274 |
| 127 | −0.394864244 | 0.760560941 | 7.047118706 | 0.003414781 |
| 128 | −0.206408928 | 0.866691867 | 9.763195707 | 0.003445073 |
| 129 | −0.504764306 | 0.704775508 | 9.763195707 | 0.003546617 |
| 130 | −0.387113765 | 0.764657839 | 9.763195707 | 0.003585337 |
| 131 | −0.180354486 | 0.882486133 | 9.763195707 | 0.003614274 |
| 132 | −0.182665342 | 0.881073731 | 9.763195707 | 0.003699434 |
| 133 | −0.224539294 | 0.855868293 | 9.763195707 | 0.003726839 |
| 134 | −0.105841727 | 0.929262615 | 9.763195707 | 0.003727074 |
| 135 | −0.146008756 | 0.903747242 | 9.763195707 | 0.003758487 |
| 136 | −0.448374765 | 0.732867979 | 9.763195707 | 0.003766914 |
| 137 | −0.194843638 | 0.873667581 | 9.763195707 | 0.003822136 |
| 138 | −0.524099452 | 0.695393047 | 9.763195707 | 0.00384512 |
| 139 | −0.307853518 | 0.807842797 | 9.763195707 | 0.003857496 |
| 140 | −0.221779779 | 0.857506921 | 9.763195707 | 0.003863449 |
| 141 | −0.259913717 | 0.835137865 | 9.763195707 | 0.00391702 |
| 142 | −0.197659111 | 0.871964248 | 9.763195707 | 0.00397731 |
| 143 | −0.314300806 | 0.804240667 | 9.763195707 | 0.003985738 |
| 144 | −0.250479654 | 0.840616888 | 9.763195707 | 0.003996346 |
| 145 | −0.350434199 | 0.784348002 | 9.763195707 | 0.004009135 |
| 146 | −0.156554264 | 0.897165305 | 9.763195707 | 0.004017975 |
| 147 | −0.137410703 | 0.9091494 | 9.763195707 | 0.004106848 |
| 148 | −0.316189323 | 0.803188588 | 9.763195707 | 0.004139616 |
| 149 | −0.196094396 | 0.872910474 | 9.763195707 | 0.004145863 |
| 150 | −0.170575575 | 0.888488141 | 9.763195707 | 0.004158887 |
| 151 | −0.212744803 | 0.862893968 | 9.763195707 | 0.004202793 |
| 152 | −0.244724622 | 0.843976877 | 9.763195707 | 0.004242928 |
| 153 | −0.346939529 | 0.786250247 | 9.763195707 | 0.00428542 |
| 154 | −0.524515864 | 0.695192362 | 9.763195707 | 0.004300625 |
| 155 | −0.49206406 | 0.711007134 | 9.763195707 | 0.00434571 |
| 156 | −0.229371406 | 0.853006473 | 9.763195707 | 0.004359913 |
| 157 | −0.590989351 | 0.66388748 | 9.763195707 | 0.004434111 |
| 158 | −0.162506963 | 0.893471142 | 9.763195707 | 0.004435761 |
| 159 | −0.274156562 | 0.826933624 | 9.763195707 | 0.00448562 |
| 160 | −0.171519101 | 0.887907258 | 9.763195707 | 0.004516914 |
| 161 | −0.189228519 | 0.877074612 | 9.763195707 | 0.004533652 |
| 162 | −0.346277597 | 0.786611074 | 9.763195707 | 0.004560644 |
| 163 | −0.224636988 | 0.855810338 | 9.763195707 | 0.004581447 |
| 164 | −0.175308013 | 0.88557843 | 9.763195707 | 0.004591702 |
| 165 | −0.187898967 | 0.877883274 | 9.763195707 | 0.004591761 |
| 166 | −0.226954625 | 0.854436614 | 9.763195707 | 0.004607379 |
| 167 | −0.298779917 | 0.812939606 | 9.763195707 | 0.004616219 |
| 168 | −0.155303368 | 0.897943535 | 9.763195707 | 0.004649104 |
| 169 | −0.230181634 | 0.852527552 | 9.763195707 | 0.004696605 |
| 170 | −0.289089079 | 0.818418647 | 9.763195707 | 0.004754008 |
| 171 | −0.25013536 | 0.840817522 | 9.763195707 | 0.004774694 |
| 172 | −0.402275661 | 0.756663804 | 9.763195707 | 0.004787482 |
| 173 | −0.121241812 | 0.919395932 | 9.763195707 | 0.004823904 |
| 174 | −0.293252037 | 0.816060469 | 9.763195707 | 0.004916018 |
| 175 | −0.188453408 | 0.87754596 | 9.763195707 | 0.004949375 |
| 176 | −0.229357783 | 0.853014528 | 9.763195707 | 0.005003418 |
| 177 | −0.118887297 | 0.920897635 | 9.763195707 | 0.005017739 |
| 178 | −0.061658345 | 0.958162101 | 9.763195707 | 0.005056518 |
| 179 | −0.360761142 | 0.778753613 | 9.763195707 | 0.005057756 |
| 180 | −0.209955699 | 0.864563779 | 9.763195707 | 0.005069543 |
| 181 | −0.092941768 | 0.937608941 | 9.763195707 | 0.005080504 |
| 182 | −0.262231952 | 0.833796978 | 9.763195707 | 0.005190653 |
| 183 | −0.282927999 | 0.821921206 | 9.763195707 | 0.005198963 |
| 184 | −0.219773695 | 0.858700124 | 9.763195707 | 0.00521847 |
| 185 | −0.328163712 | 0.796549701 | 9.763195707 | 0.005355375 |
| 186 | −0.483558921 | 0.715211123 | 9.763195707 | 0.005374882 |
| 187 | −0.232880465 | 0.850934231 | 9.763195707 | 0.005384371 |
| 188 | −0.519301868 | 0.697709379 | 9.763195707 | 0.005433758 |
| 189 | −0.171766084 | 0.887755265 | 9.763195707 | 0.005457685 |
| 190 | −0.301606617 | 0.811348358 | 9.763195707 | 0.005479196 |
| 191 | −0.267258493 | 0.830896974 | 9.763195707 | 0.005515794 |
| 192 | −0.149047116 | 0.901845925 | 9.763195707 | 0.005532001 |
| 193 | −0.384309209 | 0.766145757 | 9.763195707 | 0.005535596 |
| 194 | −0.341806565 | 0.789052629 | 9.763195707 | 0.005543612 |
| 195 | −0.236871126 | 0.848583701 | 9.763195707 | 0.005559111 |
| 196 | −0.154497679 | 0.898445141 | 9.763195707 | 0.005559288 |
| 197 | −0.101946483 | 0.931774993 | 9.763195707 | 0.005570898 |
| 198 | −0.111376806 | 0.925704214 | 9.763195707 | 0.00557302 |
| 199 | −0.196624966 | 0.872589509 | 9.763195707 | 0.005598244 |
| 200 | −0.208822548 | 0.865243109 | 9.763195707 | 0.005617751 |
| 201 | 0.176789549 | 1.130365665 | 11.63540578 | 0.00016649 |
| 202 | 0.182075591 | 1.134514927 | 11.63540578 | 0.000175978 |
| 203 | 0.162628207 | 1.119324394 | 11.63540578 | 0.000383074 |
| 204 | 0.40681683 | 1.325757427 | 11.63540578 | 0.000429338 |
| 205 | −0.11912978 | 0.920742867 | 11.63540578 | 0.005684052 |
| 206 | −0.199498342 | 0.870853326 | 11.63540578 | 0.005685349 |
| 207 | −0.327720874 | 0.796794242 | 11.63540578 | 0.005735207 |
| 208 | −0.26616918 | 0.831524583 | 11.63540578 | 0.005746818 |
| 209 | −0.153163323 | 0.899276502 | 11.63540578 | 0.00581695 |
| 210 | −0.279822544 | 0.823806524 | 11.63540578 | 0.005835278 |
| 211 | −0.386755375 | 0.764847816 | 11.63540578 | 0.005916077 |
| 212 | −0.217365077 | 0.860134944 | 11.63540578 | 0.005991513 |
| 213 | −0.282049908 | 0.822421618 | 11.63540578 | 0.006078678 |
| 214 | −0.368995191 | 0.774321609 | 11.63540578 | 0.006078736 |
| 215 | −0.069719279 | 0.952823381 | 11.63540578 | 0.006097065 |
| 216 | −0.168089512 | 0.89002051 | 11.63540578 | 0.006187294 |
| 217 | −0.178370764 | 0.883700396 | 11.63540578 | 0.006256129 |
| 218 | −0.29587893 | 0.814575919 | 11.63540578 | 0.006258428 |
| 219 | −0.258004675 | 0.83624369 | 11.63540578 | 0.006276462 |
| 220 | −0.061135983 | 0.958509089 | 11.63540578 | 0.006280823 |
| 221 | −0.146115776 | 0.903680204 | 11.63540578 | 0.006412188 |
| 222 | −0.275150971 | 0.826363839 | 11.63540578 | 0.006430752 |
| 223 | −0.119581494 | 0.920454623 | 11.63540578 | 0.006481612 |
| 224 | −0.261668585 | 0.834122636 | 11.63540578 | 0.006618753 |
| 225 | −0.467750348 | 0.723091264 | 11.63540578 | 0.006673916 |
| 226 | −0.170236569 | 0.888696943 | 11.63540578 | 0.006715523 |
| 227 | −0.087151047 | 0.941379899 | 11.63540578 | 0.006735266 |
| 228 | −0.272595837 | 0.827828695 | 11.63540578 | 0.006738036 |
| 229 | −0.296783847 | 0.814065144 | 11.63540578 | 0.006749057 |
| 230 | −0.132110131 | 0.912495829 | 11.63540578 | 0.006757485 |
| 231 | −0.175348366 | 0.88555366 | 11.63540578 | 0.006769861 |
| 232 | −0.152503427 | 0.89968793 | 11.63540578 | 0.006809936 |
| 233 | −0.21311697 | 0.862671399 | 11.63540578 | 0.006841113 |
| 234 | −0.177207323 | 0.884413331 | 11.63540578 | 0.006900106 |
| 235 | −0.201253758 | 0.86979435 | 11.63540578 | 0.007013673 |
| 236 | −0.292574951 | 0.816443553 | 11.63540578 | 0.007052393 |
| 237 | −0.210035123 | 0.864516184 | 11.63540578 | 0.007062176 |
| 238 | −0.218802016 | 0.859278667 | 11.63540578 | 0.00715541 |
| 239 | −0.231977107 | 0.851467219 | 11.63540578 | 0.007180693 |
| 240 | −0.395462504 | 0.760245616 | 11.63540578 | 0.007189062 |
| 241 | −0.261246813 | 0.834366527 | 11.63540578 | 0.007193482 |
| 242 | −0.380533537 | 0.76815346 | 11.63540578 | 0.007222006 |
| 243 | −0.173081269 | 0.886946341 | 11.63540578 | 0.007230669 |
| 244 | −0.466560508 | 0.723687868 | 11.63540578 | 0.007345238 |
| 245 | −0.243291277 | 0.844815801 | 11.63540578 | 0.00737612 |
| 246 | −0.214876999 | 0.861619616 | 11.63540578 | 0.007418199 |
| 247 | −0.223828966 | 0.856289793 | 11.63540578 | 0.007451379 |
| 248 | −0.191702435 | 0.875571903 | 11.63540578 | 0.007520215 |
| 249 | −0.244754746 | 0.843959254 | 11.63540578 | 0.007524576 |
| 250 | −0.293176479 | 0.816103209 | 11.63540578 | 0.007535596 |
| 251 | −0.303375497 | 0.810354178 | 11.63540578 | 0.007557638 |
| 252 | −0.244649266 | 0.844020961 | 11.63540578 | 0.00755976 |
| 253 | −0.280052769 | 0.823560894 | 11.63540578 | 0.007623645 |
| 254 | −0.203904286 | 0.868197825 | 11.63540578 | 0.007658416 |
| 255 | −0.155953995 | 0.897538671 | 11.63540578 | 0.007705976 |
| 256 | −0.202393059 | 0.869107741 | 11.63540578 | 0.007751061 |
| 257 | −0.161561418 | 0.894056916 | 11.63540578 | 0.007767798 |
| 258 | −0.364528742 | 0.776722551 | 11.63540578 | 0.007768152 |
| 259 | −0.244627443 | 0.844033729 | 11.63540578 | 0.007834807 |
| 260 | −0.286024075 | 0.820159224 | 11.63540578 | 0.007836752 |
| 261 | −0.24460782 | 0.844045209 | 13.42189746 | 0.007899045 |
| 262 | −0.17554108 | 0.885435376 | 13.42189746 | 0.008058286 |
| 263 | −0.426578629 | 0.744024158 | 13.42189746 | 0.008127829 |
| 264 | −0.149129275 | 0.901794568 | 13.42189746 | 0.008223008 |
| 265 | −0.248756168 | 0.841621714 | 13.42189746 | 0.008259842 |
| 266 | −0.349061324 | 0.785094747 | 13.42189746 | 0.008281707 |
| 267 | −0.087200394 | 0.9413477 | 13.42189746 | 0.008333392 |
| 268 | −0.116938426 | 0.922142474 | 13.42189746 | 0.008404173 |
| 269 | −0.243533327 | 0.844674072 | 13.42189746 | 0.008427098 |
| 270 | −0.256334047 | 0.837212614 | 13.42189746 | 0.008437824 |
| 271 | −0.223215014 | 0.856654272 | 13.42189746 | 0.008476073 |
| 272 | −0.160949186 | 0.894436404 | 13.42189746 | 0.008580446 |
| 273 | −0.685558024 | 0.621765286 | 13.42189746 | 0.008607143 |
| 274 | −0.206953948 | 0.866364511 | 13.42189746 | 0.008620934 |
| 275 | −0.266241158 | 0.831483098 | 13.42189746 | 0.008623291 |
| 276 | −0.151209281 | 0.900495342 | 13.42189746 | 0.008811704 |
| 277 | −0.186890942 | 0.878496874 | 13.42189746 | 0.008826438 |
| 278 | −0.302886246 | 0.810629034 | 13.42189746 | 0.00883516 |
| 279 | −0.165230376 | 0.891786103 | 13.42189746 | 0.0088971 |
| 280 | −0.37061142 | 0.773454634 | 13.42189746 | 0.008948079 |
| 281 | −0.202101353 | 0.869283488 | 13.42189746 | 0.008965229 |
| 282 | −0.236278041 | 0.848932621 | 13.42189746 | 0.00903041 |
| 283 | −0.181463688 | 0.881807903 | 13.42189746 | 0.009041077 |
| 284 | −0.225702407 | 0.855178562 | 13.42189746 | 0.009061763 |
| 285 | −0.296985545 | 0.81395134 | 13.42189746 | 0.00909789 |
| 286 | −0.135221715 | 0.910529892 | 13.42189746 | 0.009155705 |
| 287 | −0.201811182 | 0.869458346 | 13.42189746 | 0.009201968 |
| 288 | −0.159755362 | 0.895176853 | 13.42189746 | 0.009231023 |
| 289 | −0.147299889 | 0.902938799 | 13.42189746 | 0.009245757 |
| 290 | −0.153491707 | 0.899071834 | 13.42189746 | 0.009368576 |
| 291 | −0.327727336 | 0.796790672 | 13.42189746 | 0.009393152 |
| 292 | −0.143840193 | 0.905106716 | 13.42189746 | 0.009401285 |
| 293 | −0.186663803 | 0.878635196 | 13.42189746 | 0.009567716 |
| 294 | −0.222706769 | 0.856956115 | 13.42189746 | 0.009667845 |
| 295 | −0.102751263 | 0.931255365 | 13.42189746 | 0.009778347 |
| 296 | −0.154434592 | 0.89848443 | 13.42189746 | 0.009781058 |
| 297 | −0.105208688 | 0.929670455 | 13.42189746 | 0.009897749 |
| 298 | −0.356240374 | 0.781197711 | 13.42189746 | 0.009913602 |
| 299 | −0.211258659 | 0.863783307 | 13.42189746 | 0.009947313 |
| 300 | −0.192448279 | 0.875119368 | 13.42189746 | 0.009955446 |

[symbol]

indicates data missing or illegible when filed

TABLE 4
List of top 300 genes selected by Rank Prod.
RankProd

| No. | Probe ID | Name of gene | Description of gene | EntrezID | Acc | RP_Rsum | RP_FC | RP_pfp | RP_pval |
|---|---|---|---|---|---|---|---|---|---|
| 1 | 2480600 | LOC728358 | — | 728358 | NM_001042500.1 | 206.9319 | 0.3679 | 0 | 0 |
| 2 | 7150170 | LOC728358 | — | 728358 | NM_001042500.1 | 217.1554 | 0.3807 | 0 | 0 |
| 3 | 2970747 | DEFA3 | defensin, alpha 3, neutrophil- | 1668 | NM_005217.2 | 221.4639 | 0.3779 | 0 | 0 |
| | | | specific | | | | | | |
| 4 | 4540239 | DEFA1 | defensin, alpha 1 | 1667 | NM_004084.2 | 226.007 | 0.387 | 0 | 0 |
| 5 | 5080692 | HLA-A29.1 | — | 649853 | NM_001080840.1 | 232.3536 | 0.3703 | 0 | 0 |
| 6 | 870477 | LOC728358 | — | 728358 | NM_001042500.1 | 249.17 | 0.3939 | 0 | 0 |
| 7 | 7650497 | ELA2 | elastase 2, neutrophil | 1991 | NM_001972.2 | 273.8273 | 0.4006 | 0 | 0 |
| 8 | 6550164 | DEFA4 | defensin, alpha 4, corticostatin | 1669 | NM_001925.1 | 309.0369 | 0.4123 | 0 | 0 |
| 9 | 770400 | NULL | NULL | 653600 | XM_928349.1 | 324.4866 | 0.4475 | 0 | 0 |
| 10 | 1500735 | CTSG | cathepsin G | 1511 | NM_001911.2 | 324.7636 | 0.4191 | 0 | 0 |
| 11 | 3890349 | HIST1H4C | histone cluster 1, H4c | 8364 | NM_003542.3 | 342.3622 | 0.5327 | 0 | 0 |
| 12 | 7330398 | HLA-DRB4 | major histocompatibility | 3126 | NM_021983.4 | 395.251 | 1.5402 | 0 | 0 |
| | | | complex, | | | | | | |
| | | | class II, DR beta 4 | | | | | | |
| 13 | 5860075 | CAMP | cathelicidin antimicrobial | 820 | NM_004345.3 | 426.4961 | 0.4888 | 0 | 0 |
| | | | peptide | | | | | | |
| 14 | 7050021 | PRKAR1A | protein kinase, | 5573 | NR_002734.3 | 440.111 | 1.6574 | 0 | 0 |
| | | | cAMP-dependent, | | | | | | |
| | | | regulatory, type I, | | | | | | |
| | | | alpha (tissue | | | | | | |
| | | | specific extinguisher 1) | | | | | | |
| 15 | 4390398 | LCN2 | lipocalin 2 | 3934 | NM_005564.3 | 468.6986 | 0.5216 | 0 | 0 |
| 16 | 4180768 | ALAS2 | aminolevulinate, delta-, | 212 | NM_001037968.1 | 494.2717 | 0.6935 | 0 | 0 |
| | | | synthase 2 | | | | | | |
| 17 | 2690561 | RPLP1 | ribosomal protein, large, P1 | 6176 | NM_001003.2 | 510.521 | 1.6083 | 0 | 0 |
| 18 | 4050717 | MYOM2 | myomesin (M-protein) 2, | 9172 | NM_003970.1 | 521.0537 | 0.6829 | 0 | 0 |
| | | | 165 kDa | | | | | | |
| 19 | 3520601 | MPO | myeloperoxidase | 4353 | NM_000250.1 | 552.0527 | 0.5121 | 0 | 0 |
| 20 | 1450358 | HBD | hemoglobin, delta | 3045 | NM_000519.3 | 555.1003 | 0.636 | 0 | 0 |
| 21 | 620544 | HLA-DRB6 | major histocompatibility | 3128 | NR_001298.1 | 599.5065 | 1.2864 | 0 | 0 |
| | | | complex, | | | | | | |
| | | | class II, DR beta 6 | | | | | | |
| | | | (pseudogene) | | | | | | |
| 22 | 6660288 | CCL3L1 | chemokine (C-C motif) | 6349 | NM_021006.4 | 608.9901 | 1.3171 | 0 | 0 |
| | | | ligand 3-like 1 | | | | | | |
| 23 | 2350274 | ERAF | erythroid associated factor | 51327 | NM_016633.2 | 624.2449 | 0.6242 | 0 | 0 |
| 24 | 6560376 | RPS26L1 | ribosomal protein S26-like 1 | 441502 | NR_002309.1 | 627.4099 | 0.6128 | 0 | 0 |
| 25 | 6960195 | NULL | NULL | 650646 | XM_942527.2 | 659.4889 | 0.6133 | 0 | 0 |
| 26 | 2230538 | LRRN3 | leucine rich repeat neuronal 3 | 54674 | NM_001099660.1 | 663.6339 | 1.5428 | 0 | 0 |
| 27 | 6180743 | LAIR2 | leukocyte-associated | 3904 | NM_021270.2 | 674.7421 | 0.6789 | 0 | 0 |
| | | | immunoglobulin-like | | | | | | |
| | | | receptor 2 | | | | | | |
| 28 | 2230601 | UTS2 | urotensin 2 | 10911 | NM_021995.1 | 682.1642 | 1.3557 | 0 | 0 |
| 29 | 6590377 | RPS26 | ribosomal protein S26 | 6231 | NM_001029.3 | 684.9927 | 0.6457 | 0 | 0 |
| 30 | 2640255 | NULL | NULL | 641848 | XM_935588.1 | 694.3737 | 1.5648 | 0 | 0 |
| 31 | 5890730 | RPS26L | — | 400156 | XR_017804.1 | 698.1257 | 0.6497 | 0 | 0 |
| 32 | 3520102 | CCL4L1 | chemokine (C-C motif) | 9560 | NM_001001435.2 | 700.5086 | 1.4296 | 0 | 0 |
| | | | ligand 4-like 1 | | | | | | |
| 33 | 6860048 | UTS2 | urotensin 2 | 10911 | NM_021995.1 | 717.5432 | 1.4062 | 0 | 0 |
| 34 | 5260484 | HLA-DRB1 | major histocompatibility | 3123 | NM_002124.1 | 718.7641 | 0.7652 | 0 | 0 |
| | | | complex, | | | | | | |
| | | | class II, DR beta 1 | | | | | | |
| 35 | 50278 | LAIR2 | leukocyte-associated | 3904 | NM_002288.3 | 739.419 | 0.6969 | 0 | 0 |
| | | | immunoglobulin-like | | | | | | |
| | | | receptor 2 | | | | | | |
| 36 | 4570255 | LEF1 | lymphoid enhancer-binding | 51176 | NM_016269.2 | 762.7748 | 1.5155 | 0 | 0 |
| | | | factor 1 | | | | | | |
| 37 | 460386 | PTMA | prothymosin, alpha | 5757 | NM_001099285.1 | 764.6714 | 1.5063 | 0 | 0 |
| 38 | 4670048 | RPS26L | — | 400156 | NR_002225.2 | 796.2257 | 0.6646 | 0 | 0 |
| 39 | 6420730 | RPL9 | ribosomal protein L9 | 6133 | NM_001024921.2 | 797.4422 | 1.481 | 0 | 0 |
| 40 | 6960022 | 5-Sep | septin 5 | 5413 | NM_002688.4 | 812.1586 | 0.6894 | 0 | 0 |
| 41 | 6180427 | G0S2 | G0/G1switch 2 | 50486 | NM_015714.2 | 832.1428 | 1.1905 | 0 | 0 |
| 42 | 5290762 | UTS2 | urotensin 2 | 10911 | NM_006786.2 | 832.6698 | 1.2965 | 0 | 0 |
| 43 | 780403 | HLA-DQA1 | major histocompatibility | 3117 | XM_936128.2 | 837.2042 | 1.3738 | 0 | 0 |
| | | | complex, | | | | | | |
| | | | class II, DQ alpha 1 | | | | | | |
| 44 | 1010246 | IFI6 | interferon; alpha-inducible | 2537 | NM_022872.2 | 838.9897 | 0.6667 | 0 | 0 |
| | | | protein 6 | | | | | | |
| 45 | 6270307 | LOC644934 | — | 644934 | XM_930344.2 | 846.7408 | 0.6838 | 0 | 0 |
| 46 | 4780075 | CEACAM8 | carcinoembryonic | 1088 | NM_001816.2 | 851.5188 | 0.6171 | 0 | 0 |
| | | | antigen-related | | | | | | |
| | | | cell adhesion molecule 8 | | | | | | |
| 47 | 1450139 | FCGR3B | Fc fragment of IgG, | 2215 | NM_000570.3 | 852.2208 | 0.7809 | 0 | 0 |
| | | | low affinity IIIb, | | | | | | |
| | | | receptor (CD16b) | | | | | | |
| 48 | 1400240 | LDHB | lactate dehydrogenase B | 3945 | NM_002300.4 | 869.5601 | 1.5215 | 0 | 0 |
| 49 | 2810601 | LEF1 | lymphoid enhancer-binding | 51176 | NM_0162692 | 885.7056 | 1.438 | 0 | 0 |
| | | | factor 1 | | | | | | |
| 50 | 4230121 | RPS26L | — | 400156 | XR_017804.1 | 901.0353 | 0.6857 | 0 | 0 |
| 51 | 50689 | C7orf28B | chromosome 7 open reading | 221960 | NM_198097.1 | 901.4464 | 1.283 | 0 | 0 |
| | | | frame 28B | | | | | | |
| 52 | 7160475 | SNHG5 | small nucleolar | 387066 | XM_943699.1 | 915.2623 | 1.3754 | 0 | 0 |
| | | | RNA host gene 5 | | | | | | |
| | | | (non-protein coding) | | | | | | |
| 53 | 1010546 | NULL | NULL | 649143 | XM_944822.1 | 940.4695 | 1.2482 | 0 | 0 |
| 54 | 4120053 | PFKFB3 | 6-phosphofructo-2- | 5209 | NM_004566.2 | 949.932 | 0.7127 | 0 | 0 |
| | | | kinase/fructose-2,6- | | | | | | |
| | | | biphosphatase 3 | | | | | | |
| 55 | 5870678 | NULL | NULL | 441763 | XM_930284.1 | 959.3277 | 0.7098 | 0 | 0 |
| 56 | 6250615 | PGLYRP1 | peptidoglycan recognition | 8993 | NM_005091.1 | 978.6937 | 0.6314 | 0 | 0 |
| | | | protein 1 | | | | | | |
| 57 | 5310044 | NBPF20 | neuroblastoma breakpoint | 400818 | NM_001037675.1 | 989.9365 | 0.6816 | 0 | 0 |
| | | | family, member 20 | | | | | | |
| 58 | 7160474 | HLA-DQB1 | major histocompatibility | 3119 | NM_002123.2 | 993.2267 | 1.3788 | 0 | 0 |
| | | | complex, | | | | | | |
| | | | class II, DQ beta 1 | | | | | | |
| 59 | 1510424 | S100P | S100 calcium binding | 6286 | NM_005980.2 | 999.9308 | 0.776 | 0 | 0 |
| | | | protein P | | | | | | |
| 60 | 7550358 | NELL2 | NEL-like 2 (chicken) | 4753 | NM_006159.1 | 1000.2823 | 1.4511 | 0 | 0 |
| 61 | 6370435 | ETS1 | v-ets erythroblastosis | 2113 | NM_005238.2 | 1000.7099 | 1.383 | 0 | 0 |
| | | | virus E26 | | | | | | |
| | | | oncogene homolog 1 (avian) | | | | | | |
| 62 | 4480730 | HBM | hemoglobin, mu | 3042 | NM_001003938.3 | 1002.8748 | 0.7114 | 0 | 0 |
| 63 | 6770673 | SOCS2 | suppressor of cytokine | 8835 | NM_003877.3 | 1008.5738 | 1.4385 | 0 | 0 |
| | | | signaling 2 | | | | | | |
| 64 | 3140242 | KIR2DL3 | killer cell immunoglobulin- | 3804 | NM_014511.3 | 1012.7829 | 0.7052 | 0 | o |
| | | | like receptor, | | | | | | |
| | | | two domains, long | | | | | | |
| | | | cytoplasmic tail, 3 | | | | | | |
| 65 | 5390246 | CCR7 | chemokine (C-C motif) | 1236 | NM_001838.2 | 1024.3788 | 1.3396 | 0 | 0 |
| | | | receptor 7 | | | | | | |
| 66 | 6280408 | TTN | titin | 7273 | NM_003319.3 | 1040.0032 | 1.4333 | 0 | 0 |
| 67 | 840685 | IL1B | interleukin 1, beta | 3553 | NM_000576.2 | 1043.9839 | 0.9118 | 0 | 0 |
| 68 | 1440564 | RUNX3 | runt-related transcription | 864 | NM_004350.2 | 1045.6015 | 0.7504 | 0 | 0 |
| | | | factor 3 | | | | | | |
| 69 | 2640301 | TNF | tumor necrosis factor (TNF | 7124 | NM_000594.2 | 1052.0345 | 0.9119 | 0 | 0 |
| | | | superfamily, member 2) | | | | | | |
| 70 | 160047 | LOC389787 | — | 389787 | XM_497072.2 | 1058.0289 | 1.4065 | 0 | 0 |
| 71 | 1500280 | IFIT3 | interferon-induced protein | 3437 | NM_001031683.1 | 1067.6439 | 0.7336 | 0 | 0 |
| | | | with | | | | | | |
| | | | tetratricopeptide repeats 3 | | | | | | |
| 72 | 1780719 | PTGES3 | prostaglandin E synthase 3 | 10728 | NM_006601.4 | 1094.4413 | 1.4426 | 0 | 0 |
| | | | (cytosolic) | | | | | | |
| 73 | 7610440 | XAF1 | XIAP associated factor 1 | 54739 | NM_199139.1 | 1101.0267 | 0.6954 | 0 | 0 |
| 74 | 1260482 | GZMK | granzyme K (granzyme 3; | 3003 | NM_002104.2 | 1101.0382 | 1.379 | 0 | 0 |
| | | | tryptase II) | | | | | | |
| 75 | 2570112 | ABLIM1 | actin binding LIM protein 1 | 3983 | NM_006720.3 | 1109.2206 | 1.3947 | 0 | 0 |
| 76 | 5810685 | THBS1 | thrombospondin 1 | 7057 | NM_003246.2 | 1112.0822 | 0.7981 | 0 | 0 |
| 77 | 1050292 | GP9 | glycoprotein IX (platelet) | 2815 | NM_000174.2 | 1121.2912 | 0.7089 | 0 | 0 |
| 78 | 4010181 | FOLR3 | folate receptor 3 (gamma) | 2352 | NM_000804.2 | 1121.4294 | 0.7343 | 0 | 0 |
| 79 | 1580025 | GNG11 | guanine nucleotide | 2791 | NM_004126.3 | 1123.8896 | 0.7606 | 0 | 0 |
| | | | binding protein | | | | | | |
| | | | (G protein), gamma 11 | | | | | | |
| 80 | 4220307 | NULL | NULL | 647673 | XM_936731.1 | 1127.0089 | 1.4189 | 0 | 0 |
| 81 | 4220246 | CCL20 | chemokine (C-C motif) | 6364 | NM_004591.1 | 1130.1869 | 0.8647 | 0 | 0 |
| | | | ligand 20 | | | | | | |
| 82 | 6270605 | LOC649946 | — | 649946 | NR_003040.1 | 1141.8104 | 1.3897 | 0 | 0 |
| 83 | 3370202 | ANXA2P1 | annexin A2 pseudogene 1 | 303 | NR_001562.1 | 1148.68 | 1.3614 | 0 | 0 |
| 84 | 6020066 | NULL | NULL | 651202 | XM_940333.2 | 1156.9854 | 1.3818 | 0 | 0 |
| 85 | 2970370 | PCDH17 | protocadherin 17 | 27253 | NM_014459.2 | 1159.006 | 1.4416 | 0 | 0 |
| 86 | 2970575 | CCL4L2 | chemokine (C-C motif) | 388372 | NM_207007.2 | 1160.5275 | 0.8619 | 0 | 0 |
| | | | ligand 4-like 2 | | | | | | |
| 87 | 3360615 | FCER1A | Fc fragment of IgE, | 2205 | NM_002001.2 | 1161.9701 | 1.3166 | 0 | 0 |
| | | | high affinity I, | | | | | | |
| | | | receptor for; | | | | | | |
| | | | alpha polypeptide | | | | | | |
| 88 | 6900634 | CD69 | CD69 molecule | 969 | NM_001781.1 | 1185.7514 | 1.3982 | 0 | 0 |
| 89 | 650349 | RPS28 | ribosomal protein S28 | 6234 | NM_001031.4 | 1190.4157 | 1.3501 | 0 | 0 |
| 90 | 6650242 | IFITM3 | interferon induced | 10410 | NM_021034.2 | 1198.6619 | 0.7139 | 0 | 0 |
| | | | transmembrane | | | | | | |
| | | | protein 3 (1-8U) | | | | | | |
| 91 | 2000148 | IFIT1 | interferon-induced | 3434 | NM_001548.3 | 1201.038 | 0.728 | 0 | 0 |
| | | | protein with | | | | | | |
| | | | tetratricopeptide repeats 1 | | | | | | |
| 92 | 2190139 | CA1 | carbonic anhydrase I | 759 | NM_001738.1 | 1216.0508 | 0.7338 | 0 | 0 |
| 93 | 2140753 | RPL14 | ribosomal protein L14 | 9045 | NM_001034996.1 | 1216.4627 | 1.3673 | 0 | 0 |
| 94 | 5050162 | CD83 | CD83 molecule | 9308 | NM_001040280.1 | 1221.184 | 1.1247 | 0 | 0 |
| 95 | 4200746 | BPI | bactericidal/permeability- | 671 | NM_001725.1 | 1222.3488 | 0.676 | 0 | 0 |
| | | | increasing protein | | | | | | |
| 96 | 2600747 | IFIT2 | interferon-induced | 3433 | NM_001547.4 | 1226.2189 | 0.7229 | 0 | 0 |
| | | | protein with | | | | | | |
| | | | tetratricopeptide repeats 2 | | | | | | |
| 97 | 3130543 | RNASE3 | ribonuclease, | 6037 | NM_002935.2 | 1231.3433 | 0.6719 | 0 | 0 |
| | | | RNase A family, 3 | | | | | | |
| | | | (eosinophil cationic protein) | | | | | | |
| 98 | 5670739 | AZU1 | azurocidin 1 | 566 | NM_001700.3 | 1238.4609 | 0.6567 | 0 | 0 |
| 99 | 7400377 | CEACAM6 | carcinoembryonic | 4680 | NM_002483.3 | 1240.5422 | 0.6648 | 0 | 0 |
| | | | antigen-related | | | | | | |
| | | | cell adhesion molecule 6 | | | | | | |
| | | | (non-specific cross | | | | | | |
| | | | reacting antigen) | | | | | | |
| 100 | 4670390 | CXCL2 | chemokine (C—X—C motif) | 2920 | NM_002089.3 | 1243.1968 | 1.0736 | 0 | 0 |
| | | | ligand 2 | | | | | | |
| 101 | 670010 | NULL | NULL | 650298 | XM_939387.1 | 1255.7097 | 0.7673 | 0 | 0 |
| 102 | 6590682 | CCL3 | chemokine (C-C motif) | 6348 | NM_002983.1 | 1258.8623 | 1.0301 | 0 | 0 |
| | | | ligand 3 | | | | | | |
| 103 | 4560088 | LOC439949 | — | 439949 | XM_001129241.1 | 1259.3189 | 1.3845 | 0 | 0 |
| 104 | 6220671 | PLAUR | plasminogen activator, | 5329 | NM_001005376.1 | 1269.8919 | 0.7674 | 0 | 0 |
| | | | urokinase receptor | | | | | | |
| 105 | 3170152 | IL2RB | interleukin 2 receptor, beta | 3560 | NM_000878.2 | 1271.1735 | 0.8008 | 0 | 0 |
| 106 | 6620026 | CD83 | CD83 molecule | 9308 | NM_004233.3 | 1287.9941 | 1.0467 | 0 | 0 |
| 107 | 2360164 | KLRC2 | killer cell lectin-like receptor | 3822 | NM_002260.3 | 1288.636 | 0.8481 | 0 | 0 |
| | | | subfamily C, member 2 | | | | | | |
| 108 | 2650192 | C6orf105 | chromosome 6 open reading | 84830 | NM_032744.1 | 1289.3942 | 1.3412 | 0 | 0 |
| | | | frame 105 | | | | | | |
| 109 | 2810010 | CCL3L3 | chemokine (C-C motif) | 414062 | NM_001001437.3 | 1296.3404 | 1.2483 | 0 | 0 |
| | | | ligand 3-like 3 | | | | | | |
| 110 | 3190148 | DDIT4 | DNA-damage-inducible | 54541 | NM_019058.2 | 1307.8573 | 0.7086 | 0 | 0 |
| | | | transcript 4 | | | | | | |
| 111 | 1770504 | HLA-DRB3 | major histocompatibility | 3125 | NM_022555.3 | 1317.7473 | 1.2121 | 0 | 0 |
| | | | complex, | | | | | | |
| | | | class II, DR beta 3 | | | | | | |
| 112 | 6590594 | HIST1H2AC | histone cluster 1, H2ac | 8334 | NM_003512.3 | 1319.1937 | 0.7494 | 0 | 0 |
| 113 | 2260129 | MS4A6A | membrane-spanning | 64231 | NM_022349.2 | 1320.1527 | 1.2241 | 0 | 0 |
| | | | 4-domains, | | | | | | |
| | | | subfamily A, member 6A | | | | | | |
| 114 | 2750367 | PMAIP1 | phorbol-12-myristate-13- | 5366 | NM_021127.1 | 1322.9263 | 1.344 | 0 | 0 |
| | | | acetate-induced protein 1 | | | | | | |
| 115 | 5890095 | LILRA5 | leukocyte immunoglobulin- | 353514 | NM_021250.2 | 1328.6256 | 0.7741 | 0 | 0 |
| | | | like receptor, subfamily A | | | | | | |
| | | | (with TM domain), | | | | | | |
| | | | member 5 | | | | | | |
| 116 | 2900360 | KIR2DL4 | killer cell | 3805 | NM_002255.3 | 1329.4767 | 0.7459 | 0 | 0 |
| | | | immunoglobulin-like | | | | | | |
| | | | receptor, two domains, | | | | | | |
| | | | long cytoplamic tail, 4 | | | | | | |
| 117 | 6940176 | ACTR3 | ARP3 actin-related protein 3 | 10096 | NM_005721.3 | 1331.182 | 1.3755 | 0 | 0 |
| | | | homolog (yeast) | | | | | | |
| 118 | 4010040 | HBG2 | hemoglobin, gamma G | 3048 | NM_000184.2 | 1331.5404 | 1.1022 | 0 | 0 |
| 119 | 270338 | TRAT1 | T cell receptor associated | 50852 | NM_016388.2 | 1334.9472 | 1.2985 | 0 | 0 |
| | | | transmembrane adaptor 1 | | | | | | |
| 120 | 1070487 | KLRC3 | killer cell lectin-like receptor | 3823 | NM_002261.2 | 1341.8253 | 0.8231 | 0 | 0 |
| | | | subfamily C, member 3 | | | | | | |
| 121 | 6770326 | NLRP8 | NLR family, pyrin domain | 126205 | NM_176811.2 | 1341.9389 | 1.2932 | 0 | 0 |
| | | | containing 8 | | | | | | |
| 122 | 7160692 | NULL | NULL | 644250 | XM_929199.1 | 1343.5684 | 1.3113 | 0 | 0 |
| 123 | 5870136 | CLIC3 | chloride intracellular | 9022 | NM_004669.2 | 1346.5828 | 0.7759 | 0 | 0 |
| | | | channel 3 | | | | | | |
| 124 | 6200747 | LOC220433 | — | 220433 | XM_941684.2 | 1348.1888 | 1.3645 | 0 | 0 |
| 125 | 5260070 | HES4 | hairy and enhancer of split 4 | 57801 | NM_021170.2 | 1348.7064 | 0.7167 | 0 | 0 |
| | | | (Drosophila) | | | | | | |
| 126 | 4250053 | CCL3L1 | chemokine (C-C motif) | 6349 | NM_021006.4 | 1356.1796 | 1.1002 | 0 | 0 |
| | | | ligand 3-like 1 | | | | | | |
| 127 | 6580041 | GNLY | granulysin | 10578 | NM_006433.2 | 1356.7575 | 0.7782 | 0 | 0 |
| 128 | 7040482 | LOC642934 | — | 642934 | XM_942991.2 | 1359.7468 | 1.3681 | 0 | 0 |
| 129 | 3890523 | IL7R | interleukin 7 receptor | 3575 | XM_937367.1 | 1362.7824 | 1.2775 | 0 | 0 |
| 130 | 1340600 | PPP1R15A | protein phosphatase 1, | 23645 | NM_014330.2 | 1373.0141 | 0.7984 | 0 | 0 |
| | | | regulatory | | | | | | |
| | | | (inhibitor) subunit 15A | | | | | | |
| 131 | 5900129 | CROP | — | 51747 | NM_006107.2 | 1375.3663 | 1.3602 | 0 | 0 |
| 132 | 1010592 | CD36 | CD36 molecule | 948 | NM_001001548.1 | 1383.7856 | 1.1993 | 0 | 0 |
| | | | (thrombospondin receptor) | | | | | | |
| 133 | 5720682 | TMEM176A | transmembrane protein 176A | 55365 | NM_018487.2 | 1384.9828 | 0.7916 | 1.00E−04 | 0 |
| 134 | 610437 | CD24 | CD24 molecule | 100133941 | NM_013230.2 | 1388.7966 | 0.7457 | 1.00E−04 | 0 |
| 135 | 4180079 | CRISPLD2 | cysteine-rich secretory protein | 83716 | NM_031476.2 | 1388.8351 | 0.72 | 1.00E−04 | 0 |
| | | | LCCL domain containing 2 | | | | | | |
| 136 | 650112 | LST1 | leukocyte specific transcript 1 | 7940 | NM_007161.2 | 1388.9553 | 0.7844 | 1.00E−04 | 0 |
| 137 | 520382 | CLK1 | CDC-like kinase 1 | 1195 | NM_001024646.1 | 1395.6456 | 1.323 | 0 | 0 |
| 138 | 450537 | HBG1 | hemoglobin, gamma A | 3047 | NM_000559.2 | 1395.7174 | 1.0847 | 0 | 0 |
| 139 | 4490520 | GPR183 | G protein-coupled | 1880 | NM_004951.3 | 1395.8256 | 1.273 | 0 | 0 |
| | | | receptor 183 | | | | | | |
| 140 | 4040398 | MAL | mal, T-cell differentiation | 4118 | NM_022440.1 | 1396.4257 | 1.2775 | 0 | 0 |
| | | | protein | | | | | | |
| 141 | 5900482 | HMGB2 | high-mobility group box 2 | 3148 | NM_002129.2 | 1396.9268 | 1.3569 | 0 | 0 |
| 142 | 510468 | NFE2 | nuclear factor | 4778 | NM_006163.1 | 1400.397 | 0.783 | 0 | 0 |
| | | | (erythroid-derived 2), | | | | | | |
| | | | 45 kDa | | | | | | |
| 143 | 6330196 | MAL | mal, T-cell differentiation | 4118 | NM_002371.2 | 1403.2124 | 1.2786 | 0 | 0 |
| | | | protein | | | | | | |
| 144 | 2100196 | ISG15 | ISG15 ubiquitin-like modifier | 9636 | NM_005101.1 | 1404.6098 | 0.7538 | 0 | 0 |
| 145 | 2260477 | PTGS2 | prostaglandin-endoperoxide | 5743 | NM_000963.1 | 1417.9779 | 1.1062 | 0 | 0 |
| | | | synthase 2 (prostaglandin G/H | | | | | | |
| | | | synthase and cyclooxygenase) | | | | | | |
| 146 | 1780709 | DDX17 | DEAD (Asp-Glu-Ala-Asp) | 10521 | NM_030881.2 | 1418.7298 | 1.3597 | 0 | 0 |
| | | | box polypeptide 17 | | | | | | |
| 147 | 1400672 | AMFR | autocrine motility factor | 267 | NM_001144.4 | 1425.012 | 1.2953 | 0 | 0 |
| | | | receptor | | | | | | |
| 148 | 6110747 | GTMAP2 | GIPase, IMAP family | 26157 | NM_015660.2 | 1433.7316 | 1.3711 | 0 | 0 |
| | | | member 2 | | | | | | |
| 149 | 730379 | LOC388621 | — | 388621 | XM_941195.2 | 1434.8209 | 1.3642 | 0 | 0 |
| 150 | 870338 | EGR1 | early growth response 1 | 1958 | NM_001964.2 | 1437.3716 | 0.8285 | 0 | 0 |
| 151 | 730528 | PLAUR | plasminogen activator, | 5329 | NM_002659.2 | 1448.22 | 0.7926 | 0 | 0 |
| | | | urokinase receptor | | | | | | |
| 152 | 2060440 | MAFB | v-maf musculoaponeurotic | 9935 | NM_005461.3 | 1451.0344 | 0.7939 | 1.00E−04 | 0 |
| | | | fibrosarcoma oncogene | | | | | | |
| | | | homolog B (avian) | | | | | | |
| 153 | 3140750 | RBM38 | RNA binding motif protein 38 | 55544 | NM_183425.1 | 1459.9844 | 0.7692 | 1.00E−04 | 0 |
| 154 | 4490176 | RGS1 | regulator of G-protein | 5996 | NM_002922.3 | 1460.4038 | 1.0695 | 1.00E−04 | 0 |
| | | | signaling 1 | | | | | | |
| 155 | 2370010 | GZMH | granzyme H | 2999 | NM_033423.3 | 1464.3431 | 0.8085 | 1.00E−04 | 0 |
| | | | (cathepsin G-like 2, | | | | | | |
| | | | protein h-CCPX) | | | | | | |
| 156 | 7210035 | SNORD13 | small nucleolar | 692084 | NR_003041.1 | 1465.3176 | 0.8786 | 1.00E−04 | 0 |
| | | | RNA, C/D box 13 | | | | | | |
| 157 | 780465 | SLC11A1 | solute carrier family 11 | 6556 | NM_000578.3 | 1465.5854 | 0.7539 | 1.00E−04 | 0 |
| | | | (proton-coupled | | | | | | |
| | | | divalent metal ion | | | | | | |
| | | | transporters), member 1 | | | | | | |
| 158 | 1410278 | PF4V1 | platelet factor 4 variant 1 | 5197 | NM_002620.2 | 1467.1678 | 0.7455 | 1.00E−04 | 0 |
| 159 | 10224 | METRNL | meteorin, glial | 284207 | XM_941466.2 | 1470.6115 | 0.7549 | 1.00E−04 | 0 |
| | | | cell differentiation | | | | | | |
| | | | regulator-like | | | | | | |
| 160 | 6840324 | RPL13L | ribosomal protein L13-like | 283345 | NR_002803.1 | 1473.3493 | 1.3141 | 0 | 0 |
| 161 | 4760243 | NULL | NULL | 648210 | XR_018923.1 | 1473.563 | 1.3236 | 0 | 0 |
| 162 | 2690390 | HCG4 | HLA complex group 4 | 54435 | NR_002139.1 | 1483.3064 | 0.7057 | 1.00E−04 | 0 |
| 163 | 6130168 | GSTM2 | glutathione S-transferase mu 2 | 2946 | NM_000848.2 | 1484.5662 | 1.1586 | 1.00E−04 | 0 |
| | | | (muscle) | | | | | | |
| 164 | 6650035 | LOC338758 | — | 338758 | XM_931359.2 | 1485.0079 | 0.786 | 1.00E−04 | 0 |
| 165 | 2710575 | CD69 | CD69 molecule | 969 | NM_001781.1 | 1492.1903 | 1.1581 | 1.00E−04 | 0 |
| 166 | 1030458 | C19orf10 | chromosome 19 open reading | 56005 | NM_019107.3 | 1495.2283 | 0.7531 | 1.00E−04 | 0 |
| | | | frame 10 | | | | | | |
| 167 | 3990703 | IL10 | interleukin 10 | 3586 | NM_000572.2 | 1496.2645 | 1.2881 | 1.00E−04 | 0 |
| 168 | 2230563 | PPBP | pro-platelet basic protein | 5473 | NM_002704.2 | 1498.9534 | 0.8688 | 1.00E−04 | 0 |
| | | | (chemokine (C—X—C motif) | | | | | | |
| | | | ligand 7) | | | | | | |
| 169 | 5490768 | GPR56 | G protein-coupled receptor 56 | 9289 | NM_201525.1 | 1502.85 | 0.9478 | 1.00E−04 | 0 |
| 170 | 4040576 | IL6 | interleukin 6 | 3569 | NM_000600.1 | 1503.702 | 0.8304 | 1.00E−04 | 0 |
| | | | (interferon, beta 2) | | | | | | |
| 171 | 1850523 | GZMB | granzyme B | 3002 | NM_004131.3 | 1505.0467 | 0.8201 | 1.00E−04 | 0 |
| | | | (granzyme 2, cytotoxic | | | | | | |
| | | | T-lymphocyte-associated | | | | | | |
| | | | serine esterase 1) | | | | | | |
| 172 | 1570553 | IL8 | interleukin 8 | 3576 | NM_000584.2 | 1513.6436 | 1.115 | 1.00E−04 | 0 |
| 173 | 110332 | NULL | NULL | NULL | XM_378421 | 1518.0403 | 1.3148 | 1.00E−04 | 0 |
| 174 | 4670193 | PRF1 | perforin 1 | 5551 | NM_005041.4 | 1519.3926 | 0.8813 | 1.00E−04 | 0 |
| | | | (pore forming protein) | | | | | | |
| 175 | 5670605 | MATK | megakaryocyte-associated | 4145 | NM_139354.2 | 1520.0412 | 0.81 | 1.00E−04 | 0 |
| | | | tyrosine kinase | | | | | | |
| 176 | 6650735 | NULL | NULL | NULL | BCO20840 | 1525.1509 | 1.2826 | 1.00E−04 | 0 |
| 177 | 6510246 | NULL | NULL | 648210 | XR_018923.1 | 1527.7265 | 1.3216 | 1.00E−04 | 0 |
| 178 | 1510681 | NULL | NULL | 440673 | NM_001039703.1 | 1530.4662 | 0.7386 | 2.00E−04 | 0 |
| 179 | 6650161 | GNA13 | guanine nucleotide | 10672 | NM_006572.3 | 1532.1658 | 1.3018 | 1.00E−04 | 0 |
| | | | binding protein | | | | | | |
| | | | (G protein), alpha 13 | | | | | | |
| 180 | 70162 | TDG | thymine-DNA glycosylase | 6996 | NM_003211.3 | 1532.3669 | 0.7618 | 2.00E−04 | 0 |
| 181 | 6290114 | SDPR | serum deprivation response | 8436 | NM_004657.4 | 1536.2237 | 0.7967 | 2.00E−04 | 0 |
| | | | (phosphatidylserine | | | | | | |
| | | | binding protein) | | | | | | |
| 182 | 3830242 | NULL | NULL | 642093 | XM_942754.1 | 1537.7061 | 1.2013 | 1.00E−04 | 0 |
| 183 | 150609 | LOC652493 | — | 652493 | XM_941953.1 | 1538.659 | 0.8658 | 2.00E−04 | 0 |
| 184 | 1410221 | S100A12 | S100 calcium binding | 6283 | NM_005621.1 | 1538.9825 | 1.2033 | 1.00E−04 | 0 |
| | | | protein A12 | | | | | | |
| 185 | 1030333 | CCL2 | chemokine (C-C motif) | 6347 | NM_002982.3 | 1539.4369 | 1.0091 | 2.00E−04 | 0 |
| | | | ligand 2 | | | | | | |
| 186 | 7000356 | RXRA | retinoid X receptor, alpha | 6256 | NM_002957.3 | 1541.9695 | 0.7849 | 2.00E−04 | 0 |
| 187 | 4610129 | RETN | resistin | 56729 | NM_020415.2 | 1542.2649 | 0.9579 | 1.00E−04 | 0 |
| 188 | 290687 | LOC653884 | — | 653884 | XM_936240.1 | 1544.2074 | 0.7447 | 2.00E−04 | 0 |
| 189 | 6280332 | CXCL16 | chemokine (C—X—C motif) | 58191 | NM_022059.1 | 1546.842 | 0.7614 | 2.00E−04 | 0 |
| | | | ligand 16 | | | | | | |
| 190 | 6860347 | FAM46C | family with sequence | 54855 | NM_017709.3 | 1546.9813 | 0.8189 | 2.00E−04 | 0 |
| | | | similarity 46, member C | | | | | | |
| 191 | 3890326 | SOD2 | superoxide dismutase 2, | 6648 | NM_001024465.1 | 1548.2034 | 0.8086 | 2.00E−04 | 0 |
| | | | mitochondrial | | | | | | |
| 192 | 940398 | EIF3M | eukaryotic translation | 10480 | NM_006360.3 | 1548.6574 | 1.3154 | 2.00E−04 | 0 |
| | | | initiation factor 3, | | | | | | |
| | | | subunit M | | | | | | |
| 193 | 5700070 | ALPL | alkaline phosphatase, | 249 | NM_000478.3 | 1554.899 | 0.8918 | 2.00E−04 | 0 |
| | | | liver/bone/kidney | | | | | | |
| 194 | 3940438 | NCF1 | neutrophil cytosolic factor 1 | 653361 | NM_000265.4 | 1557.7407 | 0.7547 | 2.00E−04 | 0 |
| 195 | 2900328 | PTPLAD2 | protein tyrosine | 401494 | NM_001010915.1 | 1561.8011 | 1.2964 | 2.00E−04 | 0 |
| | | | phosphatase-like A | | | | | | |
| | | | domain containing 2 | | | | | | |
| 196 | 3930537 | NULL | NULL | NULL | M97723 | 1563.1544 | 1.2251 | 2.00E−04 | 0 |
| 197 | 3060040 | PABPC1 | poly(A) binding protein, | 26986 | NM_002568.3 | 1573.2119 | 1.3135 | 2.00E−04 | 0 |
| | | | cytoplasmic 1 | | | | | | |
| 198 | 3870338 | IFI44L | interferon-induced protein | 10964 | NM_006820.1 | 1574.4975 | 0.7976 | 2.00E−04 | 0 |
| | | | 44-like | | | | | | |
| 199 | 3840564 | MS4A7 | membrane-spanning | 58475 | NM_206938.1 | 1576.6213 | 0.7676 | 2.00E−04 | 0 |
| | | | 4-domains, | | | | | | |
| | | | subfamily A, member 7 | | | | | | |
| 200 | 3370201 | LOC648343 | — | 648343 | XR_018327.1 | 1584.6649 | 1.2593 | 2.00E−04 | 0 |
| 201 | 6280504 | LOC100008589 | — | 100008589 | NR_003287.1 | 1584.9019 | 0.8501 | 2.00E−04 | 0 |
| 202 | 7200435 | ASCL2 | achaete-scute complex | 430 | NM_005170.2 | 1588.1072 | 0.7612 | 2.00E−04 | 0 |
| | | | homolog 2 | | | | | | |
| | | | (Drosophila) | | | | | | |
| 203 | 7050326 | CDKN2D | cyclin-dependent | 1032 | NM_079421.2 | 1592.7956 | 0.771 | 2.00E−04 | 0 |
| | | | kinase inhibitor | | | | | | |
| | | | 2D (p19, inhibits CDK4) | | | | | | |
| 204 | 7320561 | OAS2 | 2′-5′-oligoadenylate | 4939 | NM_016817.2 | 1592.8459 | 0.782 | 2.00E−04 | 0 |
| | | | synthetase 2, 69/71 kDa | | | | | | |
| 205 | 2640088 | ALDOA | aldolase A, | 226 | NM_184041.1 | 1601.3395 | 0.7836 | 2.00E−04 | 0 |
| | | | fructose-bisphosphate | | | | | | |
| 206 | 6380079 | FAM53B | family with sequence | 9679 | NM_014661.3 | 1601.8988 | 0.7927 | 2.00E−04 | 0 |
| | | | similarity 53, member B | | | | | | |
| 207 | 6590446 | NULL | NULL | 651149 | XM_940278.1 | 1603.0262 | 1.1689 | 2.00E−04 | 0 |
| 208 | 5050541 | RPL15P3 | ribosomal protein | 653232 | XM_944104.2 | 1610.6217 | 1.2836 | 2.00E−04 | 0 |
| | | | L15 pseudogene 3 | | | | | | |
| 209 | 6620136 | MYH9 | myosin, heavy chain 9, | 4627 | NM_002473.3 | 1611.8118 | 0.7916 | 2.00E−04 | 0 |
| | | | non-muscle | | | | | | |
| 210 | 2340743 | CPA3 | carboxypeptidase A3 | 1359 | NM_001870.1 | 1617.7401 | 1.2372 | 2.00E−04 | 0 |
| | | | (mast cell) | | | | | | |
| 211 | 6400392 | GSTM1 | glutathione S-transferase mu 1 | 2944 | NM_000561.2 | 1618.8346 | 1.1278 | 2.00E−04 | 0 |
| 212 | 1030348 | CDKN1B | cyclin-dependent kinase | 1027 | NM_004064.2 | 1622.318 | 1.2788 | 2.00E−04 | 0 |
| | | | inhibitor 1B (p27, Kip1) | | | | | | |
| 213 | 130717 | ARPC1B | actin related protein 2/3 | 10095 | NM_005720.2 | 1622.3622 | 0.7728 | 2.00E−04 | 0 |
| | | | complex, subunit 1B, 41 kDa | | | | | | |
| 214 | 3420373 | SOD2 | superoxide dismutase 2, | 6648 | NM_001024466.1 | 1623.9115 | 0.8404 | 2.00E−04 | 0 |
| | | | mitochondrial | | | | | | |
| 215 | 7320424 | HNRPA1L-2 | — | 664709 | NR_002944.2 | 1627.4854 | 1.3497 | 2.00E−04 | 0 |
| 216 | 830356 | SLC4A5 | solute carrier family 4, | 57835 | NM_133478.2 | 1629.4592 | 1.2662 | 3.00E−04 | 0 |
| | | | sodium bicarbonate | | | | | | |
| | | | cotransporter, member 5 | | | | | | |
| 217 | 1240450 | CD27 | CD27 molecule | 939 | NM_001242.4 | 1630.1171 | 1.2929 | 3.00E−04 | 0 |
| 218 | 520408 | IFIT3 | interferon-induced protein | 3437 | NM_001549.2 | 1636.6346 | 0.7611 | 2.00E−04 | 0 |
| | | | with tetratricopeptide | | | | | | |
| | | | repeats 3 | | | | | | |
| 219 | 5420095 | MYC | v-myc myelocytomatosis viral | 4609 | NM_002467.3 | 1636.6524 | 1.3042 | 3.00E−04 | 0 |
| | | | oncogene homolog (avian) | | | | | | |
| 220 | 7510253 | ACRBP | acrosin binding protein | 84519 | NM_032489.2 | 1637.0001 | 0.7754 | 2.00E−04 | 0 |
| 221 | 520392 | P2RY13 | purinergic receptor P2Y, | 53829 | NM_023914.2 | 1637.1533 | 0.7731 | 2.00E−04 | 0 |
| | | | G-protein coupled, 13 | | | | | | |
| 222 | 70630 | RNF144B | ring finger protein 144B | 255488 | NM_182757.2 | 1637.3458 | 0.7382 | 2.00E−04 | 0 |
| 223 | 5360273 | SNCA | synuclein, alpha | 6622 | NM_007308.1 | 1637.8283 | 0.8495 | 2.00E−04 | 0 |
| | | | (non A4 component | | | | | | |
| | | | of amyloid precursor) | | | | | | |
| 224 | 1690706 | HIST1H3H | histone cluster 1, H3h | 8357 | NM_003536.2 | 1645.7986 | 0.7667 | 3.00E−04 | 0 |
| 225 | 7560593 | OSM | oncostatin M | 5008 | NM_020530.3 | 1647.1147 | 0.8196 | 3.00E−04 | 0 |
| 226 | 770167 | CD79B | CD79b molecule, | 974 | NM_001039933.1 | 1648.4831 | 1.2138 | 3.00E−04 | 0 |
| | | | immunoglobulin- | | | | | | |
| | | | associated beta | | | | | | |
| 227 | 1010035 | NLRP3 | NLR family, pyrin domain | 114548 | NM_004895.3 | 1648.7639 | 0.8612 | 3.00E−04 | 0 |
| | | | containing 3 | | | | | | |
| 228 | 2710451 | NULL | NULL | 651894 | XM_941155.2 | 1649.6418 | 1.2523 | 3.00E−04 | 0 |
| 229 | 2260551 | RAD21 | RAD21 homolog (S. pombe) | 5885 | NM_006265.1 | 1653.0804 | 1.2801 | 3.00E−04 | 0 |
| 230 | 5670465 | ADM | adrenomedullin | 133 | NM_001124.1 | 1655.0659 | 0.7829 | 3.00E−04 | 0 |
| 231 | 6420446 | CMPK1 | cytidine monophosphate | 51727 | NM_016308.1 | 1656.035 | 1.3183 | 3.00E−04 | 0 |
| | | | (UMP-CMP) kinase 1, | | | | | | |
| | | | cytosolic | | | | | | |
| 232 | 4260372 | GTSCR1 | Gilles de la Tourette | 220158 | XM_496277.2 | 1659.3612 | 1.26 | 3.00E−04 | 0 |
| | | | syndrome chromosome | | | | | | |
| | | | region, candidate 1 | | | | | | |
| 233 | 2490450 | hCG_1992539 | — | 91561 | XM_934176.1 | 1661.3741 | 1.2023 | 3.00E−04 | 0 |
| 234 | 4040170 | HBQ1 | hemoglobin, theta 1 | 3049 | NM_005331.3 | 1662.4015 | 0.8109 | 3.00E−04 | 0 |
| 235 | 870202 | TNFSF10 | tumor necrosis factor (ligand) | 8743 | NM_003810.2 | 1663.4194 | 0.8562 | 3.00E−04 | 0 |
| | | | superfamily, member 10 | | | | | | |
| 236 | 1980594 | FTHL8 | ferritin, heavy | 2501 | NR_002203.1 | 1668.0712 | 1.1674 | 3.00E−04 | 0 |
| | | | polypeptide-like 8 | | | | | | |
| 237 | 2370041 | LRRN3 | leucine rich repeat neuronal 3 | 54674 | NM_018334.3 | 1672.3412 | 1.3042 | 3.00E−04 | 0 |
| 238 | 4220110 | NULL | NULL | 647450 | XM_936518.1 | 1672.5458 | 0.8791 | 3.00E−04 | 0 |
| 239 | 1510612 | MYL4 | myosin, light chain 4, alkali; | 4635 | NM_002476.2 | 1681.4977 | 0.7979 | 4.00E−04 | 0 |
| | | | atrial, embryonic | | | | | | |
| 240 | 4010139 | BANK1 | B-cell scaffold protein | 55024 | NM_001083907.1 | 1683.3115 | 1.2158 | 4.00E−04 | 0 |
| | | | with ankyrin repeats 1 | | | | | | |
| 241 | 5090215 | IFI6 | interferon, alpha-inducible | 2537 | NM_022873.2 | 1690.3545 | 0.818 | 4.00E−04 | 0 |
| | | | protein 6 | | | | | | |
| 242 | 620717 | CCL5 | chemokine (C-C motif) | 6352 | NM_002985.2 | 1691.5746 | 0.812 | 4.00E−04 | 0 |
| | | | ligand 5 | | | | | | |
| 243 | 4610681 | LOC653658 | — | 653658 | XM_939687.2 | 1693.2132 | 1.3052 | 4.00E−04 | 0 |
| 244 | 4290349 | LOC643949 | — | 643949 | XR_018645.1 | 1695.2143 | 1.2653 | 4.00E−04 | 0 |
| 245 | 450615 | MT2A | metallothionein 2A | 4502 | NM_005953.2 | 1696.9888 | 0.7903 | 4.00E−04 | 0 |
| 246 | 1110373 | C15orf48 | chromosome 15 open | 84419 | NM_032413.2 | 1702.1009 | 0.946 | 4.00E−04 | 0 |
| | | | reading frame 48 | | | | | | |
| 247 | 6400243 | ABLIM1 | actin binding LIM protein 1 | 3983 | NM_001003407.1 | 1703.3875 | 1.2737 | 4.00E−04 | 0 |
| 248 | 6560279 | VAV3 | vav 3 guanine nucleotide | 10451 | NM_006113.4 | 1704.7097 | 1.0099 | 4.00E−04 | 0 |
| | | | exchange factor | | | | | | |
| 249 | 3940504 | CD79A | CD79a molecule, | 973 | NM_021601.3 | 1705.1684 | 1.136 | 4.00E−04 | 0 |
| | | | immunoglobulin- | | | | | | |
| | | | associated alpha | | | | | | |
| 250 | 6510072 | ACTG1 | actin, gamma 1 | 71 | NM_001614.2 | 1705.2256 | 0.8476 | 4.00E−04 | 0 |
| 251 | 610524 | CCL3L1 | chemokine (C-C motif) | 6349 | NM_021006.4 | 1713.0407 | 1.1746 | 4.00E−04 | 0 |
| | | | ligand 3-like 1 | | | | | | |
| 252 | 6590646 | FAM26F | family with sequence | 441168 | NM_001010919.1 | 1714.9816 | 1.2875 | 5.00E−04 | 0 |
| | | | similarity 26, member F | | | | | | |
| 253 | 3830136 | NACAP1 | nascent-polypeptide- | 83955 | NR_002182.1 | 1716.7585 | 1.3074 | 5.00E−04 | 0 |
| | | | associated complex | | | | | | |
| | | | alpha polypeptide | | | | | | |
| | | | pseudogene 1 | | | | | | |
| 254 | 7650220 | hCG_1787519 | — | 643007 | XM_938089.2 | 1718.0255 | 1.2797 | 5.00E−04 | 0 |
| 255 | 1070477 | ALDH1A1 | aldehyde dehydrogenase 1 | 216 | NM_000689.3 | 1718.8928 | 1.2672 | 5.00E−04 | 0 |
| | | | family, member A1 | | | | | | |
| 256 | 6510754 | ALDH1A1 | aldehyde dehydrogenase 1 | 216 | NM_000689.3 | 1720.5388 | 1.2203 | 5.00E−04 | 0 |
| | | | family, member A1 | | | | | | |
| 257 | 3930008 | RPL14 | ribosomal protein L14 | 9045 | NM_001034996.1 | 1720.6296 | 1.0405 | 5.00E−04 | 0 |
| 258 | 840551 | CEP27 | centrosomal protein 27 kDa | 55142 | NM_018097.1 | 1724.7797 | 1.2511 | 5.00E−04 | 0 |
| 259 | 5050402 | HIST1H2BK | histone cluster 1, H2bk | 85236 | NM_080593.1 | 1726.2525 | 0.7687 | 5.00E−04 | 0 |
| 260 | 4920228 | FFAR2 | free fatty acid receptor 2 | 2867 | NM_005306.1 | 1726.9269 | 0.8449 | 5.00E−04 | 0 |
| 261 | 3400521 | NULL | NULL | 653086 | XM_930995.1 | 1728.9741 | 1.249 | 5.00E−04 | 0 |
| 262 | 4890241 | GPR56 | G protein-coupled receptor 56 | 9289 | NM_201524.1 | 1730.7855 | 0.9285 | 5.00E−04 | 0 |
| 263 | 6280446 | NULL | NULL | 642989 | XM_926370.1 | 1731.2064 | 1.2277 | 5.00E−04 | 0 |
| 264 | 2030132 | LOC653506 | — | 653506 | XM_927769.1 | 1732.6509 | 0.8096 | 5.00E−04 | 0 |
| 265 | 3310538 | CD36 | CD36 molecule | 948 | NM_000072.2 | 1732.7017 | 1.2213 | 5.00E−04 | 0 |
| | | | (thrombospondin | | | | | | |
| | | | receptor) | | | | | | |
| 266 | 2640025 | HP | haptoglobin | 3240 | NM_005143.2 | 1733.6315 | 0.7543 | 5.00E−04 | 0 |
| 267 | 1940047 | AIF1 | allograft inflammatory | 199 | NM_001623.3 | 1734.8998 | 0.7781 | 5.00E−04 | 0 |
| | | | factor 1 | | | | | | |
| 268 | 5690671 | GOLGA8B | golgi autoantigen, golgin | 440270 | NM_001023567.2 | 1735.7582 | 1.2537 | 5.00E−04 | 0 |
| | | | subfamily a, 8B | | | | | | |
| 269 | 2470601 | IL1RN | interleukin 1 receptor | 3557 | NM_173842.1 | 1736.4413 | 0.8188 | 5.00E−04 | 0 |
| | | | antagonist | | | | | | |
| 270 | 4150201 | BCL2 | B-cell CLL/lymphoma 2 | 596 | NM_000633.2 | 1737.2395 | 1.2312 | 5.00E−04 | 0 |
| 271 | 6580059 | UCP2 | uncoupling protein 2 | 7351 | NM_003355.2 | 1738.6131 | 1.2387 | 5.00E−04 | 0 |
| | | | (mitochondrial, | | | | | | |
| | | | proton carrier) | | | | | | |
| 272 | 3180131 | hCG_1984468 | — | 389672 | XM_933893.1 | 1749.2716 | 1.3078 | 5.00E−04 | 0 |
| 273 | 1770273 | ANKRD30B | ankyrin repeat domain 30B | 374860 | NM_001029862.1 | 1750.2072 | 1.2567 | 5.00E−04 | 0 |
| 274 | 6450102 | NULL | NULL | 642113 | XM_936253.1 | 1754.1531 | 0.9366 | 6.00E−04 | 0 |
| 275 | 1340743 | IL8 | interleukin 8 | 3576 | NM_000584.2 | 1754.2793 | 1.148 | 5.00E−04 | 0 |
| 276 | 6620292 | C10orf54 | chromosome 10 open | 64115 | NM_022153.1 | 1755.4366 | 0.7563 | 6.00E−04 | 0 |
| | | | reading frame 54 | | | | | | |
| 277 | 2570358 | HNRPDL | heterogeneous nuclear | 9987 | NM_031372.1 | 1756.6323 | 1.304 | 6.00E−04 | 0 |
| | | | ribonucleoprotein D-like | | | | | | |
| 278 | 510209 | LOC643310 | — | 643310 | XM_926656.1 | 1756.8922 | 1.3155 | 6.00E−04 | 0 |
| 279 | 1770603 | TCN1 | transcobalamin I (vitamin B12 | 6947 | NM_001062.3 | 1757.6057 | 1.1103 | 6.00E−04 | 0 |
| | | | binding protein, | | | | | | |
| | | | R binder family) | | | | | | |
| 280 | 1440121 | tcag7.1261 | — | 645968 | XM_928934.1 | 1759.0714 | 1.2841 | 6.00E−04 | 0 |
| 281 | 160242 | C13orf15 | chromosome 13 open | 28984 | NM_014059.2 | 1764.5447 | 1.1056 | 6.00E−04 | 0 |
| | | | reading frame 15 | | | | | | |
| 282 | 4200541 | FAM113B | family with sequence | 91523 | NM_138371.1 | 1768.2475 | 1.2217 | 6.00E−04 | 0 |
| | | | similarity 113, member B | | | | | | |
| 283 | 990500 | AVPI1 | arginine | 60370 | NM_021732.1 | 1770.8805 | 0.8357 | 7.00E−04 | 0 |
| | | | vasopressin-induced 1 | | | | | | |
| 284 | 1440605 | ZNF101 | zinc finger protein 101 | 94039 | NM_033204.2 | 1771.8967 | 1.2622 | 6.00E−04 | 0 |
| 285 | 2230167 | LOC653773 | — | 653773 | XM_938755.2 | 1772.9624 | 1.2915 | 6.00E−04 | 0 |
| 286 | 10358 | SPN | sialophorin | 6693 | NM_001030288.1 | 1772.9705 | 0.7869 | 7.00E−04 | 0 |
| 287 | 7150711 | ZNF223 | zinc finger protein 223 | 7766 | NM_013361.3 | 1775.2142 | 1.2356 | 6.00E−04 | 0 |
| 288 | 3420154 | NLRP3 | NLR family, pyrin domain | 114548 | NM_001079821.1 | 1778.0983 | 0.8935 | 7.00E−04 | 0 |
| | | | containing 3 | | | | | | |
| 289 | 1710630 | ST6GAL1 | ST6 beta-galactosamide | 6480 | NM_003032.2 | 1778.5828 | 1.224 | 6.00E−04 | 0 |
| | | | alpha-2,6-sialyltranferase 1 | | | | | | |
| 290 | 5360064 | GNLY | granulysin | 10578 | NM_012483.1 | 1786.0213 | 0.8506 | 7.00E−04 | 0 |
| 291 | 1500201 | HNRNPC | heterogeneous nuclear | 3183 | NM_031314.1 | 1788.8391 | 1.3177 | 7.00E−04 | 0 |
| | | | ribonucleoprotein C (C1/C2) | | | | | | |
| 292 | 6020523 | PPP2R2B | protein phosphatase 2 | 5521 | NM_181676.1 | 1795.9286 | 0.8076 | 8.00E−04 | 0 |
| | | | (formerly 2A), regulatory | | | | | | |
| | | | subunit B, beta | | | | | | |
| | | | isoform | | | | | | |
| 293 | 6280008 | HSD17B11 | hydroxysteroid (17-beta) | 51170 | NM_016245.3 | 1796.2197 | 1.2755 | 7.00E−04 | 0 |
| | | | dehydrogenase 11 | | | | | | |
| 294 | 3780193 | FCRLA | Fc receptor-like A | 84824 | NM_032738.3 | 1801.0361 | 1.1008 | 7.00E−04 | 0 |
| 295 | 580706 | CCR2 | chemokine (C-C motif) | 1231 | NM_000647.4 | 1810.4502 | 1.0875 | 8.00E−04 | 0 |
| | | | receptor 2 | | | | | | |
| 296 | 7510386 | IL1RN | interleukin 1 receptor | 3557 | NM_173843.1 | 1813.3956 | 0.9866 | 8.00E−04 | 0 |
| | | | antagonist | | | | | | |
| 297 | 1230767 | IFITM2 | interferon induced | 10581 | NM_006435.2 | 1814.7255 | 0.7643 | 8.00E−04 | 0 |
| | | | transmembrane | | | | | | |
| | | | protein 2 (1-8D) | | | | | | |
| 298 | 460164 | FTHL11 | ferritin, heavy | 2503 | NR_002204.1 | 1816.8226 | 1.1796 | 8.00E−04 | 0 |
| | | | polypeptide-like 11 | | | | | | |
| 299 | 4150100 | PASK | PAS domain containing | 23178 | NM_015148.2 | 1817.7821 | 1.1603 | 8.00E−04 | 0 |
| | | | serine/threonine kinase | | | | | | |
| 300 | 4050491 | TCEA3 | transcription elongation | 6920 | NM_003196.1 | 1817.9245 | 1.2597 | 8.00E−04 | 0 |
| | | | factor A (SII), 3 | | | | | | |

TABLE 5
List of top 300 genes selected by Spearman's rank correlation coefficient.
Spearman

| No. | Probe ID | Name of gene | Description of gene | EntrezID | Acc | limma_logFC | Cor_Spearman_R | Cor_Spearman_absR | Cor_Spearman_Pval | Cor_Spearman_adPval |
|---|---|---|---|---|---|---|---|---|---|---|
| 1 | 1300687 | NULL | NULL | 731950 | XR_016039.1 | −0.061135983 | 0.700750469 | 0.700750469 | 1.25E−06 | 0.0212 |
| 2 | 2710653 | FBXO38 | F-box protein 38 | 81545 | NM_030793.3 | −0.149047116 | 0.660225141 | 0.660225141 | 6.35E−06 | 0.037 |
| 3 | 5860465 | USP9Y | “ubiquitin specific peptidase 9, Y- | 8287 | NM_004654.3 | −0.094524102 | 0.654409006 | 0.654409006 | 8.00E−06 | 0.037 |
| | | | linked (fat facets-like, | | | | | | | |
| | | | Drosophila)” | | | | | | | |
| 4 | 3390368 | PDP2 | — | 57546 | NM_020786.1 | 0.068777448 | −0.652345216 | 0.652345216 | 8.72E−06 | 0.037 |
| 5 | 3130477 | C7orf28A | chromosome 7 open reading frame | 51622 | XM_001133729.1 | −0.383441629 | 0.634521576 | 0.634521576 | 1.73E−05 | 0.0392 |
| | | | 28A | | | | | | | |
| 6 | 1780719 | PTGES3 | prostaglandin E synthase 3 | 10728 | NM_006601.4 | −0.528677962 | 0.633395872 | 0.633395872 | 1.80E−05 | 0.0392 |
| | | | (cytosolic) | | | | | | | |
| 7 | 6760017 | YY1 | YY1 transcription factor | 7528 | NM_003403.3 | −0.328869705 | 0.630393996 | 0.630393996 | 2.02E−05 | 0.0392 |
| 8 | 270544 | NR2C1 | “nuclear receptor subfamily 2, | 7181 | NM_003297.1 | −0.155303368 | 0.626641651 | 0.626641651 | 2.32E−05 | 0.0392 |
| | | | group C, member 1” | | | | | | | |
| 9 | 5960072 | NULL | NULL | NULL | BY797688 | −0.097047292 | 0.626266417 | 0.626266417 | 2.35E−05 | 0.0392 |
| 10 | 2650601 | GPBP1L1 | GC-rich promoter binding protein | 60313 | NM_021639.3 | −0.185092124 | 0.623827392 | 0.623827392 | 2.58E−05 | 0.0392 |
| | | | 1-like 1 | | | | | | | |
| 11 | 6420446 | CMPK1 | “oytidine monophosphate (UMP- | 51727 | NM_016308.1 | −0.398631213 | 0.622514071 | 0.622514071 | 2.70E−05 | 0.0392 |
| | | | CMP) kinase 1, cytosolic” | | | | | | | |
| 12 | 7510379 | SACS | spastic ataxia of Charlevoix- | 26278 | NM_014363.3 | −0.121241812 | 0.621388368 | 0.621388368 | 2.82E−05 | 0.0392 |
| | | | Saguenay (sacsin) | | | | | | | |
| 13 | 3130296 | AMY2A | “amylase, alpha 2A (pancreatic)” | 279 | NM_000699.2 | −0.282794372 | 0.616510319 | 0.616510319 | 3.36E−05 | 0.0392 |
| 14 | 520706 | UBE4A | “ubiquitination factor E4A (UFD2 | 9354 | NM_004788.2 | −0.230502672 | 0.614258912 | 0.614258912 | 3.64E−05 | 0.0392 |
| | | | homolog, yeast)” | | | | | | | |
| 15 | 1230593 | SP3 | Sp3 transcription factor | 6670 | NM_001017371.3 | −0.175703429 | 0.613883677 | 0.613883677 | 3.69E−05 | 0.0392 |
| 16 | 2120017 | NOL8 | nucleolar protein 8 | 55035 | NM_017948.4 | −0.189491166 | 0.612945591 | 0.612945591 | 3.82E−05 | 0.0392 |
| 17 | 990315 | TCP1 | t-complex 1 | 6950 | NM_030752.2 | −0.256767834 | 0.612195122 | 0.612195122 | 3.92E−05 | 0.0392 |
| 18 | 730288 | COG3 | component of oligomeric golgi | 83548 | NM_031431.2 | −0.128112796 | 0.606941839 | 0.606941839 | 4.72E−05 | 0.0408 |
| | | | complex 3 | | | | | | | |
| 19 | 150672 | KLHL7 | kelch-like 7 (Drosophila) | 55975 | NM_001031710.1 | −0.155913324 | 0.605816135 | 0.605816135 | 4.91E−05 | 0.0408 |
| 20 | 6590484 | NAP1L1 | nucleosome assembly protein | 4673 | NM_139207.1 | −0.357418466 | 0.605253283 | 0.605253283 | 5.01E−05 | 0.0408 |
| | | | 1-like 1 | | | | | | | |
| 21 | 770441 | DOPEY1 | dopey family member 1 | 23033 | NM_015018.2 | −0.10084509 | 0.604878049 | 0.604878049 | 5.07E−05 | 0.0408 |
| 22 | 990044 | KIAA1147 | KIAA1147 | 57189 | XM_001130020.1 | −0.162506963 | 0.601125704 | 0.601125704 | 5.78E−05 | 0.0408 |
| 23 | 3120075 | TIA1 | TIA1 cytotoxic granule-associated | 7072 | NM_022173.1 | −0.154497679 | 0.600375235 | 0.600375235 | 5.93E−05 | 0.0408 |
| | | | RNA binding protein | | | | | | | |
| 24 | 4830255 | DPP4 | dipeptidyl-peptidase 4 | 1803 | NM_001935.3 | −0.307400655 | 0.599249531 | 0.599249531 | 6.16E−05 | 0.0408 |
| 25 | 4880521 | CDC16 | cell division cycle 16 homolog | 8881 | NM_003903.3 | −0.34380491 | 0.598499062 | 0.598499062 | 6.32E−05 | 0.0408 |
| | | | (S. cerevisiae) | | | | | | | |
| 26 | 150706 | UGP2 | UDP-glucose pyrophosphorylase 2 | 7360 | NM_006759.3 | −0.347146055 | 0.597560976 | 0.597560976 | 6.53E−05 | 0.0408 |
| 27 | 1780709 | DDX17 | DEAD (Asp-Glu-Ala-Asp) box | 10521 | NM_030881.2 | −0.443292451 | 0.596998124 | 0.596998124 | 6.66E−05 | 0.0408 |
| | | | polypeptide 17 | | | | | | | |
| 28 | 1400240 | LDHB | lactate dehydrogenase B | 3945 | NM_002300.4 | −0.605485777 | 0.596622889 | 0.596622889 | 6.74E−05 | 0.0408 |
| 29 | 6180497 | GOLGA8C | “golgi autoantigen, golgin | 400304 | XM_375152.3 | −0.242008817 | 0.594559099 | 0.594559099 | 7.23E−05 | 0.0423 |
| | | a, 8C” | subfamily | | | | | | | |
| 30 | 5900129 | CROP | — | 51747 | NM_006107.2 | −0.443849065 | 0.593433396 | 0.593433396 | 7.51E−05 | 0.0425 |
| 31 | 4570170 | KIAA0947 | — | 23379 | NM_015325.1 | −0.180354486 | 0.590243902 | 0.590243902 | 8.35E−05 | 0.0446 |
| 32 | 5720300 | G3BP1 | GTPase activating protein (SH3 | 10146 | NM_005754.2 | −0.241645343 | 0.590056285 | 0.590056285 | 8.41E−05 | 0.0446 |
| | | | domain) binding protein 1 | | | | | | | |
| 33 | 1110102 | HS2ST1 | heparan sulfate 2-O- | 9653 | NM_012262.2 | −0.075582168 | 0.587992495 | 0.587992495 | 9.00E−05 | 0.0463 |
| | | | sulfotransferase 1 | | | | | | | |
| 34 | 2640025 | HP | haptoglobin | 3240 | NM_005143.2 | 0.40681683 | −0.585553471 | 0.585553471 | 9.79E−05 | 0.0476 |
| 35 | 6020575 | NNT | nicotinamide nucleotide | 23530 | NM_012343.3 | −0.191702435 | 0.584803002 | 0.584803002 | 0.000100019 | 0.0476 |
| | | | transhydrogenase | | | | | | | |
| 36 | 7400376 | RABL2A | “RAB, member of RAS oncogene | 11159 | NM_013412.1 | −0.178370764 | 0.58424015 | 0.58424015 | 0.000101881 | 0.0476 |
| | | | family-like 2A” | | | | | | | |
| 37 | 4220731 | P4HA1 | “prolyl 4-hydroxylase, alpha | 5033 | NM_000917.2 | −0.307837835 | 0.583677298 | 0.583677298 | 0.000103774 | 0.0476 |
| | | | polypeptide 1” | | | | | | | |
| 38 | 1110091 | TIAL1 | TIA1 cytotoxic granule-associated | 7073 | NM_001033925.1 | −0.233908998 | 0.581425891 | 0.581425891 | 0.000111672 | 0.0486 |
| | | | RNA binding protein-like 1 | | | | | | | |
| 39 | 670209 | ZNF700 | zinc finger protein 700 | 90592 | NM_144566.1 | −0.134476397 | 0.581425891 | 0.581425891 | 0.000111672 | 0.0486 |
| 40 | 3930561 | PRKC1 | “protein kinase C, iota” | 5584 | NM_002740.5 | −0.105841727 | 0.577298311 | 0.577298311 | 0.000127583 | 0.0538 |
| 41 | 4880463 | SEC24A | “SEC24 family, member A | 10802 | NM_021982.1 | −0.069649892 | 0.57673546 | 0.57673546 | 0.000129906 | 0.0538 |
| | | | (S. cerevisiae)” | | | | | | | |
| 42 | 450195 | Sept7 | septin 7 | 989 | NM_001788.4 | −0.31815245 | 0.573921201 | 0.573921201 | 0.000142102 | 0.0538 |
| 43 | 7000521 | PRPS2 | phosphoribosyl pyrophosphate | 5634 | NM_001039091.1 | −0.203904286 | 0.573733583 | 0.573733583 | 0.000142951 | 0.0538 |
| | | | synthetase 2 | | | | | | | |
| 44 | 3130370 | ZNF83 | zinc finger protein 83 | 55769 | NM_018300.2 | −0.30567958 | 0.573170732 | 0.573170732 | 0.000145525 | 0.0538 |
| 45 | 6650056 | ZNF566 | zinc finger protein 566 | 84924 | NM_032838.2 | −0.051770571 | 0.573170732 | 0.573170732 | 0.000145525 | 0.0538 |
| 46 | 240463 | RNF216L | ring finger protein 216-like | 441191 | XR_001271.1 | 0.162378967 | −0.572795497 | 0.572795497 | 0.000147702 | 0.0538 |
| 47 | 5900731 | SFRS12 | “splicing factor, arginine/serine- | 140890 | NM_001077199.1 | −0.290167988 | 0.572420263 | 0.572420263 | 0.000149023 | 0.0538 |
| | | | rich 12” | | | | | | | |
| 48 | 1740136 | SLC38A2 | “solute carrier family 38, member | 54407 | NM_018976.3 | −0.214673013 | 0.568105066 | 0.568105066 | 0.000170654 | 0.0603 |
| | | | 2” | | | | | | | |
| 49 | 6280521 | NULL | NULL | 648399 | XM_937448.1 | −0.092941768 | 0.567354597 | 0.567354597 | 0.000174694 | 0.0605 |
| 50 | 840358 | EXOSC10 | exosome component 10 | 5394 | NM_002685.2 | −0.226165883 | 0.565853659 | 0.565853659 | 0.000183034 | 0.0609 |
| 51 | 5360719 | MAPK9 | mitogen-activated protein kinase 9 | 5601 | NM_002752.3 | −0.123212945 | 0.565853659 | 0.565853659 | 0.000183034 | 0.0609 |
| 52 | 1090892 | GPBP1 | GC-rich promoter binding | 65056 | NM_022913.1 | −0.264875927 | 0.564165103 | 0.564165103 | 0.000192846 | 0.0623 |
| | | | protein 1 | | | | | | | |
| 53 | 6380673 | TUBE1 | “tubulin, epsilon 1” | 51175 | NM_016262.3 | −0.138726153 | 0.563602251 | 0.563602251 | 0.00019622 | 0.0623 |
| 54 | 2570132 | CLEC2D | “C-type lectin domain family 2, | 29121 | NM_001004419.2 | −0.163087579 | 0.563227017 | 0.563227017 | 0.0001985 | 0.0623 |
| | | | member D” | | | | | | | |
| 55 | 3990608 | MAN2A1 | “mannosidase, alpha, class 2A, | 4124 | NM_002372.2 | −0.327379686 | 0.562288931 | 0.562288931 | 0.000204303 | 0.0623 |
| | | | member 1” | | | | | | | |
| 56 | 4670605 | MGC40489 | — | 146880 | XR_016048.1 | −0.029223716 | 0.562101313 | 0.562101313 | 0.000205482 | 0.0623 |
| 57 | 4830605 | NULL | NULL | NULL | AV735490 | −0.046858933 | 0.560037523 | 0.560037523 | 0.000218863 | 0.0652 |
| 58 | 6940176 | ACTR3 | ARP3 actin-related protein 3 | 10096 | NM_005721.3 | −0.459963089 | 0.556097561 | 0.556097561 | 0.000246612 | 0.0721 |
| | | | homolog (yeast) | | | | | | | |
| 59 | 5560465 | NOP56 | NOP56 ribonucleoprotein homolog | 10528 | NM_006392.2 | −0.266935568 | 0.553095685 | 0.553095685 | 0.000269844 | 0.0768 |
| | | | (yeast) | | | | | | | |
| 60 | 7000474 | GARNL1 | GTPase activating Rap/RanGAP | 253959 | NM_194301.2 | −0.175348366 | 0.55272045 | 0.55272045 | 0.000272883 | 0.0768 |
| | | | domain-like 1 | | | | | | | |
| 61 | 4850735 | TAF4B | “TAF4b RNA polymerase II, | 6875 | NM_005640.1 | −0.058542324 | 0.552345216 | 0.552345216 | 0.000275952 | 0.0768 |
| | | | TATA box binding protein (TBP)- | | | | | | | |
| | | | associated factor, 105 kDa” | | | | | | | |
| 62 | 3800707 | XPO4 | exportin 4 | 64328 | NM_022459.3 | −0.217365077 | 0.551594747 | 0.551594747 | 0.000282185 | 0.077 |
| 63 | 3290669 | SFRS12 | “splicing factor, arginine/serine- | 140890 | NM_139168.2 | −0.132873689 | 0.551031895 | 0.551031895 | 0.000286942 | 0.077 |
| | | | rich 12” | | | | | | | |
| 64 | 6110630 | HIST1H2BK | “histone cluster 1, H2bk” | 85236 | NM_080593.1 | 0.379122401 | −0.550469043 | 0.550469043 | 0.000292583 | 0.077 |
| 65 | 5810619 | TADA1L | “transcriptional adaptor 1 (HFI1 | 117143 | NM_053053.2 | −0.16203449 | 0.550093809 | 0.550093809 | 0.000295032 | 0.077 |
| | | | homolog, yeast)-like” | | | | | | | |
| 66 | 510209 | LOC643310 | — | 643310 | XM_926856.1 | −0.395581648 | 0.549530957 | 0.549530957 | 0.000299984 | 0.0771 |
| 67 | 6450437 | NULL | NULL | NULL | BF445990 | 0.102742584 | −0.545028143 | 0.545028143 | 0.000343313 | 0.0859 |
| 68 | 4050195 | FAM10A4 | “family with sequence similarity | 145165 | NR_002183.1 | −0.370567771 | 0.544840525 | 0.544840525 | 0.000344253 | 0.0859 |
| | | | 10, member A4 pseudogene” | | | | | | | |
| 69 | 7380707 | ZFAND1 | “zinc finger, AN1-type domain 1” | 79752 | NM_024699.1 | −0.254784176 | 0.544090056 | 0.544090056 | 0.000351858 | 0.0865 |
| 70 | 70128 | NULL | NULL | NULL | AK123745 | −0.051335734 | 0.543339587 | 0.543339587 | 0.000359613 | 0.0869 |
| 71 | 2030332 | PTPN18 | “protein tyrosine phosphatase, | 26469 | NM_014369.2 | 0.083763446 | −0.541838649 | 0.541838649 | 0.000376607 | 0.0869 |
| | | | non-receptor type 18 (brain- | | | | | | | |
| | | | derived)” | | | | | | | |
| 72 | 6650594 | ATP11B | “ATPase, class VI, type 11B” | 23200 | NM_014616.1 | −0.252853775 | 0.541838649 | 0.541838649 | 0.000375587 | 0.0869 |
| 73 | 2120537 | SPOCD1 | SPOC domain containing 1 | 90853 | NM_144569.4 | 0.09473433 | −0.541838649 | 0.541838649 | 0.000376607 | 0.0869 |
| 74 | 6380768 | EIF4E | eukaryotic translation initiation | 1977 | NM_001968.2 | −0.084050702 | 0.540900563 | 0.540900563 | 0.000385893 | 0.0869 |
| | | | factor 4E | | | | | | | |
| 75 | 6980253 | PTPLB | “protein tyrosine phosphatase-like | 201562 | NM_198402.2 | −0.336175973 | 0.540337711 | 0.540337711 | 0.000392197 | 0.0869 |
| | | | (proline instead of catalytic | | | | | | | |
| | | | arginine), member b” | | | | | | | |
| 76 | 6060553 | RBP5 | “retinol binding protein 5, cellular” | 83758 | NM_031491.1 | 0.051243739 | −0.540337711 | 0.540337711 | 0.000393257 | 0.0869 |
| 77 | 60553 | NDFIP1 | Nedd4 family interacting protein 1 | 80762 | NM_030571.2 | −0.171766084 | 0.540150094 | 0.540150094 | 0.000394319 | 0.0869 |
| 78 | 4210129 | ELOVL5 | “ELOVL family member 5, | 60481 | NM_021814.3 | −0.284710319 | 0.538836773 | 0.538836773 | 0.000409464 | 0.0891 |
| | | | elongation of long chain fatty acids | | | | | | | |
| | | | (FEN1/Elo2, SUR4/Elo3-like, | | | | | | | |
| 79 | 6760326 | ZNF658 | zinc finger protein 658 | 26149 | NM_033160.4 | −0.078993442 | 0.537898687 | 0.537898687 | 0.0004206 | 0.0903 |
| 80 | 3060040 | PABPC1 | “poly(A) binding protein, | 26986 | NM_002568.3 | −0.393451244 | 0.537148218 | 0.537148218 | 0.000429704 | 0.0905 |
| | | | cytoplasmic 1” | | | | | | | |
| 81 | 460386 | PTMA | “prothymosin, alpha” | 5757 | NM_001099285.1 | −0.590989351 | 0.5369606 | 0.5369606 | 0.000432007 | 0.0905 |
| 82 | 290128 | NULL | NULL | 643985 | XM_927235.1 | −0.048540479 | 0.536022514 | 0.536022514 | 0.000443691 | 0.0918 |
| 83 | 3310309 | CCDC135 | coiled-coil domain containing 135 | 84229 | NM_032269.4 | 0.099558313 | −0.535272045 | 0.535272045 | 0.000454449 | 0.0929 |
| 84 | 7400047 | LOC388344 | — | 388344 | XM_371023.4 | −0.327727336 | 0.534521576 | 0.534521576 | 0.000462978 | 0.0935 |
| 85 | 6550750 | ARMC8 | armedillo repeat containing 8 | 25852 | NM_014154.2 | −0.087200394 | 0.533020638 | 0.533020638 | 0.000483014 | 0.095 |
| 86 | 2600204 | SACM1L | SAC1 suppressor of actin | 22908 | NM_014016.2 | −0.262966982 | 0.532457786 | 0.532457786 | 0.000490726 | 0.095 |
| | | | mutations 1-like (yeast) | | | | | | | |
| 87 | 6620356 | ARPP-19 | — | 10776 | NM_006628.4 | −0.261668585 | 0.532457786 | 0.532457786 | 0.000490726 | 0.095 |
| 88 | 3710465 | C6orf211 | chromosome 6 open reading frame | 79624 | NM_024573.1 | −0.114858487 | 0.532270169 | 0.532270169 | 0.000493321 | 0.095 |
| | | | 211 | | | | | | | |
| 89 | 6020048 | LOC646103 | — | 646103 | XM_377879.3 | −0.029867018 | 0.531894934 | 0.531894934 | 0.000498548 | 0.095 |
| 90 | 4010632 | LQK1 | — | 642946 | XM_927142.1 | 0.072739876 | −0.531332083 | 0.531332083 | 0.000507815 | 0.0957 |
| 91 | 2320577 | SSR2 | “signal sequence receptor, beta | 6746 | XM_945427.1 | 0.064320484 | −0.530956848 | 0.530956848 | 0.00051318 | 0.0957 |
| | | | (translocon-associated protein | | | | | | | |
| | | | beta)” | | | | | | | |
| 92 | 1780639 | LOC645355 | — | 645355 | XM_932842.1 | 0.036028447 | −0.530206379 | 0.530206379 | 0.000524062 | 0.0967 |
| 93 | 1850612 | PARP2 | poly (ADP-ribose) polymerase 2 | 10038 | NM_005484.2 | −0.097585163 | 0.528893058 | 0.528893058 | 0.000542187 | 0.0989 |
| 94 | 4220673 | NULL | NULL | NULL | AA971450 | 0.072927449 | −0.528517824 | 0.528517824 | 0.000549307 | 0.0992 |
| 95 | 2970196 | DEFB125 | “defensin, beta 125” | 245938 | NM_153325.2 | 0.07618092 | −0.527204503 | 0.527204503 | 0.00056969 | 0.1018 |
| 96 | 2640274 | ALDH5A1 | “aldehyde dehydrogenase 5 family, | 7915 | NM_001080.3 | −0.078301425 | 0.526266417 | 0.526266417 | 0.000583149 | 0.1031 |
| | | | member A1” | | | | | | | |
| 97 | 4780767 | FLJ40473 | — | 285226 | XR_001031.1 | −0.068012051 | 0.525891182 | 0.525891182 | 0.000589222 | 0.1031 |
| 98 | 4760243 | NULL | NULL | 648210 | XR_018923.1 | −0.404442095 | 0.52532833 | 0.52532833 | 0.000598437 | 0.1031 |
| 99 | 4540356 | UFM1 | ubiquitin-fold modifier 1 | 51569 | NM_016617.1 | −0.290998607 | 0.525140713 | 0.525140713 | 0.000601537 | 0.1031 |
| 100 | 2680440 | NULL | NULL | NULL | BF338665 | 0.061724508 | −0.523639775 | 0.523639775 | 0.000628477 | 0.1066 |
| 101 | 770021 | PRKRA | “protein kinase, interferon- | 8575 | NM_003690.3 | −0.229357783 | 0.522138837 | 0.522138837 | 0.000653139 | 0.1081 |
| | | | inducible double stranded RNA | | | | | | | |
| | | | dependent activator” | | | | | | | |
| 102 | 840064 | LOC645489 | — | 645489 | XM_928514.1 | −0.199041088 | 0.52195122 | 0.52195122 | 0.000656492 | 0.1081 |
| 103 | 6650646 | C4orf39 | chromosome 4 open reading frame | 152756 | NM_153027.1 | −0.056865183 | 0.52195122 | 0.52195122 | 0.000656492 | 0.1081 |
| | | | 39 | | | | | | | |
| 104 | 7000754 | AMY2B | “amylase, alpha 2B (pancreatic)” | 280 | NM_020978.3 | −0.131806513 | 0.520825516 | 0.520825516 | 0.000676935 | 0.1095 |
| 105 | 6860148 | SLC9A6 | “solute carrier family 9 | 10479 | NM_001042537.1 | −0.17456976 | 0.520637899 | 0.520637899 | 0.000680398 | 0.1095 |
| | | | (sodium/hydrogen exchanger), | | | | | | | |
| | | | member 6” | | | | | | | |
| 106 | 7400343 | STX2 | syntaxin 2 | 2054 | NM_001980.2 | −0.258793675 | 0.520450281 | 0.520450281 | 0.000683875 | 0.1095 |
| 107 | 5420053 | CCT6P1 | “chaperonin containing TCP1, | 643253 | NR_003110.2 | −0.281922881 | 0.519324578 | 0.519324578 | 0.000705079 | 0.1118 |
| | | | subunit 6 (zeta) pseudogene 1” | | | | | | | |
| 108 | 6560162 | TMED7 | transmembrane emp24 protein | 51014 | NM_181836.3 | −0.243305775 | 0.518949343 | 0.518949343 | 0.000712276 | 0.1119 |
| | | | transport domain containing 7 | | | | | | | |
| 109 | 1850300 | TC2N | “tandem C2 domains, nuclear” | 123036 | NM_152332.3 | −0.236871126 | 0.518198874 | 0.518198874 | 0.000726869 | 0.113 |
| 110 | 4150168 | ARSA | arylsulfatase A | 410 | NM_000487.3 | 0.091560891 | −0.51782364 | 0.51782364 | 0.000736124 | 0.113 |
| 111 | 6560161 | NULL | NULL | NULL | BX111675 | 0.054993081 | −0.517448405 | 0.517448405 | 0.000743605 | 0.113 |
| 112 | 1500465 | AASS | aminoadipate-semialdehyde | 10157 | NM_005763.2 | −0.034373234 | 0.516697936 | 0.516697936 | 0.000756858 | 0.113 |
| | | | synthase | | | | | | | |
| 113 | 4250154 | NULL | NULL | 648749 | XM_937834.2 | −0.061658345 | 0.516510319 | 0.516510319 | 0.000760684 | 0.113 |
| 114 | 2750411 | RGAG4 | retrotransposon gag domain | 340526 | NM_001024455.2 | 0.0613934 | −0.516135084 | 0.516135084 | 0.000770323 | 0.113 |
| | | | containing 4 | | | | | | | |
| 115 | 6420730 | RPL9 | ribosomal protein L9 | 6133 | NM_001024921.2 | −0.56653985 | 0.515947467 | 0.515947467 | 0.000772284 | 0.113 |
| 116 | 4180356 | RBBP6 | retinoblastoma binding protein 6 | 5930 | NM_032626.5 | −0.053093332 | 0.51575985 | 0.51575985 | 0.000776159 | 0.113 |
| 117 | 4150553 | TAF13 | “TAF13 RNA polymerase II, | 6884 | NM_005645.3 | 0.061312413 | −0.515572233 | 0.515572233 | 0.000782035 | 0.113 |
| | | | TATA box binding protein (TBP)- | | | | | | | |
| | | | associated factor, 18 kDa” | | | | | | | |
| 118 | 3610521 | PCDHGB6 | “protocadherin gamma | 56100 | NM_018926.2 | 0.176789549 | −0.515384615 | 0.515384615 | 0.000785974 | 0.113 |
| | | | subfamily B, 6” | | | | | | | |
| 119 | 4180142 | KIAA1370 | KIAA1370 | 56204 | NM_019600.1 | −0.224539294 | 0.514834146 | 0.514634146 | 0.0007999 | 0.1139 |
| 120 | 6450538 | TCERG1 | transcription elongation regulator 1 | 10915 | NM_006706.3 | −0.153163323 | 0.514258912 | 0.514258912 | 0.000807957 | 0.1139 |
| 121 | 5310736 | FAM162A | “family with sequence similarity | 26365 | NM_014367.3 | −0.324511803 | 0.514071295 | 0.514071295 | 0.000812012 | 0.1139 |
| | | | 162, member A” | | | | | | | |
| 122 | 290687 | LOC653084 | — | 653884 | XM_936240.1 | 0.425268736 | −0.513320826 | 0.513320826 | 0.000830488 | 0.1155 |
| 123 | 3710681 | ARFGEF1 | ADP-ribosylation factor guanine | 10565 | NM_006421.3 | −0.094839399 | 0.512757974 | 0.512757974 | 0.000840913 | 0.116 |
| | | | nucleotide-exchange factor | | | | | | | |
| | | | 1(brefeldin A-inhibited) | | | | | | | |
| 124 | 2000035 | NULL | NULL | NULL | AL042883 | 0.08373784 | −0.512382739 | 0.512382739 | 0.000851456 | 0.1165 |
| 125 | 7160767 | RBBP4 | retinoblastoma binding protein 4 | 5928 | NM_005610.1 | −0.101719082 | 0.510881801 | 0.510881801 | 0.000883795 | 0.12 |
| 126 | 2570358 | HNRPDL | heterogeneous nuclear | 9987 | NM_031372.1 | −0.382998221 | 0.509943715 | 0.509943715 | 0.000905959 | 0.122 |
| | | | ribonucleoprotein D-like | | | | | | | |
| 127 | 4390576 | DFFA | “DNA fragmentation factor, | 1676 | NM_213566.1 | 0.121909434 | −0.50956848 | 0.50956848 | 0.000917226 | 0.1225 |
| | | | 45 kDa, alpha polypeptide” | | | | | | | |
| 128 | 1820528 | PAPSS1 | 3′-phosphoadenosine 5′- | 9061 | NM_005443.4 | −0.222706769 | 0.509005629 | 0.509005629 | 0.000928618 | 0.1231 |
| | | | phosphosulfate synthase 1 | | | | | | | |
| 129 | 6040379 | ZBTB11 | zinc finger and BTB domain | 27107 | NM_014415.2 | −0.043557823 | 0.508067542 | 0.508067542 | 0.000951782 | 0.1235 |
| | | | containing 11 | | | | | | | |
| 130 | 160440 | NULL | NULL | 643389 | XM_926721.1 | −0.052401185 | 0.507879925 | 0.507879925 | 0.000956476 | 0.1235 |
| 131 | 1710646 | C11orf63 | chromosome 11 open reading | 79864 | NM_024806.2 | −0.036113925 | 0.507692308 | 0.507692308 | 0.000961191 | 0.1235 |
| | | | frame 63 | | | | | | | |
| 132 | 3120537 | GAB2 | GRB2-associated binding protein 2 | 9846 | NM_080491.1 | 0.113527825 | −0.507317073 | 0.507317073 | 0.000973069 | 0.1235 |
| 133 | 4540138 | NGB | neuroglobin | 58157 | NM_021257.3 | 0.062540263 | −0.506941839 | 0.506941839 | 0.000982665 | 0.1235 |
| 134 | 5910131 | PDE6H | “phosphodiesterase 6H, cGMP- | 5149 | NM_006205.1 | 0.060610886 | −0.506754221 | 0.506754221 | 0.000987495 | 0.1235 |
| | | | specific, cone, gamma” | | | | | | | |
| 135 | 6980286 | RNF219 | ring finger protein 219 | 79596 | NM_024546.2 | −0.105227382 | 0.506754221 | 0.506754221 | 0.000985077 | 0.1235 |
| 136 | 6650161 | GNA13 | “guanine nucleotide binding | 10672 | NM_006572.3 | −0.380533537 | 0.506566604 | 0.506566604 | 0.000989917 | 0.1235 |
| | | | protein (G protein), alpha 13” | | | | | | | |
| 137 | 6380747 | ANKRD32 | ankyrin repeat domain 32 | 84250 | NM_032290.2 | −0.104537188 | 0.505253283 | 0.505253283 | 0.001024398 | 0.1251 |
| 138 | 580014 | C12orf43 | chromosome 12 open reading | 64897 | NM_022895.1 | −0.20852646 | 0.505065666 | 0.505065666 | 0.00102941 | 0.1251 |
| | | | frame 43 | | | | | | | |
| 139 | 3850180 | CHCHD7 | coiled-coil-helix-coiled-coil-helix | 79145 | NM_001011670.1 | −0.119451503 | 0.505065666 | 0.505065666 | 0.00102941 | 0.1251 |
| | | | domain containing 7 | | | | | | | |
| 140 | 610367 | HECA | headcase homolog (Drosophila) | 51696 | NM_016217.2 | −0.312188665 | 0.504878049 | 0.504878049 | 0.001034444 | 0.1251 |
| 141 | 780402 | RTN4 | retioulon 4 | 57142 | NM_020532.4 | −0.274156562 | 0.504690432 | 0.504690432 | 0.0010395 | 0.1251 |
| 142 | 770128 | L3MBTL3 | l(3)mbt-like 3 (Drosophila) | 84456 | NM_032438.1 | −0.161561418 | 0.503939962 | 0.503939962 | 0.001059945 | 0.1251 |
| 143 | 3780465 | SMARCA5 | “SWI/SNF related, matrix | 8467 | NM_003601.2 | −0.115124978 | 0.503752345 | 0.503752345 | 0.001065112 | 0.1251 |
| | | | associated, actin dependent | | | | | | | |
| | | | regulator of chromatin, subfamily | | | | | | | |
| | | | a. | | | | | | | |
| 144 | 5490603 | hCG_1783417 | — | 401019 | NM_001080831.1 | −0.173305696 | 0.503752345 | 0.503752345 | 0.001065112 | 0.1251 |
| 145 | 4610138 | CAPZA1 | “capping protein (actin filament) | 829 | NM_006135.1 | −0.36644329 | 0.503377111 | 0.503377111 | 0.001075513 | 0.1251 |
| | | | muscle Z-line, alpha 1” | | | | | | | |
| 146 | 2450326 | NULL | NULL | 642047 | XM_936157.1 | 0.047996723 | −0.503377111 | 0.503377111 | 0.001078127 | 0.1251 |
| 147 | 6580064 | C14orf19 | chromosome 14 open reading | 280655 | NR_002937.1 | −0.152106349 | 0.503001876 | 0.503001876 | 0.001086005 | 0.1251 |
| | | | frame 19 | | | | | | | |
| 148 | 7040524 | FAM76A | “family with sequence similarity | 199870 | NM_152660.1 | −0.052516764 | 0.502814259 | 0.502814259 | 0.001091285 | 0.1251 |
| | | | 76, member A” | | | | | | | |
| 149 | 6770634 | USP8 | ubiquitin specific peptidase 8 | 9101 | NM_005154.2 | −0.15261273 | 0.50206379 | 0.50206379 | 0.001112634 | 0.1253 |
| 150 | 2120468 | C10orf58 | chromosome 10 open reading | 84293 | NM_032333.2 | −0.327354271 | 0.501876173 | 0.501876173 | 0.001118029 | 0.1253 |
| | | | frame 58 | | | | | | | |
| 151 | 2070019 | UBA6 | ubiquitin-like modifier activating | 55236 | NM_018227.5 | −0.194843638 | 0.501688555 | 0.501688555 | 0.001123447 | 0.1253 |
| | | | enzyme 6 | | | | | | | |
| 152 | 5390433 | DICER1 | “dicer 1, ribonuclease type III” | 23405 | NM_030621.2 | −0.111116126 | 0.501688555 | 0.501688555 | 0.001123447 | 0.1253 |
| 153 | 6450129 | ITM2A | integral membrane protein 2A | 9452 | NM_004867.3 | −0.126988076 | 0.501125704 | 0.501125704 | 0.001139843 | 0.1253 |
| 154 | 20288 | Sept11 | septin 11 | 55752 | NM_018243.2 | −0.136166131 | 0.500938086 | 0.500938086 | 0.001145356 | 0.1253 |
| 155 | 6370736 | EIF1AX | “eukaryotic translation initiation | 1964 | NM_001412.3 | −0.117614043 | 0.500375235 | 0.500375235 | 0.001162036 | 0.1253 |
| | | | factor 1A, X-linked” | | | | | | | |
| 156 | 730379 | LOC388621 | — | 388621 | XM_941195.2 | −0.448108038 | 0.500187617 | 0.500187617 | 0.001167644 | 0.1253 |
| 157 | 1500047 | RIN1 | Ras and Rab interactor 1 | 9610 | NM_004292.2 | 0.132155916 | −0.5 | 0.5 | 0.001176101 | 0.1253 |
| 158 | 5960594 | PMS1 | PMS1 postmeiotic segregation | 5378 | NM_000534.3 | −0.077033315 | 0.5 | 0.5 | 0.001173276 | 0.1253 |
| | | | increased 1 (S. cerevisiae) | | | | | | | |
| 159 | 4220114 | NULL | NULL | NULL | DA160411 | 0.070349309 | −0.499624765 | 0.499624765 | 0.001187461 | 0.1253 |
| 160 | 5910463 | PKIA | “protein kinase (cAMP-dependent, | 5569 | NM_006823.2 | −0.254561014 | 0.499437148 | 0.499437148 | 0.001190317 | 0.1253 |
| | | | catalytic) inhibitor alpha” | | | | | | | |
| 161 | 1410170 | GOPC | golgi associated PDZ and coiled- | 57120 | NM_020399.2 | −0.088182858 | 0.498686679 | 0.498686679 | 0.001213381 | 0.1253 |
| | | | coil motif containing | | | | | | | |
| 162 | 4780768 | FAM8A1 | “family with sequence similarity B, | 51439 | NM_016255.1 | −0.099801523 | 0.498499062 | 0.498499062 | 0.001219209 | 0.1253 |
| | | | member A1” | | | | | | | |
| 163 | 1580286 | SEH1L | SEH1-like (S. cerevisiae) | 81929 | NM_031216.3 | −0.083010039 | 0.498311445 | 0.498311445 | 0.001225062 | 0.1253 |
| 164 | 4570403 | NULL | NULL | NULL | BX106581 | 0.112837902 | −0.497748593 | 0.497748593 | 0.001245745 | 0.1253 |
| 165 | 5310747 | PSIP1 | PC4 and SFRS1 interacting | 11168 | NM_033222.2 | −0.298779917 | 0.497748593 | 0.497748593 | 0.001242771 | 0.1253 |
| | | | protein 1 | | | | | | | |
| 166 | 460682 | CCDC132 | coiled-coil domain containing 132 | 55610 | NM_017667.2 | −0.123015026 | 0.497748593 | 0.497748593 | 0.001242771 | 0.1253 |
| 167 | 7550221 | NULL | NULL | NULL | BG207842 | 0.067923939 | −0.497748593 | 0.497748593 | 0.001245745 | 0.1253 |
| 168 | 3520601 | MPO | myeloperoxidase | 4353 | NM_000250.1 | 0.96554979 | −0.497373358 | 0.497373358 | 0.001257702 | 0.1253 |
| 169 | 2570725 | PPCS | phosphopantothenoylcysteine | 79717 | NM_001077447.1 | −0.310167811 | 0.497373358 | 0.497373358 | 0.001254703 | 0.1253 |
| | | | synthetase | | | | | | | |
| 170 | 6200747 | LOC220433 | — | 220433 | XM_941684.2 | −0.448374765 | 0.497185741 | 0.497185741 | 0.001260707 | 0.1253 |
| 171 | 3710682 | NULL | NULL | 642033 | XM_936103.1 | 0.143366073 | −0.496998124 | 0.496998124 | 0.001269761 | 0.1253 |
| 172 | 2100594 | BUB3 | budding uninhibited by | 9184 | NM_004725.2 | −0.303162523 | 0.496247655 | 0.496247655 | 0.001291113 | 0.1253 |
| | | | benzimidazoles 3 homolog (yeast) | | | | | | | |
| 173 | 2760605 | MTMR1 | myotubularin related protein 1 | 8776 | NM_176789.1 | −0.027175642 | 0.496247655 | 0.496247655 | 0.001291113 | 0.1253 |
| 174 | 6900768 | NULL | NULL | NULL | DA572426 | −0.08577853 | 0.49587242 | 0.49587242 | 0.001303457 | 0.1253 |
| 175 | 7150685 | CBX5 | “chromobox homolog 5 (HP1 | 23468 | NM_012117.1 | 0.077258047 | −0.495121951 | 0.495121951 | 0.001331616 | 0.1253 |
| | | | alpha homolog, Drosophila)” | | | | | | | |
| 176 | 160047 | LOC389787 | — | 389787 | XM_497072.2 | −0.49206406 | 0.495121951 | 0.495121951 | 0.00132846 | 0.1253 |
| 177 | 3830598 | CARTPT | CART prepropeptide | 9607 | NM_004291.2 | 0.027959175 | −0.495121951 | 0.495121951 | 0.001331616 | 0.1253 |
| 178 | 870040 | ASCC3 | activating signal cointegrator 1 | 10973 | NM_006828.2 | −0.10465835 | 0.494934334 | 0.494934334 | 0.001334777 | 0.1253 |
| | | | complex subunit 3 | | | | | | | |
| 179 | 2100292 | RBBP7 | retinoblastoma binding protein 7 | 5931 | NM_002893.2 | −0.173081269 | 0.494746717 | 0.494746717 | 0.001341121 | 0.1253 |
| 180 | 5860327 | PRPF18 | PRP18 pre-mRNA processing | 8559 | NM_003675.3 | −0.26670234 | 0.494371482 | 0.494371482 | 0.001353889 | 0.1253 |
| | | | factor 18 homolog (S. cerevisiae) | | | | | | | |
| 181 | 7560300 | TCTEX1D1 | Tctex1 domain containing 1 | 200132 | NM_152665.1 | 0.124259481 | −0.494183865 | 0.494183865 | 0.001363536 | 0.1253 |
| 182 | 5360619 | CDC16 | cell division cycle 16 homolog | 8881 | NM_001078645.1 | −0.262987116 | 0.494183865 | 0.494183865 | 0.001360314 | 0.1253 |
| | | | (S. cerevisiae) | | | | | | | |
| 183 | 3440189 | ZBTB20 | zinc finger and BTB domain | 26137 | NM_015642.3 | −0.287117754 | 0.493996248 | 0.493996248 | 0.001366765 | 0.1253 |
| | | | containing 20 | | | | | | | |
| 184 | 940168 | GTPBP8 | GTP-binding protein 8 (putative) | 29083 | NM_014170.2 | 0.193620887 | −0.493996248 | 0.493996248 | 0.001370001 | 0.1253 |
| 185 | 10142 | CD164 | “CD164 molecule, sialomucin” | 8763 | NM_006016.3 | −0.14302977 | 0.493996248 | 0.493996248 | 0.001366765 | 0.1253 |
| 186 | 6020273 | RPS4Y2 | “ribosomal protein S4, Y-linked 2” | 140032 | NM_001039567.2 | −0.29587893 | 0.49380863 | 0.49380863 | 0.001373244 | 0.1253 |
| 187 | 3990112 | CAST | calpastatin | 831 | NM_001042445.1 | −0.280052769 | 0.493058161 | 0.493058161 | 0.001399433 | 0.127 |
| 188 | 3120762 | MSH5 | mutS homolog 5 (E. coli) | 4439 | NM_002441.3 | 0.058093161 | −0.492682927 | 0.492682927 | 0.001416025 | 0.1278 |
| 189 | 160537 | KDSR | 3-ketodihydrosphingosine | 2531 | NM_002035.1 | −0.165230376 | 0.491932458 | 0.491932458 | 0.001439548 | 0.1292 |
| | | | reductase | | | | | | | |
| 190 | 5290358 | CPT1A | carnitine palmitoyltransferase 1A | 1374 | NM_001031847.1 | 0.165571989 | −0.490994371 | 0.490994371 | 0.001477215 | 0.131 |
| | | | (liver) | | | | | | | |
| 191 | 3440670 | NULL | NULL | 402251 | XM_377933.3 | −0.279019599 | 0.490994371 | 0.490994371 | 0.001473755 | 0.131 |
| 192 | 3370673 | GUSBL2 | “glucuronidase, beta-like 2” | 375513 | NM_206910.1 | 0.128073825 | −0.490806754 | 0.490806754 | 0.001484157 | 0.131 |
| 193 | 4260767 | GP1BA | “glycoprotein 1b (platelet), alpha | 2811 | NM_000173.4 | 0.13089936 | −0.490243902 | 0.490243902 | 0.001505156 | 0.131 |
| | | | polypeptide” | | | | | | | |
| 194 | 6550600 | MYC | v-myc myelocytomatosis viral | 4609 | NM_002467.3 | −0.337363684 | 0.489493433 | 0.489493433 | 0.001529989 | 0.131 |
| | | | oncogene homolog (avian) | | | | | | | |
| 195 | 1740154 | TMEM106B | transmembrane protein 106B | 54664 | NM_018374.2 | −0.106689074 | 0.489493433 | 0.489493433 | 0.001529989 | 0.131 |
| 196 | 7160332 | NULL | NULL | NULL | CF552427 | 0.054930882 | −0.489305816 | 0.489305816 | 0.001540742 | 0.131 |
| 197 | 4010452 | SLC38A6 | “solute carrier family 38, member | 145389 | NM_153811.1 | −0.136358094 | 0.489305816 | 0.489305816 | 0.00153715 | 0.131 |
| | | | 6” | | | | | | | |
| 198 | 510050 | LOC652837 | — | 652837 | XM_942529.1 | −0.036184103 | 0.489305816 | 0.489305816 | 0.00153715 | 0.131 |
| 199 | 5720703 | AKTIP | AKT interacting protein | 64400 | NM_022476.2 | −0.132110131 | 0.489118199 | 0.489118199 | 0.001544342 | 0.131 |
| 200 | 380575 | RPL23 | ribosomal protein L23 | 9349 | NM_000978.3 | −0.338815803 | 0.489118199 | 0.489118199 | 0.001544342 | 0.131 |
| 201 | 1980626 | SMARCA5 | “SWI/SNF related, matrix | 8467 | NM_003601.2 | −0.146115776 | 0.488742964 | 0.488742964 | 0.001558814 | 0.1316 |
| | | | associated, actin dependent | | | | | | | |
| | | | regulator of chromatin, | | | | | | | |
| | | | subfamily a. | | | | | | | |
| 202 | 6110747 | GIMAP2 | “GTPase. IMAP family member 2” | 26157 | NM_015660.2 | −0.45531031 | 0.488555347 | 0.488555347 | 0.001566095 | 0.1316 |
| 203 | 7380382 | RNF115 | ring finger protein 115 | 27246 | NM_014455.1 | 0.278371033 | −0.48836773 | 0.48836773 | 0.001577073 | 0.1318 |
| 204 | 6510619 | NAE1 | NEDD8 activating enzyme E1 | 8883 | NM_001018160.1 | −0.29276015 | 0.487992495 | 0.487992495 | 0.00158812 | 0.1321 |
| | | | subunit 1 | | | | | | | |
| 205 | 6110091 | WSB1 | WD repeat and SOCS box- | 26118 | NM_134265.2 | −0.29256262 | 0.485928705 | 0.485928705 | 0.001671249 | 0.1376 |
| | | | containing 1 | | | | | | | |
| 206 | 2970296 | ALG8 | “asparagine-linked glycosylation 8, | 79053 | NM_001007027.2 | −0.171596568 | 0.485928705 | 0.485928705 | 0.001671249 | 0.1376 |
| | | | alpha-1,3-glucosyltransferase | | | | | | | |
| | | | homolog (S. cerevisiae)” | | | | | | | |
| 207 | 7150554 | LCOR | ligand dependent nuclear receptor | 84458 | NM_032440.1 | −0.293176479 | 0.485741088 | 0.485741088 | 0.001678994 | 0.1376 |
| | | | corepressor | | | | | | | |
| 208 | 6560609 | CNOT8 | “CCR4-NOT transcription | 9337 | NM_004779.4 | −0.206326635 | 0.484990619 | 0.484990619 | 0.001710294 | 0.1395 |
| | | | complex, subunit 8” | | | | | | | |
| 209 | 20091 | GABARAPL2 | GABA(A) receptor-associated | 11345 | NM_007285.6 | −0.164409469 | 0.484615385 | 0.484615385 | 0.001726137 | 0.1395 |
| | | | protein-like 2 | | | | | | | |
| 210 | 2900112 | PPIB | peptidylprolyl isomerase B | 5479 | NM_000942.4 | −0.126826389 | 0.484615385 | 0.484615385 | 0.001726137 | 0.1395 |
| | | | (cyclophilin B) | | | | | | | |
| 211 | 4730458 | CLTC | “clathrin, heavy chain (Hc)” | 1213 | NM_004859.3 | −0.126167554 | 0.483864916 | 0.483864916 | 0.001758214 | 0.1407 |
| 212 | 3140553 | SAR1A | SAR1 homolog A (S. cerevisiae) | 56681 | NM_020150.3 | −0.181453186 | 0.483677298 | 0.483677298 | 0.001766316 | 0.1407 |
| 213 | 5960561 | DBR1 | debranching enzyme homolog 1 | 51163 | NM_016216.2 | −0.051928612 | 0.483677298 | 0.483677298 | 0.001766316 | 0.1407 |
| | | | (S. cerevisiae) | | | | | | | |
| 214 | 4050609 | DNAJA2 | “DnaJ (Hsp40) homolog, | 10294 | NM_005880.2 | −0.266568167 | 0.483489681 | 0.483489681 | 0.00177445 | 0.1407 |
| | | | subfamily A, member 2” | | | | | | | |
| 215 | 990543 | SFRS11 | “splicing factor, arginine/serine- | 9295 | NM_004768.2 | −0.164426621 | 0.482926829 | 0.482926829 | 0.001799054 | 0.1408 |
| | | | rich 11” | | | | | | | |
| 216 | 7570189 | GAGE6 | G antigen 6 | 2578 | NM_001476.1 | 0.084017945 | −0.482363977 | 0.482363977 | 0.001828139 | 0.1408 |
| 217 | 1500201 | HNRNPC | heterogeneous nuclear | 3183 | NM_031314.1 | −0.397999182 | 0.48217636 | 0.48217636 | 0.001832328 | 0.1408 |
| | | | ribonucleoprotein C (C1/C2) | | | | | | | |
| 218 | 2760400 | WDSOF1 | WD repeate and SOF1 domain | 25879 | NM_015420.5 | −0.059823595 | 0.481613508 | 0.481613508 | 0.00185764 | 0.1408 |
| | | | containing | | | | | | | |
| 219 | 5820544 | CTGLF1 | “centaurin, gamma-like family, | 119016 | NM_133446.1 | −0.040059562 | 0.481613508 | 0.481613508 | 0.00185764 | 0.1408 |
| | | | member 1” | | | | | | | |
| 220 | 2680433 | MOSPD1 | motile sperm domain containing 1 | 56180 | NM_019566.1 | −0.042888816 | 0.481613508 | 0.481613508 | 0.00185764 | 0.1408 |
| 221 | 4260504 | SNX14 | sorting nexin 14 | 57231 | NM_020468.2 | −0.218109366 | 0.481425891 | 0.481425891 | 0.001866146 | 0.1408 |
| 222 | 5910543 | GLOD4 | glyoxalase domain containing 4 | 51031 | NM_016080.2 | −0.177207323 | 0.481238274 | 0.481238274 | 0.001874687 | 0.1408 |
| 223 | 840673 | ZNF383 | zinc finger protein 383 | 163087 | NM_152604.1 | −0.129968709 | 0.481238274 | 0.481238274 | 0.001874687 | 0.1408 |
| 224 | 5550711 | SYNE1 | “spectrin repeat containing, nuclear | 23345 | NM_182961.2 | 0.075512374 | −0.481050657 | 0.481050657 | 0.001887563 | 0.1408 |
| | | | envelope 1” | | | | | | | |
| 225 | 4760037 | NULL | NULL | 651648 | XM_940853.1 | −0.018758212 | 0.481050657 | 0.481050657 | 0.001883262 | 0.1408 |
| 226 | 5820202 | LOC644131 | — | 644131 | XR_018325.1 | −0.244724622 | 0.480863039 | 0.480863039 | 0.001891872 | 0.1408 |
| 227 | 4730408 | ANAPC5 | anaphase promoting complex | 51433 | NM_016237.3 | −0.212087146 | 0.480863039 | 0.480863039 | 0.001891872 | 0.1408 |
| | | | subunit 5 | | | | | | | |
| 228 | 3850008 | NULL | NULL | 654189 | XM_942687.1 | −0.093486403 | 0.480675422 | 0.480675422 | 0.001900517 | 0.1408 |
| 229 | 460333 | SPAST | spastin | 6683 | NM_199436.1 | −0.064545186 | 0.480675422 | 0.480675422 | 0.001900517 | 0.1408 |
| 230 | 1110192 | PPM2C | “protein phosphatase 2C, | 54704 | NM_018444.2 | −0.100238781 | 0.48011257 | 0.48011257 | 0.001926661 | 0.1421 |
| | | | magnesium-dependent, catalytic | | | | | | | |
| | | | subunit” | | | | | | | |
| 231 | 3520470 | RBMXP3 | “RNA binding motif protein, X- | 143543 | NR_002197.1 | −0.129523594 | 0.479924953 | 0.479924953 | 0.001935447 | 0.1422 |
| | | | linked pseudogene 3” | | | | | | | |
| 232 | 5900482 | HMGB2 | high-mobility group box 2 | 3148 | NM_002129.2 | −0.440289057 | 0.479174484 | 0.479174484 | 0.001970944 | 0.1442 |
| 233 | 2230300 | ZNF561 | zinc finger protein 561 | 93134 | NM_152289.1 | −0.059435926 | 0.47879925 | 0.47879925 | 0.001988907 | 0.1448 |
| 234 | 6280524 | CCNL1 | cyclin L1 | 57018 | NM_020307.2 | −0.186663803 | 0.476923077 | 0.476923077 | 0.002080918 | 0.1503 |
| 235 | 6650133 | LSM5 | “LSM5 homolog, U6 Small | 23658 | NM_012322.1 | −0.157326463 | 0.476923077 | 0.476923077 | 0.002080918 | 0.1503 |
| | | | nuclear RNA associated | | | | | | | |
| | | | (S. cerevisiae)” | | | | | | | |
| 236 | 1170288 | PRMT1 | protein arginine | 3276 | NM_198319.2 | 0.067974089 | −0.476172608 | 0.476172608 | 0.002123537 | 0.1518 |
| | | | methyltransferase 1 | | | | | | | |
| 237 | 7320424 | HNRPA1L-2 | — | 664709 | NR_002944.2 | −0.432630765 | 0.475797373 | 0.475797373 | 0.002137913 | 0.1518 |
| 238 | 2070025 | SAV1 | salvador homolog 1 (Drosophila) | 60485 | NM_021818.2 | −0.083084103 | 0.475797373 | 0.475797373 | 0.002137913 | 0.1518 |
| 239 | 3940333 | ZNF266 | zinc finger protein 266 | 10781 | NM_006631.2 | −0.108968593 | 0.475797373 | 0.475797373 | 0.002137913 | 0.1518 |
| 240 | 4810072 | TUSC2 | tumor suppressor candidate 2 | 11334 | NM_007275.1 | 0.162628207 | −0.475234522 | 0.475234522 | 0.002171795 | 0.1533 |
| 241 | 7610608 | RP11-122C9.1 | — | 653702 | NM_001093763.1 | −0.316189323 | 0.475046904 | 0.475046904 | 0.002176674 | 0.1533 |
| 242 | 840601 | MEGF10 | multiple EGF-like-domains 10 | 84466 | NM_032446.1 | 0.047723662 | −0.474859287 | 0.474859287 | 0.002191368 | 0.1536 |
| 243 | 3870209 | RTEL1 | regulator of telomere elongation | 51750 | NM_032957.3 | 0.061308622 | −0.474484053 | 0.474484053 | 0.002211097 | 0.1544 |
| | | | helicase 1 | | | | | | | |
| 244 | 4900343 | MORF4L1 | mortality factor 4 like 1 | 10933 | NM_206839.1 | −0.24904666 | 0.473921201 | 0.473921201 | 0.002235979 | 0.1552 |
| 245 | 6270433 | hCG_1646420 | — | 644672 | XM_938396.1 | 0.038585438 | −0.473921201 | 0.473921201 | 0.002240985 | 0.1552 |
| 246 | 3780482 | NULL | NULL | NULL | BQ011293 | 0.031282267 | −0.473545966 | 0.473545966 | 0.002261108 | 0.1557 |
| 247 | 3190059 | IMMT | “inner membrane protein, | 10989 | NM_001100169.1 | −0.221779779 | 0.473358349 | 0.473358349 | 0.002266164 | 0.1557 |
| | | | mitochondrial (mitofilin)” | | | | | | | |
| 248 | 5560703 | C6orf120 | chromosome 6 open reading frame | 387263 | NM_001029863.1 | −0.109371386 | 0.472232645 | 0.472232645 | 0.002327616 | 0.1586 |
| | | | 120 | | | | | | | |
| 249 | 7000672 | AGL | “amylo-1, 6-glucosidase, 4-alpha- | 178 | NM_000642.2 | −0.081394333 | 0.472232645 | 0.472232645 | 0.002327616 | 0.1586 |
| | | | glucanotransferase” | | | | | | | |
| 250 | 6980326 | ANP32C | “acidic (leucine-rich) nuclear | 23520 | NM_012403.1 | −0.074417224 | 0.471669794 | 0.471669794 | 0.00235889 | 0.1589 |
| | | | phosphoprotein 32 family, member | | | | | | | |
| | | | C” | | | | | | | |
| 251 | 2640255 | NULL | NULL | 641848 | XM_935588.1 | −0.645965338 | 0.471482176 | 0.471482176 | 0.002369397 | 0.1589 |
| 252 | 2190390 | NCOA1 | nuclear receptor coactivator 1 | 8648 | NM_147223.2 | −0.208822548 | 0.471482176 | 0.471482176 | 0.002369397 | 0.1589 |
| 253 | 5360204 | NMD3 | NMD3 homolog (S. cerevisiae) | 51068 | NM_015938.3 | −0.201253758 | 0.471482176 | 0.471482176 | 0.002369397 | 0.1589 |
| 254 | 4040242 | FAM89A | “family with sequence similarity | 375061 | NM_198552.1 | 0.108042121 | −0.471294559 | 0.471294559 | 0.002385235 | 0.1591 |
| | | | 89, member A” | | | | | | | |
| 255 | 2690561 | RPLP1 | “ribosomal protein, large, P1” | 6176 | NM_001003.2 | −0.685558024 | 0.471106942 | 0.471106942 | 0.002390536 | 0.1591 |
| 256 | 3390286 | ADRA2B | “adrenergic, alpha-2B-, receptor” | 151 | NM_000682.5 | 0.054174105 | −0.470731707 | 0.470731707 | 0.002417192 | 0.1602 |
| 257 | 5960332 | SLC39A10 | “solute carrier family 39 (zinc | 57181 | NM_020342.1 | −0.147299889 | 0.470168856 | 0.470168856 | 0.002444111 | 0.1608 |
| | | | transporter), member 10” | | | | | | | |
| 258 | 7380068 | CNBP | “CCHC-type zinc finger, nucleic | 7555 | NM_003418.1 | −0.327720874 | 0.469981238 | 0.469981238 | 0.002454952 | 0.1608 |
| | | | acid binding protein” | | | | | | | |
| 259 | 1820300 | CTSO | cathepsin O | 1519 | NM_001334.2 | −0.231977107 | 0.469981238 | 0.469981238 | 0.002454952 | 0.1608 |
| 260 | 6100170 | NULL | NULL | NULL | AI004472 | 0.074355718 | −0.469608004 | 0.469606004 | 0.002482242 | 0.1612 |
| 261 | 7610079 | HSF2BP | heat shock transcription faotor 2 | 11077 | NM_007031.1 | −0.038423478 | 0.469606004 | 0.469606004 | 0.002476763 | 0.1612 |
| | | | binding protein | | | | | | | |
| 262 | 6480600 | THUMPD1 | THUMP domain containing 1 | 55623 | NM_017736.3 | −0.123219301 | 0.469230769 | 0.469230769 | 0.002498744 | 0.1612 |
| 263 | 990528 | DNAJC10 | “DnaJ (Hsp40) homolog, | 54431 | NM_018981.1 | −0.085780126 | 0.469230769 | 0.469230769 | 0.002498744 | 0.1612 |
| | | | subfamily C, member 10” | | | | | | | |
| 264 | 4860066 | NULL | NULL | 647346 | XM_936495.2 | −0.209955699 | 0.468667917 | 0.468667917 | 0.002532038 | 0.1624 |
| 265 | 5050402 | HIST1H2BK | “histone cluster 1, H2bk” | 85236 | NM_080593.1 | 0.379454337 | −0.4684803 | 0.4684803 | 0.002548832 | 0.1624 |
| 266 | 7040482 | LOC642934 | — | 642934 | XM_942991.2 | −0.452151346 | 0.4684803 | 0.4684803 | 0.002543223 | 0.1624 |
| 267 | 2060050 | NULL | NULL | NULL | BM932227 | −0.116682268 | 0.467917448 | 0.467917448 | 0.00257704 | 0.1624 |
| 268 | 6590278 | CBX2 | “chromobox homolog 2 (Pc class | 84733 | NM_005189.1 | 0.077041967 | −0.467542214 | 0.467542214 | 0.002605523 | 0.1624 |
| | | | homolog, Drosophila)” | | | | | | | |
| 269 | 60053 | RPL11 | ribosomal protein L11 | 6135 | NM_000975.2 | −0.156372832 | 0.467542214 | 0.467542214 | 0.002599804 | 0.1624 |
| 270 | 1820068 | AMY1C | “amylase, alpha 1C (salivary)” | 278 | NM_001008219.1 | −0.195378515 | 0.467542214 | 0.467542214 | 0.002599804 | 0.1624 |
| 271 | 430100 | XRCC6 | X-ray repair complementing | 2547 | NM_001469.3 | −0.202101353 | 0.467354597 | 0.467354597 | 0.002611253 | 0.1624 |
| | | | defective repair in Chinese hamster | | | | | | | |
| | | | cells 6 | | | | | | | |
| 272 | 520133 | SUMO2 | SMT3 suppressor of mif two 3 | 6613 | NM_001005849.1 | −0.316672366 | 0.467354597 | 0.467354597 | 0.002611253 | 0.1624 |
| | | | homolog 2 (S. cerevisiae) | | | | | | | |
| 273 | 3060379 | SEC14L1 | SEC14-like 1 (S. cerevisiae) | 6397 | NM_003003.1 | 0.211393155 | −0.467354597 | 0.467354597 | 0.002616994 | 0.1624 |
| 274 | 2760553 | UBA3 | ubiquitin-like modifier activating | 9039 | NM_198197.1 | −0.187898967 | 0.467166979 | 0.467166979 | 0.002622746 | 0.1624 |
| | | | enzyme 3 | | | | | | | |
| 275 | 4540689 | ANKRD10 | ankyrin repeat domain 10 | 55608 | NM_017664.2 | −0.170575575 | 0.466791745 | 0.466791745 | 0.002645865 | 0.1624 |
| 276 | 7100519 | CEP57 | centrosomal protein 57 kDa | 9702 | NM_014679.3 | −0.122048981 | 0.466604128 | 0.466604128 | 0.002657493 | 0.1624 |
| 277 | 4860431 | NBPF14 | “neuroblastoma breakpoint family, | 25832 | NM_015383.1 | −0.189228519 | 0.46641651 | 0.46641651 | 0.002669165 | 0.1624 |
| | | | member 14” | | | | | | | |
| 278 | 6110014 | FUSIP1 | FUS interacting protein | 10772 | NM_054016.1 | 0.343795227 | −0.46641651 | 0.46641651 | 0.002675018 | 0.1624 |
| | | | (serine/arginine-rich) 1 | | | | | | | |
| 279 | 6250609 | KPNA2 | “karyopherin alpha 2 (RAG cohort | 3838 | NM_002266.2 | −0.04951944 | 0.46641651 | 0.46641651 | 0.002669165 | 0.1624 |
| | | | 1, importin alpha 1)” | | | | | | | |
| 280 | 2360630 | FDFT1 | farnesyl-diphosphate | 2222 | NM_004462.3 | −0.242595956 | 0.466041276 | 0.466041276 | 0.002692645 | 0.1624 |
| | | | farnesyltransferase 1 | | | | | | | |
| 281 | 6860673 | NUS1 | nuclear undecaprenyl | 116150 | NM_138459.3 | −0.049044618 | 0.466041276 | 0.466041276 | 0.002692645 | 0.1624 |
| | | | pyrophosphate synthase 1 homolog | | | | | | | |
| | | | (S. cerevisiae) | | | | | | | |
| 282 | 6270674 | RECQL | RecQ protein-like (DNA helicase | 5965 | NM_032941.1 | −0.04289978 | 0.465853659 | 0.465853659 | 0.002704453 | 0.1624 |
| | | | Q1-like) | | | | | | | |
| 283 | 6370435 | ETS1 | v-ets erythroblastosis virus E26 | 2113 | NM_005238.2 | −0.467750348 | 0.465666041 | 0.465666041 | 0.002716307 | 0.1624 |
| | | | oncogene homolog 1 (avian) | | | | | | | |
| 284 | 270091 | C19orf68 | chromosome 19 open reading | 374920 | NM_199341.1 | 0.052642885 | −0.465478424 | 0.465478424 | 0.002734174 | 0.1624 |
| | | | frame 68 | | | | | | | |
| 285 | 1050148 | LOC653264 | — | 653264 | XM_932721.2 | −0.102751263 | 0.465478424 | 0.465478424 | 0.002728207 | 0.1624 |
| 286 | 3990563 | IFNA10 | “interferon, alpha 10” | 3446 | NM_002171.1 | 0.151388979 | −0.465290807 | 0.465290807 | 0.002746142 | 0.1624 |
| 287 | 2690370 | ZNF92 | zinc finger protein 92 | 168374 | NM_007139.2 | −0.058140458 | 0.465290807 | 0.465290807 | 0.002740152 | 0.1624 |
| 288 | 2640551 | CMPK1 | “cytidine monophosphate (UMP- | 51727 | NM_016308.1 | −0.272595837 | 0.464915572 | 0.464915572 | 0.002764182 | 0.1624 |
| | | | CMP) kinase 1, cytosollc” | | | | | | | |
| 289 | 3830470 | PLB1 | phospholipase B1 | 151056 | NM_153021.3 | 0.102166339 | −0.464915572 | 0.464915572 | 0.002770218 | 0.1624 |
| 290 | 1940008 | LOC644330 | — | 644330 | XR_017492.1 | −0.238139626 | 0.464727955 | 0.464727955 | 0.002776266 | 0.1624 |
| 291 | 3610348 | FAM10A4 | “family with sequence similarity | 145165 | NR_002183.1 | −0.192448279 | 0.464540338 | 0.464540338 | 0.002788397 | 0.1626 |
| | | | 10, member A4 pseudogene” | | | | | | | |
| 292 | 6650672 | ZNF439 | zinc finger protein 439 | 90594 | NM_152262.2 | −0.168089512 | 0.464165103 | 0.464165103 | 0.002812798 | 0.1635 |
| 293 | 6590441 | TRIP12 | thyroid hormone receptor | 9320 | NM_004238.1 | −0.196624966 | 0.463789869 | 0.463789869 | 0.002837388 | 0.1643 |
| | | | interactor 12 | | | | | | | |
| 294 | 3310372 | NULL | NULL | NULL | AI066603 | 0.060736288 | −0.463414634 | 0.463414634 | 0.002868392 | 0.1651 |
| 295 | 1740647 | FAM180B | “family with sequence similarity | 399888 | XM_941808.2 | 0.083819707 | −0.4630394 | 0.4630394 | 0.002893409 | 0.1651 |
| | | | 180, member B” | | | | | | | |
| 296 | 3870670 | MED7 | mediator complex subunit 7 | 9443 | NM_004270.3 | −0.059699888 | 0.4630394 | 0.4630394 | 0.002887137 | 0.1651 |
| 297 | 6940102 | TNC | tenasoin C | 3371 | NM_002160.1 | 0.032850087 | −0.4630394 | 0.4630394 | 0.002893409 | 0.1651 |
| 298 | 3940653 | PREPL | prolyl endopeptidase-like | 9581 | NM_006036.2 | −0.129916608 | 0.462664165 | 0.462664165 | 0.002912298 | 0.1651 |
| 299 | 1570292 | NULL | NULL | NULL | AI807878 | −0.087151047 | 0.462476548 | 0.462476548 | 0.002924951 | 0.1651 |
| 300 | 5890477 | SNORA32 | “small nucleolar RNA, H/ACA | 692063 | NR_003032.1 | −0.085303112 | 0.462288931 | 0.462288931 | 0.002937652 | 0.1651 |
| | | | box 32” | | | | | | | |

TABLE 6
Coefficients used for the prediction of survival time of each patient with the gene set consisting
of top 50 genes selected by Pearson product-moment correlation coefficient, latent variable 3.

| ProbeID | S2_pre | S3_pre | S4_pre | S6_pre | S7_pre | S8_pre | L3_pre | L4_pre | L1_pre | S10_pre | S12_pre | S13_pre |
|---|---|---|---|---|---|---|---|---|---|---|---|---|
| 3390368 | −185 | −188 | −199 | −198 | −173 | −185 | −184 | −184 | −190 | −187 | −183 | −189 |
| 1300687 | 127 | 134 | 118 | 138 | 138 | 130 | 130 | 131 | 135 | 128 | 130 | 134 |
| 5860465 | 38 | 35 | 45 | 33 | 32 | 37 | 34 | 31 | 35 | 32 | 32 | 28 |
| 4390576 | −348 | −362 | −360 | −383 | −349 | −345 | −354 | −350 | −366 | −362 | −354 | −365 |
| 4830255 | 185 | 201 | 184 | 208 | 174 | 206 | 186 | 177 | 186 | 202 | 190 | 182 |
| 4570403 | −406 | −422 | −427 | −449 | −416 | −423 | −415 | −410 | −422 | −433 | −410 | −432 |
| 1780719 | 33 | 69 | −21 | 74 | 32 | 27 | 59 | 64 | 70 | 33 | 65 | 65 |
| 3130477 | −34 | −41 | −45 | −49 | −84 | −62 | −53 | −31 | −51 | −79 | −45 | −55 |
| 6110630 | −478 | −476 | −513 | −525 | −493 | −476 | −469 | −473 | −446 | −508 | −460 | −454 |
| 3310309 | −344 | −350 | −340 | −366 | −352 | −335 | −342 | −337 | −363 | −351 | −334 | −346 |
| 4220731 | 137 | 146 | 224 | 170 | 140 | 157 | 153 | 167 | 149 | 151 | 158 | 173 |
| 520706 | 46 | 47 | 71 | 53 | 83 | 72 | 46 | 42 | 56 | 38 | 45 | 55 |
| 6420446 | −57 | −80 | −87 | −74 | −62 | −73 | −77 | −86 | −68 | −116 | −78 | −71 |
| 1400240 | 350 | 368 | 295 | 432 | 401 | 364 | 376 | 381 | 347 | 439 | 383 | 347 |
| 7510379 | 17 | 14 | 36 | 12 | 31 | 34 | 15 | 4 | 6 | 1 | 10 | 3 |
| 2640025 | −89 | −80 | −56 | −49 | −58 | −43 | −66 | −63 | −62 | −78 | −38 | −54 |
| 3130296 | −98 | −113 | −83 | −115 | −108 | −99 | −96 | −94 | −55 | −79 | −104 | −110 |
| 3520601 | −160 | −166 | −163 | −149 | −177 | −173 | −168 | −165 | −153 | −224 | −176 | −182 |
| 1110091 | 271 | 264 | 228 | 263 | 251 | 281 | 259 | 262 | 284 | 255 | 260 | 263 |
| 3130370 | 427 | 415 | 396 | 457 | 395 | 389 | 425 | 431 | 432 | 450 | 444 | 436 |
| 2030332 | −173 | −171 | −165 | −189 | −178 | −165 | −178 | −173 | −186 | −178 | −177 | −178 |
| 670209 | 246 | 244 | 261 | 263 | 256 | 256 | 247 | 253 | 252 | 264 | 243 | 253 |
| 6560161 | −235 | −240 | −235 | −260 | −241 | −245 | −240 | −238 | −244 | −250 | −239 | −242 |
| 1740647 | −300 | −310 | −305 | −321 | −296 | −303 | −300 | −297 | −305 | −322 | −298 | −309 |
| 4880463 | 68 | 68 | 86 | 70 | 70 | 83 | 69 | 66 | 79 | 61 | 68 | 69 |
| 990315 | −32 | −37 | −47 | −43 | −16 | −71 | −36 | −34 | −47 | −61 | −29 | −32 |
| 240463 | −72 | −69 | −65 | −61 | −63 | −63 | −56 | −67 | −32 | −22 | −43 | −49 |
| 2000035 | −298 | −304 | −289 | −326 | −309 | −297 | −298 | −293 | −308 | −309 | −293 | −311 |
| 1780709 | −58 | −53 | −115 | −60 | −65 | −27 | −61 | −70 | −50 | −95 | −75 | −48 |
| 2680440 | −184 | −187 | −191 | −203 | −184 | −183 | −188 | −189 | −186 | −198 | −185 | −186 |
| 150672 | 131 | 132 | 148 | 147 | 121 | 126 | 134 | 145 | 135 | 125 | 136 | 141 |
| 6940176 | −76 | −88 | 7 | −89 | −36 | −74 | −89 | −84 | −68 | −121 | −81 | −104 |
| 6180497 | 121 | 118 | 116 | 123 | 123 | 111 | 122 | 121 | 135 | 116 | 118 | 111 |
| 150706 | −20 | −22 | 17 | −8 | −33 | −45 | −23 | −26 | −29 | −22 | −19 | −24 |
| 5900129 | −181 | −167 | −165 | −166 | −144 | −156 | −151 | −169 | −119 | −187 | −161 | −135 |
| 6450437 | −363 | −368 | −359 | −396 | −368 | −369 | −365 | −360 | −379 | −369 | −363 | −369 |
| 3990608 | 293 | 286 | 317 | 336 | 239 | 291 | 287 | 288 | 280 | 298 | 287 | 292 |
| 3120075 | −57 | −65 | 8 | −67 | −61 | −74 | −67 | −68 | −68 | −84 | −60 | −66 |
| 1500047 | −193 | −196 | −222 | −209 | −206 | −186 | −198 | −190 | −208 | −204 | −195 | −213 |
| 840358 | −52 | −46 | −57 | −44 | −78 | −21 | −52 | −45 | −52 | −41 | −51 | −36 |
| 6590484 | −70 | −74 | −67 | −82 | −82 | −82 | −77 | −73 | −66 | −112 | −81 | −92 |
| 2100594 | −84 | −103 | −61 | −117 | −112 | −98 | −101 | −114 | −124 | −126 | −112 | −114 |
| 6650056 | 166 | 176 | 186 | 187 | 180 | 166 | 174 | 172 | 191 | 166 | 173 | 181 |
| 2120017 | 69 | 67 | 74 | 77 | 87 | 76 | 74 | 78 | 84 | 61 | 79 | 79 |
| 1780639 | −65 | −64 | −52 | −64 | −70 | −60 | −62 | −63 | −67 | −66 | −62 | −65 |
| 6650594 | −285 | −322 | −247 | −342 | −298 | −272 | −310 | −320 | −339 | −356 | −312 | −331 |
| 3420136 | −139 | −144 | −126 | −153 | −149 | −131 | −141 | −139 | −139 | −144 | −140 | −146 |
| 6760017 | −138 | −123 | −130 | −136 | −162 | −124 | −134 | −119 | −136 | −163 | −128 | −108 |
| 510209 | −66 | −60 | −126 | −63 | −44 | −70 | −56 | −66 | −80 | −14 | −67 | −61 |
| 4220673 | −191 | −199 | −199 | −210 | −175 | −195 | −188 | −185 | −191 | −198 | −188 | −200 |
| Intercept | 19978 | 20602 | 19656 | 20443 | 20673 | 19330 | 19853 | 19517 | 19384 | 23046 | 19209 | 20247 |

| ProbeID | S14_pre | S15_pre | S16_pre | S17_pre | S18_pre | S20_pre | S21_pre | S22_pre | S23_pre |
|---|---|---|---|---|---|---|---|---|---|
| 3390368 | −191 | −180 | −184 | −184 | −183 | −184 | −197 | −184 | −172 |
| 1300687 | 140 | 127 | 134 | 133 | 131 | 133 | 175 | 134 | 128 |
| 5860465 | 33 | 28 | 29 | 33 | 33 | 33 | 29 | 33 | 21 |
| 4390576 | −365 | −359 | −370 | −356 | −351 | −354 | −396 | −352 | −337 |
| 4830255 | 193 | 177 | 190 | 187 | 182 | 188 | 247 | 187 | 170 |
| 4570403 | −429 | −392 | −415 | −418 | −405 | −416 | −481 | −418 | −412 |
| 1780719 | 95 | 77 | 65 | 64 | 54 | 68 | 129 | 98 | 102 |
| 3130477 | −35 | −39 | −46 | −44 | −45 | −42 | −166 | −21 | 14 |
| 6110630 | −487 | −492 | −446 | −480 | −464 | −482 | −432 | −481 | −446 |
| 3310309 | −352 | −346 | −347 | −342 | −336 | −340 | −408 | −337 | −322 |
| 4220731 | 182 | 175 | 157 | 164 | 168 | 164 | 236 | 147 | 142 |
| 520706 | 33 | 47 | 51 | 49 | 42 | 47 | 57 | 36 | 9 |
| 6420446 | −78 | −89 | −66 | −78 | −89 | −75 | 17 | −66 | −82 |
| 1400240 | 373 | 367 | 370 | 368 | 366 | 360 | 296 | 361 | 404 |
| 7510379 | 10 | 8 | 7 | 12 | 13 | 10 | 67 | 8 | 6 |
| 2640025 | −64 | −12 | −48 | −63 | −68 | −66 | −94 | −47 | −25 |
| 3130296 | −124 | −116 | −107 | −100 | −84 | −103 | −185 | −93 | −77 |
| 3520601 | −165 | −202 | −176 | −176 | −165 | −169 | −231 | −180 | −194 |
| 1110091 | 252 | 245 | 243 | 261 | 251 | 258 | 172 | 271 | 232 |
| 3130370 | 415 | 411 | 418 | 427 | 408 | 421 | 352 | 396 | 425 |
| 2030332 | −186 | −185 | −182 | −180 | −168 | −181 | −200 | −175 | −170 |
| 670209 | 267 | 240 | 250 | 250 | 252 | 252 | 368 | 244 | 232 |
| 6560161 | −251 | −242 | −240 | −242 | −239 | −241 | −275 | −235 | −228 |
| 1740647 | −309 | −287 | −304 | −299 | −295 | −299 | −342 | −287 | −279 |
| 4880463 | 72 | 58 | 64 | 69 | 61 | 68 | 147 | 66 | 75 |
| 990315 | −25 | −39 | −32 | −34 | −43 | −29 | 4 | −32 | −17 |
| 240463 | −59 | −39 | −61 | −57 | −55 | −53 | −101 | −59 | −33 |
| 2000035 | −309 | −297 | −313 | −300 | −297 | −300 | −349 | −287 | −293 |
| 1780709 | −73 | −89 | −47 | −67 | −55 | −63 | −36 | −87 | −94 |
| 2680440 | −193 | −191 | −195 | −188 | −186 | −188 | −208 | −190 | −166 |
| 150672 | 150 | 142 | 144 | 137 | 134 | 140 | 213 | 115 | 151 |
| 6940176 | −81 | −80 | −92 | −86 | −97 | −90 | −141 | −109 | −143 |
| 6180497 | 120 | 78 | 124 | 122 | 129 | 118 | 93 | 139 | 141 |
| 150706 | −21 | 1 | −18 | −22 | −29 | −20 | −31 | −20 | −14 |
| 5900129 | −199 | −141 | −158 | −181 | −139 | −162 | −225 | −159 | −154 |
| 6450437 | −380 | −358 | −379 | −367 | −358 | −364 | −448 | −367 | −333 |
| 3990608 | 272 | 289 | 310 | 296 | 315 | 290 | 90 | 286 | 249 |
| 3120075 | −66 | −60 | −70 | −65 | −66 | −66 | −21 | −65 | −66 |
| 1500047 | −195 | −203 | −203 | −195 | −193 | −197 | −241 | −173 | −196 |
| 840358 | −52 | −61 | −30 | −45 | −37 | −47 | −50 | −57 | −50 |
| 6590484 | −84 | −91 | −70 | −79 | −93 | −80 | −218 | −80 | −92 |
| 2100594 | −114 | −137 | −118 | −109 | −130 | −101 | −141 | −142 | −90 |
| 6650056 | 184 | 171 | 177 | 175 | 176 | 174 | 234 | 179 | 161 |
| 2120017 | 73 | 102 | 78 | 72 | 80 | 76 | 117 | 78 | 65 |
| 1780639 | −67 | −60 | −61 | −62 | −63 | −62 | −78 | −73 | −46 |
| 6650594 | −332 | −311 | −330 | −310 | −300 | −319 | −270 | −308 | −325 |
| 3420136 | −146 | −145 | −147 | −142 | −139 | −140 | −185 | −134 | −140 |
| 6760017 | −113 | −114 | −137 | −122 | −113 | −126 | −20 | −81 | −100 |
| 510209 | −78 | −68 | −79 | −67 | −48 | −65 | −85 | −81 | −61 |
| 4220673 | −196 | −189 | −203 | −190 | −186 | −190 | −240 | −188 | −175 |
| Intercept | 20979 | 20488 | 20162 | 19945 | 19272 | 19998 | 24896 | 19939 | 18424 |

| ProbeID | S25_pre | S26_pre | L5_pre | L6_pre | L7_pre | L8_pre | L9_pre | L10_pre | L11_pre | L12_pre |
|---|---|---|---|---|---|---|---|---|---|---|
| 3390368 | −180 | −185 | −180 | −198 | −100 | −179 | −160 | −170 | −192 | −186 |
| 1300687 | 144 | 137 | 128 | 149 | 84 | 109 | 126 | 124 | 139 | 133 |
| 5860465 | 31 | 21 | 32 | 15 | 34 | 19 | 26 | 41 | 28 | 34 |
| 4390576 | −359 | −374 | −362 | −374 | −211 | −318 | −314 | −308 | −362 | −360 |
| 4830255 | 162 | 144 | 215 | 209 | 97 | 258 | 187 | 212 | 180 | 185 |
| 4570403 | −427 | −443 | −421 | −436 | −237 | −359 | −373 | −377 | −417 | −420 |
| 1780719 | 66 | 98 | 61 | 83 | −7 | 163 | 66 | 11 | 37 | 67 |
| 3130477 | 0 | −51 | −48 | −60 | 57 | −55 | −43 | −53 | −24 | −50 |
| 6110630 | −453 | −429 | −493 | −435 | −515 | −399 | −472 | −444 | −502 | −469 |
| 3310309 | −356 | −362 | −341 | −372 | −193 | −292 | −285 | −297 | −355 | −344 |
| 4220731 | 202 | 159 | 161 | 230 | −48 | 186 | 147 | 180 | 183 | 157 |
| 520706 | 79 | 92 | 28 | 43 | 78 | 22 | 69 | 36 | 18 | 55 |
| 6420446 | −36 | −72 | −99 | −68 | −68 | −62 | −54 | −119 | −62 | −78 |
| 1400240 | 280 | 323 | 402 | 443 | 157 | 363 | 363 | 399 | 336 | 368 |
| 7510379 | 16 | 0 | 17 | 8 | −1 | −57 | 15 | 32 | 20 | 15 |
| 2640025 | −46 | −60 | −67 | −27 | −283 | 37 | −62 | −124 | −10 | −70 |
| 3130296 | −104 | −139 | −128 | −170 | 95 | −187 | −92 | −83 | −108 | −100 |
| 3520601 | −167 | −170 | −178 | −198 | −89 | −230 | −184 | −148 | −169 | −169 |
| 1110091 | 273 | 254 | 248 | 283 | 242 | 157 | 254 | 241 | 275 | 260 |
| 3130370 | 412 | 493 | 406 | 410 | 477 | 346 | 425 | 373 | 454 | 421 |
| 2030332 | −184 | −177 | −174 | −184 | −146 | −177 | −166 | −176 | −172 | −178 |
| 670209 | 243 | 261 | 273 | 256 | 109 | 198 | 239 | 213 | 241 | 247 |
| 6560161 | −253 | −251 | −246 | −260 | −133 | −227 | −220 | −214 | −229 | −242 |
| 1740647 | −314 | −325 | −312 | −325 | −157 | −273 | −255 | −266 | −301 | −303 |
| 4880463 | 75 | 76 | 63 | 83 | 36 | 79 | 67 | 50 | 63 | 70 |
| 990315 | −54 | −18 | −66 | −14 | −32 | −4 | −3 | −44 | −37 | −31 |
| 240463 | −75 | −78 | −77 | −52 | −59 | −30 | −75 | −73 | −68 | −56 |
| 2000035 | −306 | −324 | −299 | −326 | −175 | −252 | −266 | −264 | −297 | −301 |
| 1780709 | −63 | −40 | −32 | −126 | 28 | −84 | −63 | −83 | −121 | −65 |
| 2680440 | −178 | −208 | −194 | −173 | −125 | −177 | −180 | −164 | −195 | −189 |
| 150672 | 158 | 152 | 138 | 151 | 66 | 150 | 122 | 143 | 123 | 137 |
| 6940176 | −106 | −79 | −54 | −62 | −106 | −33 | −131 | −126 | −62 | −91 |
| 6180497 | 101 | 116 | 139 | 47 | 183 | 18 | 118 | 145 | 92 | 121 |
| 150706 | −31 | −26 | 11 | −24 | −73 | 51 | −13 | −77 | −5 | −23 |
| 5900129 | −168 | −158 | −173 | −190 | 47 | −266 | −164 | −123 | −187 | −188 |
| 6450437 | −376 | −399 | −373 | −404 | −231 | −313 | −333 | −314 | −362 | −367 |
| 3990608 | 360 | 292 | 275 | 286 | 214 | 334 | 316 | 334 | 263 | 295 |
| 3120075 | −42 | −74 | −61 | −52 | −73 | −87 | −62 | −82 | −55 | −65 |
| 1500047 | −189 | −177 | −196 | −195 | −39 | −222 | −153 | −194 | −194 | −194 |
| 840358 | −40 | −30 | −70 | −52 | 19 | −144 | −20 | −34 | −51 | −48 |
| 6590484 | −65 | −63 | −98 | −88 | −96 | 5 | −100 | −39 | −33 | −79 |
| 2100594 | −95 | −152 | −126 | −133 | −12 | −178 | −97 | −64 | −68 | −106 |
| 6650056 | 176 | 183 | 171 | 210 | 95 | 142 | 155 | 165 | 173 | 176 |
| 2120017 | 74 | 76 | 64 | 70 | 102 | 1 | 74 | 20 | 97 | 78 |
| 1780639 | −55 | −65 | −65 | −67 | −30 | −66 | −50 | −54 | −62 | −63 |
| 6650594 | −300 | −345 | −336 | −376 | −227 | −257 | −292 | −259 | −277 | −309 |
| 3420136 | −136 | −139 | −148 | −172 | −90 | −99 | −134 | −126 | −141 | −141 |
| 6760017 | −115 | −73 | −138 | −128 | −92 | −118 | −129 | −107 | −146 | −117 |
| 510209 | −84 | −99 | −86 | −27 | −121 | 49 | −63 | −37 | −24 | −61 |
| 4220673 | −180 | −202 | −194 | −213 | −97 | −165 | −171 | −169 | −201 | −192 |
| Intercept | 19115 | 20488 | 21351 | 20804 | 13062 | 17736 | 17185 | 17648 | 19780 | 19946 |

| ProbeID | L13_pre | L14_pre | L15_pre | L16_pre | L17_pre | L18_pre | L20_pre | L21_pre | L19_pre |
|---|---|---|---|---|---|---|---|---|---|
| 3390368 | −187 | −182 | −185 | −183 | −179 | −185 | −193 | −191 | −195 |
| 1300687 | 130 | 121 | 133 | 138 | 136 | 135 | 135 | 153 | 125 |
| 5860465 | 40 | 47 | 34 | 41 | 39 | 40 | 44 | 33 | 21 |
| 4390576 | −378 | −376 | −355 | −356 | −335 | −359 | −349 | −375 | −385 |
| 4830255 | 154 | 231 | 185 | 163 | 203 | 189 | 201 | 202 | 161 |
| 4570403 | −419 | −425 | −419 | −422 | −401 | −419 | −426 | −428 | −435 |
| 1780719 | 85 | 54 | 62 | 43 | 63 | 68 | 79 | 82 | 83 |
| 3130477 | −57 | −39 | −37 | −50 | −11 | −42 | −55 | −44 | −14 |
| 6110630 | −441 | −463 | −482 | −458 | −469 | −483 | −447 | −450 | −519 |
| 3310309 | −362 | −353 | −342 | −348 | −334 | −341 | −341 | −356 | −348 |
| 4220731 | 146 | 170 | 160 | 157 | 161 | 160 | 158 | 174 | 206 |
| 520706 | 74 | 41 | 52 | 28 | 43 | 51 | 32 | 56 | 59 |
| 6420446 | −89 | −47 | −78 | −75 | −83 | −82 | −100 | −96 | −86 |
| 1400240 | 368 | 332 | 366 | 369 | 383 | 375 | 385 | 367 | 381 |
| 7510379 | 31 | 17 | 14 | 20 | 21 | 9 | 11 | 20 | −6 |
| 2640025 | −109 | 25 | −58 | −51 | −55 | −70 | −25 | −54 | −69 |
| 3130296 | −102 | −102 | −100 | −85 | −97 | −111 | −99 | −134 | −112 |
| 3520601 | −153 | −165 | −176 | −170 | −148 | −170 | −177 | −133 | −159 |
| 1110091 | 299 | 273 | 260 | 264 | 254 | 254 | 271 | 268 | 331 |
| 3130370 | 398 | 377 | 425 | 430 | 433 | 426 | 441 | 411 | 406 |
| 2030332 | −175 | −184 | −180 | −170 | −181 | −183 | −180 | −178 | −189 |
| 670209 | 271 | 272 | 249 | 252 | 253 | 237 | 261 | 255 | 255 |
| 6560161 | −260 | −242 | −241 | −241 | −235 | −243 | −239 | −253 | −250 |
| 1740647 | −308 | −324 | −302 | −302 | −295 | −307 | −311 | −314 | −311 |
| 4880463 | 61 | 71 | 70 | 84 | 57 | 72 | 75 | 84 | 57 |
| 990315 | −26 | −31 | −31 | −24 | −28 | −40 | −45 | −8 | −13 |
| 240463 | −45 | −28 | −59 | −46 | −58 | −52 | −58 | −53 | −97 |
| 2000035 | −308 | −302 | −302 | −301 | −295 | −302 | −306 | −316 | −291 |
| 1780709 | −27 | −77 | −65 | −79 | −85 | −73 | −10 | −55 | −68 |
| 2680440 | −201 | −191 | −189 | −184 | −182 | −193 | −188 | −195 | −193 |
| 150672 | 135 | 107 | 137 | 140 | 144 | 151 | 150 | 168 | 102 |
| 6940176 | −94 | −80 | −85 | −96 | −71 | −77 | −63 | −54 | −74 |
| 6180497 | 119 | 145 | 121 | 138 | 138 | 77 | 170 | 134 | 115 |
| 150706 | −4 | −45 | −25 | −27 | −16 | −32 | −32 | −11 | −24 |
| 5900129 | −153 | −186 | −159 | −126 | −148 | −184 | −153 | −170 | −195 |
| 6450437 | −367 | −376 | −368 | −360 | −336 | −363 | −381 | −388 | −390 |
| 3990608 | 283 | 336 | 290 | 280 | 284 | 285 | 284 | 320 | 312 |
| 3120075 | −52 | −54 | −65 | −67 | −66 | −62 | −76 | −59 | −80 |
| 1500047 | −217 | −238 | −198 | −199 | −195 | −203 | −203 | −204 | −193 |
| 840358 | −22 | −74 | −44 | −39 | −57 | −37 | −53 | −65 | −30 |
| 6590484 | −136 | −38 | −82 | −75 | −53 | −67 | −100 | −42 | −104 |
| 2100594 | −120 | −76 | −109 | −119 | −113 | −114 | −121 | −103 | −124 |
| 6650056 | 170 | 170 | 174 | 174 | 177 | 185 | 180 | 179 | 164 |
| 2120017 | 85 | 77 | 74 | 84 | 66 | 77 | 54 | 92 | 63 |
| 1780639 | −65 | −66 | −63 | −62 | −64 | −64 | −70 | −63 | −68 |
| 6650594 | −307 | −266 | −309 | −291 | −302 | −320 | −317 | −321 | −327 |
| 3420136 | −148 | −129 | −142 | −142 | −139 | −143 | −151 | −155 | −139 |
| 6760017 | −118 | −123 | −122 | −120 | −125 | −111 | −112 | −134 | −98 |
| 510209 | −92 | −46 | −68 | −46 | −48 | −46 | −106 | −80 | −81 |
| 4220673 | −194 | −184 | −190 | −187 | −175 | −193 | −204 | −197 | −195 |
| Intercept | 20285 | 18703 | 20057 | 19357 | 17800 | 20390 | 19420 | 18749 | 21296 |

TABLE 7
Table 7: Thirty gene sets by random selection.

| | Gene | Gene | Gene | Gene | Gene | Gene | Gene | Gene | Gene | Gene | Gene | Gene | Gene | Gene | Gene | Gene |
|---|---|---|---|---|---|---|---|---|---|---|---|---|---|---|---|---|
| Gene set | ID1 | ID2 | ID3 | ID4 | ID5 | ID6 | ID7 | ID8 | ID9 | ID10 | ID11 | ID12 | ID13 | ID14 | ID15 | ID16 |
| 1 | 97 | 281 | 276 | 300 | 4 | 239 | 55 | 148 | 240 | 140 | 218 | 53 | 126 | 210 | 205 | 31 |
| 2 | 243 | 211 | 99 | 113 | 49 | 291 | 205 | 259 | 276 | 127 | 48 | 218 | 112 | 18 | | |
| 3 | 144 | 4 | 78 | 103 | 157 | 115 | 245 | 278 | 7 | 274 | 225 | 151 | 291 | 273 | 54 | 83 |
| 4 | 103 | 255 | 188 | 275 | 109 | 11 | 78 | 74 | 257 | 167 | 296 | 119 | 278 | 126 | 138 | 64 |
| 5 | 96 | 93 | 211 | 85 | 76 | 184 | 216 | 153 | 252 | 54 | 87 | 13 | 209 | 11 | 210 | 83 |
| 6 | 8 | 298 | 185 | 253 | 254 | 135 | 62 | 69 | 291 | 178 | 256 | 26 | 188 | 272 | 275 | 165 |
| 7 | 59 | 84 | 261 | 273 | 155 | 251 | 175 | 49 | 86 | 112 | 205 | 198 | 266 | 81 | 162 | 71 |
| 8 | 67 | 4 | 80 | 14 | 297 | 86 | 271 | 171 | 12 | 135 | 226 | 239 | 3 | 69 | 264 | 46 |
| 9 | 47 | 163 | 141 | 113 | 205 | 233 | 137 | 150 | 94 | 97 | 276 | 100 | 182 | 79 | 293 | 267 |
| 10 | 206 | 119 | 201 | 93 | 239 | 222 | 19 | 237 | 14 | 245 | 41 | 184 | 209 | 210 | 85 | 231 |
| 11 | 233 | 227 | 106 | 19 | 171 | 282 | 118 | 295 | 146 | 266 | 122 | 174 | 108 | 254 | 175 | 123 |
| 12 | 266 | 257 | 245 | 197 | 165 | 182 | 137 | 21 | 88 | 228 | 167 | 231 | 206 | 242 | 123 | 155 |
| 13 | 108 | 69 | 194 | 63 | 10 | 35 | 101 | 242 | 186 | 61 | 278 | 107 | 106 | 11 | 168 | 246 |
| 14 | 244 | 98 | 67 | 260 | 278 | 287 | 144 | 65 | 201 | 108 | 58 | 247 | | | | |
| 15 | 103 | 58 | 257 | 83 | 106 | 159 | 280 | 284 | 132 | 63 | 123 | 264 | 206 | 24 | 72 | 208 |
| 16 | 24 | 189 | 154 | 33 | 64 | 273 | 62 | 9 | 178 | 199 | 149 | 278 | 34 | 88 | 272 | 299 |
| 17 | 178 | 179 | 248 | 66 | 37 | 218 | 103 | 167 | 183 | 264 | 242 | 41 | 300 | 100 | 47 | 245 |
| 18 | 46 | 83 | 102 | 235 | 169 | 141 | 41 | 264 | 151 | 175 | | | | | | |
| 19 | 191 | 130 | 89 | 77 | 196 | 247 | 134 | 7 | 259 | 232 | 64 | 56 | 224 | 128 | 11 | 273 |
| 20 | 77 | 169 | 248 | 257 | 225 | 158 | 253 | 281 | 282 | 80 | 128 | 299 | 254 | 148 | 260 | 291 |
| 21 | 40 | 207 | 229 | 67 | 268 | 63 | 298 | 254 | 102 | 79 | 82 | 112 | 211 | 290 | 89 | 133 |
| 22 | 67 | 161 | 110 | 236 | 90 | 283 | 164 | 10 | 45 | 134 | 36 | 132 | 52 | 23 | 9 | 203 |
| 23 | 21 | 84 | 260 | 224 | 111 | 249 | 172 | 92 | 203 | 209 | 274 | | | | | |
| 24 | 11 | 265 | 268 | 4 | 191 | 154 | 274 | 292 | 199 | 142 | 224 | 139 | 185 | 239 | 257 | 113 |
| 25 | 162 | 296 | 183 | 85 | 33 | 41 | 286 | 93 | 251 | 224 | 48 | 221 | 40 | 7 | 73 | 184 |
| 26 | 222 | 101 | 161 | 185 | 145 | 6 | 135 | 120 | 157 | 291 | 295 | 235 | 53 | 102 | 160 | 155 |
| 27 | 238 | 30 | 279 | 275 | 135 | 97 | 200 | 44 | 232 | 237 | 35 | 173 | 207 | 27 | 234 | 202 |
| 28 | 87 | 40 | 175 | 138 | 72 | 43 | 300 | 65 | 187 | 90 | 80 | 50 | 282 | 263 | 124 | 297 |
| 29 | 48 | 117 | 157 | 57 | 244 | 13 | 289 | 276 | 218 | 49 | 251 | 283 | 140 | 181 | 145 | 267 |
| 30 | 49 | 168 | 121 | 271 | 47 | 232 | 238 | 95 | 233 | 254 | 71 | 297 | 246 | 27 | 160 | 150 |

| | Gene | Gene | Gene | Gene | Gene | Gene | Gene | Gene | Gene | Gene | Gene | Gene | Gene | Gene |
|---|---|---|---|---|---|---|---|---|---|---|---|---|---|---|
| Gene set | ID17 | ID18 | ID19 | ID20 | ID21 | ID22 | ID23 | ID24 | ID25 | ID26 | ID27 | ID28 | ID29 | ID30 |
| 1 | 221 | 138 | 132 | 3 | 30 | 182 | 201 | 166 | 142 | 107 | 212 | 264 | 182 | |
| 2 | | | | | | | | | | | | | | |
| 3 | 91 | | | | | | | | | | | | | |
| 4 | 116 | 36 | | | | | | | | | | | | |
| 5 | 109 | 253 | 107 | | | | | | | | | | | |
| 6 | 182 | 289 | 167 | 20 | 6 | 204 | | | | | | | | |
| 7 | 126 | 246 | 44 | 128 | 156 | 22 | 85 | 177 | 80 | 74 | | | | |
| 8 | 184 | 160 | 84 | 186 | 45 | 285 | 230 | 203 | 278 | 25 | 292 | | | |
| 9 | 247 | 70 | 1 | 272 | 203 | 38 | 84 | 180 | 39 | 211 | 82 | 178 | | |
| 10 | 177 | 208 | 150 | 175 | 23 | | | | | | | | | |
| 11 | 128 | 66 | 79 | | | | | | | | | | | |
| 12 | 293 | 290 | 102 | 258 | 240 | 16 | 162 | 144 | 221 | 38 | | | | |
| 13 | 277 | 68 | 78 | 139 | 218 | | | | | | | | | |
| 14 | | | | | | | | | | | | | | |
| 15 | 93 | 65 | 52 | 203 | 17 | 81 | 117 | 142 | 299 | 47 | 131 | 288 | 98 | 177 |
| 16 | 168 | 206 | 203 | 263 | | | | | | | | | | |
| 17 | 9 | 175 | 57 | 287 | 106 | 196 | 150 | | | | | | | |
| 18 | | | | | | | | | | | | | | |
| 19 | 276 | 69 | 243 | 291 | 155 | 254 | 266 | 63 | 92 | 219 | 136 | 185 | 299 | 132 |
| 20 | 298 | 74 | 5 | | | | | | | | | | | |
| 21 | | | | | | | | | | | | | | |
| 22 | 230 | 299 | 202 | 28 | 255 | 125 | 296 | 103 | 62 | 47 | 72 | 178 | 162 | 238 |
| 23 | | | | | | | | | | | | | | |
| 24 | 267 | 120 | 150 | 247 | 27 | 201 | 91 | 112 | 178 | 18 | 125 | | | |
| 25 | 67 | 174 | 298 | 173 | 234 | 269 | 102 | 3 | 43 | | | | | |
| 26 | 273 | 83 | 297 | 298 | 191 | 243 | 249 | 70 | 27 | 230 | | | | |
| 27 | 298 | 158 | 194 | 136 | 118 | 28 | 268 | 210 | 299 | 188 | 262 | | | |
| 28 | 213 | 294 | 242 | 104 | 201 | 214 | | | | | | | | |
| 29 | 287 | 248 | | | | | | | | | | | | |
| 30 | 262 | 129 | 98 | 251 | 89 | 237 | 294 | 156 | | | | | | |

* The numbers represent the ranks in Table 1.

1. A method for predicting effect of immunotherapy on a cancer patient and/or prognosis of the cancer patient after the immunotherapy, which comprises the steps of:
(1) determining expression level of each gene in a gene set which consists of at least 1 gene selected from the group of genes shown in any of Tables 1-5 and
(2) performing statistical processing of the expression level to calculate predicted survival time.

2. The method of claim 1, wherein the statistical processing is performed by regression analysis.

3. The method of claim 1, wherein the immunotherapy is peptide vaccine therapy.

4. The method of claim 1, wherein the cancer is prostate cancer.

5. A gene set for predicting effect of immunotherapy on a cancer patient and/or prognosis of the cancer patient after the immunotherapy, which consists of at least 1 gene selected from the group of genes shown in any of Tables 1-5.

6. The gene set of claim 5, wherein said at least 1 gene is selected in descending order from the top of the group of genes shown in any of Tables 1-5.

7. The gene set of claim 5, which consists of at least 10 genes.

8. The gene set of claim 5, wherein the immunotherapy is peptide vaccine therapy.

9. The gene set of claim 5, wherein the cancer is prostate cancer.

10. A kit for predicting effect of immunotherapy on a cancer patient and/or prognosis of the cancer patient after the immunotherapy, which comprises a probe or primer for each gene in the gene set of claim 5.

11. The kit of claim 10, which is used for DNA microarray analysis.

12. The kit of claim 10, wherein the cancer is prostate cancer.
